(19) United States
(12) Patent Application Publication
(10) Pub. No.: US 2012/0095690 A1
(43) Pub. Date: Apr. 19, 2012

(54) Methods and computer-readable medium to implement inversion of angle gathers for rock physics reflectivity attributes

(76) Inventors: Joseph H. Higginbotham, Katy, TX (US); Morgan P. Brown, Houston, TX (US); Cosmin Mecesanu, Katy, TX (US)

(21) Appl. No.: 13/065,032

(22) Filed: Mar. 11, 2011

Related U.S. Application Data
(63) Continuation-in-part of application No. 12/587,607, filed on Oct. 9, 2009.
Application No. 12/587,607 is a continuation-in-part of application No. 12/221,390, filed on Aug. 1, 2008, now Pat. No. 8,082,107.

(51) Int. Cl. G06F 19/00; G01V 1/28

(52) U.S. Cl. 702/18; 702/14

(57) ABSTRACT

The invention relates to methods and computer-readable medium to determine seismic reflectivity attributes indicating the presence of hydrocarbons in earth. In several embodiments, the methods and computer-readable medium perform the steps of computing seismic reflectivity attributes includes inputting data representing reflected seismic waves and a volume of P-wave velocity, transforming the volume of P-wave velocity into a volume of bulk density, transforming the volume of P-wave velocity into a volume of S-wave velocity using amplitude information from the reflected seismic waves, and using the volume of S-wave velocity and the volume of P-wave velocity to compute the reflectivity attribute.

This application is a continuation-in-part of U.S. application Ser. No. 12/587,607, Estimation of Propagation Angles of Seismic Waves in Geology with Application to Determination of Propagation Velocity and Angle-Domain Imaging, filed on Oct. 9, 2009, U.S. application Ser. No. 12/221,390, Methods and Computer-Readable Medium to Implement Computing the Propagation Velocity of Seismic Waves, filed on Aug. 1, 2008, which are incorporated by reference herein.

### BACKGROUND

The invention relates to determining propagation angles of reflected seismic waves in complex geology. The invention also relates to using measured propagation angles to enhance determination of propagation velocity and to effect angle-domain imaging of reflected seismic waves to produce an accurate image of earth's geology.

Knowledge of the propagation velocity of seismic waves is required to produce accurate images of underground geology to prospect for oil and gas with the reflection seismic method. The reflection seismic method deploys an array of sound sources (e.g., dynamite, air guns, and vibrating trucks) and receivers (e.g., seismometer or hydrophone) on or below earth's surface to construct an image of underground geology. To gather data to make the image, each sound source produces an explosion or vibration that generates seismic waves that propagate through earth, or initially through water then earth. Underground geologic interfaces, known as “reflectors,” will reflect some energy from the seismic waves back to the receivers. Each receiver will record a “trace” at that time. A multi-channel seismic recording system such as the StrataView manufactured by Geometrics Inc., San Jose, Calif. can be used to collect all of the recorded traces for a given shot. This collection is referred to as a “shot gather.”

To map the underground geology, the recorded time of the shot reflection events of each seismic trace will be mapped to the position at which the reflection occurred, using the propagation velocities of seismic waves, which vary with respect to spatial position. This mapping is known as “prestack depth migration.” Claerbout, Toward a unified theory of reflector mapping, Geophysics v. 36, p. 467 (1971), which is incorporated by reference herein, describes a method of computation known as “downward continuation,” which enables prestack migration. Downward continuation is a computation that mathematically moves the recorded seismic traces and simulated seismic source traces into the subsurface to achieve prestack depth migration.

Downward continuation requires an initial estimate of propagation velocity known as the “migration velocity.” These computed propagation velocities can be obtained for instance by the method of stacking velocity analysis developed by Taner and Koehler, Velocity spectra—digital computer derivation applications of velocity functions, Geophysics 34, p. 859 (1969), which is incorporated by reference herein.

To form an image from the recorded data at a given depth, downward continuation migration computes the dot product of the downward continued recorded seismic trace and its corresponding downward continued source trace. When an energy peak on the recorded trace is time-coincident with an energy peak on the source trace an image can be formed. This method is known as the “zero time lag correlation imaging condition.” It is noted that the term “lag” is also referred to as “shift.” If the migration velocity matches the true propagation velocity, prestack migration will form an image of the reflector at the correct location. If the migration velocity differs from the true propagation velocity, prestack migration will form an image of the reflector at an incorrect location.

Sava and Fomel, Time-shift imaging condition in seismic migration, Geophysics, v. 71, p. 209 (2006), which is incorporated by reference, state that the zero time lag correlation imaging condition may be generalized to extract energy at a non-zero time lag and used to estimate the propagation velocities. When the migration velocity is incorrect, the energy peak on the downward continued source trace will not match the time of the energy peak on the downward continued recorded trace. By applying the correlation imaging condition at a number of time shifts, other than at zero lag, the amount of misfocusing in time can be computed and related to a velocity error. The generalized imaging condition is known as the “time-shift imaging condition.” For a given position on the recording surface and a given time shift, all the traces are summed. The collection of all these summed traces at that position for all the time shifts is known as “a time-shift gather.”

In regions with significant geologic complexity, velocity analysis using depth migration (MVA) is superior to methods which operate on prestack data. Migration in general, and depth migration in particular, simplify prestack data by correcting for the effects of offset, reflector dip, and propagation from source to receiver in a heterogeneous medium. When the migration velocity is incorrect, migration will incorrectly position the surface data in depth. Some MVA techniques attempt to flatten Kirchhoff common-offset depth migration gathers by measuring depth error as a function of offset and perturbing the migration velocity accordingly.

Kirchhoff offset gathers exhibit artifacts in complex examples, which are not seen in wave equation depth-migrated images, as described in Stolk and Symes, Kinematic artifacts in prestack depth migration, Geophysics v. 69, p. 562 (2004). Claerbout, Imaging the Earth's Interior (1985), which is incorporated by reference herein, devised the zero-time/zero-offset prestack imaging condition which forms the basis of most wave equation MVA techniques. Subsurface offset gathers can be converted to angle gathers by slant-stacking as described by Prucha et al, Angle-domain common image gathers by wave-equation migration, 69th Annual International Meeting, SEG, Expanded Abstracts, p. 824 (1999) and by Sava and Fomel, Angle-domain common-image gathers by wavefield continuation methods, Geophysics v. 68, p. 1065 (2003), and have been used for MVA, as described by Clapp, Incorporating geologic information into reflection tomography, Geophysics v. 69, p. 533, (2004) and by Sava, Migration and velocity analysis by wavefield extrapolation, Ph.D. thesis, Stanford University (2004). However, the slant stack may itself introduce spurious artifacts. Shen et al., Differential semblance velocity analysis by wave-equation migration, SEG Expanded Abstracts, p. 2132 (2003) describe a velocity update method which uses misfocusing in subsurface offset directly.

Another class of MVA methods uses the other wave equation prestack focusing criterion—misfocusing in time—to quantify velocity errors. As described by MacKay and Abma, Imaging and velocity estimation with depth-focusing analysis, Geophysics v. 57, p. 1608 (1992), which is incorporated by reference herein, time-shift gathers can be constructed by phase-shifting source and receiver wave fields in shot record migration. While time-shift gathers can be converted to angle gathers, as described by Sava and Fomel, Time-shift imaging condition in seismic migration, Geophysics, v. 71, p. 209 (2006), which is incorporated by reference herein, MacKay and Abma measured the depth corresponding to best focusing and invoked a relationship attributed to Faye and Jeannot, Prestack migration velocities from focusing analysis, SEG Expanded Abstracts, p. 438 (1986), which is incorporated by reference herein, to relate the measured depth error to a velocity perturbation. The technique has small reflector dip and small offset assumptions. Audebert and Diet, Migrated focus panels: Focusing analysis reconciled with prestack depth migration, SEG Expanded Abstracts, p. 961 (1992), which is incorporated by reference herein, outline an approach to partially overcome these limitations.

In the 1990's, one of the inventors, Dr. Higginbotham, developed a method of computing the propagation velocity of seismic waves in earth. The method assumed a migration velocity, generated time shift gathers using a shot record downward continuation depth migration and the time-shift imaging condition, and converted the time shift gathers to semblance gathers. The energy peaks on the semblance gathers corresponded to the amount of misfocusing in time. The magnitude of the misfocusing in time was used to update the migration velocity. The method incorrectly assumed that a time shift corresponded to zero offset travel time. The method computed inaccurate values of the propagation velocity of seismic waves in the presence of reflector dip and source-receiver offset, and it was not understood how to increase its accuracy. Further, the earth's complex geology refracts reflected seismic waves, which makes it difficult to measure the dip angle of a reflector and the incidence angle of a reflected seismic wave at the reflector, which is related to source-receiver offset.

### SUMMARY OF THE INVENTION

The invention solves the problem of obtaining an accurate measure of the true propagation velocity which can be enhanced by obtaining the propagation angles of seismic waves in the earth. This results in an accurate image of subsurface geology that can be used to prospect for oil and gas deposits.

The invention provides methods and computer-readable medium of computing the propagation velocity of seismic waves in earth, comprising: providing an estimate of the propagation velocity; generating a time shift gather using a depth migration at a plurality of locations of the earth; converting each of the time shift gathers to a semblance gather; transforming each semblance gather into a velocity gather whose energy peaks represent a root-mean-square average of the propagation velocity along the forward and backward path between earth's surface and a point of the subsurface geology; and converting the energy peaks to the propagation velocity.

The invention also provides a method of computing a propagation velocity of seismic waves in earth, comprising: providing an estimate of the propagation velocity; generating a time shift gather using the depth migration at a plurality of locations of the earth; transforming each time shift gather into a velocity gather whose energy peaks represent a root-mean-square average of the propagation velocity along the forward and backward path between earth's surface and a point of the subsurface geology, and converting the energy peaks to the propagation velocity.

The invention relates to a velocity estimation technique which uses the time-shift imaging condition for wave equation prestack depth migration. The migration time-shift parameter is converted to a perturbation in RMS velocity, which can be converted to interval velocity. The invention can resolve velocity errors in the presence of subsurface complexity that would hamper velocity analysis with surface data. Moreover, it has no dip or offset limitations for constant velocity and weak dip limitations for varying velocity.

The invention also relates to a computer-readable medium and a method of determining the propagation angles of reflected seismic waves, including inputting data representing reflected seismic waves, inputting a propagation velocity field, computing propagation direction vectors of a source wave field and a receiver wave field using a downward continuation Fourier domain shot record migration using the data of the reflected seismic waves and the propagation velocity field, and transforming the propagation direction vectors into propagation angles of reflected seismic waves.

The invention also relates to a computer-readable medium and a method of determining a three-dimensional image of earth's geology, including inputting data representing reflected seismic waves, inputting a propagation velocity field, computing propagation direction vectors of a source wave field and a receiver wave field using a downward continuation Fourier domain shot record migration using the data of the reflected seismic waves and the propagation velocity field, transforming the propagation direction vectors into propagation angles of reflected seismic waves, and generating a three-dimensional image for each shot record using an angle-dependent imaging condition for the shot record migration, wherein an amplitude and a set of propagation angles is associated with each point in the image.

The invention relates to methods and computer-readable medium to determine seismic reflectivity attributes indicating the presence of hydrocarbons in earth. In several embodiments, the methods and computer-readable medium perform the steps of computing seismic reflectivity attributes includes inputting data representing reflected seismic waves and a volume of P-wave velocity, transforming the volume of P-wave velocity into a volume of bulk density, transforming the volume of P-wave velocity into a volume of S-wave velocity using amplitude information from the reflected seismic waves, and using the volume of S-wave velocity and the volume of P-wave velocity to compute the reflectivity attribute.

### BRIEF DESCRIPTION OF THE FIGURES

FIG. 1 illustrates a computer for implementing the methods of the invention.

FIGS. 2A-2C illustrate downward continuation migration when the correct migration velocity is used.

FIGS. 3A-3C illustrate downward continuation migration when an incorrect migration velocity is used.

FIGS. 4A-4B illustrate construction of a time-shift gather when an incorrect migration velocity is used.

FIG. 5 illustrates a seismic survey geometry and a shot image aperture.

FIG. 6 illustrates a method of downward continuation shot record migration.

FIG. 7 illustrates a method of construction of a time-shift gather.

FIGS. 8A-8C illustrate a method of flattening or retardation of a time-shift gather.

FIG. 9 illustrates counting the shots contributing to a time-shift gather.

FIG. 10 illustrates a method of semblance computation.

FIG. 11 illustrates a method of wave equation migration velocity focusing analysis.

FIGS. 12A-12C illustrate selecting by user input energy peaks on velocity gathers.

FIG. 13 illustrates automatically selecting of energy peaks on velocity gathers.

FIG. 14 illustrates a method of updating the migration velocity.

FIG. 15 illustrates a time-shift gather based on synthetic data.

FIGS. 16A-16C illustrate velocity gathers with varying amounts of velocity error.

FIGS. 17A-17C illustrate migration results with varying velocity errors.

FIGS. 18A-18C illustrate a comparison of velocity models used in a feasibility test.

FIG. 19 illustrates an incidence angle, a dip angle, and an azimuth angle for a seismic reflection.

FIG. 20 illustrates downward continuation shot record migration with angle decomposition.

FIG. 21 illustrates the downward continuation portion of phase shift plus interpolation (PSPI).

FIG. 22 illustrates the interpolation portion of PSPI.

FIG. 23 illustrates the accumulation of angle of propagation information for time-shift gathers.

FIG. 24 illustrates the computation of propagation direction vectors for time-shift gathers.

FIG. 25 illustrates computation of a collection of angle-dependent time-shift gathers.

FIG. 26 illustrates computing an incidence angle, a dip angle, and an azimuth angle from propagation direction vectors.

FIG. 27 illustrates using propagation angles to generate angle volumes.

FIG. 28 illustrates computation of downward continuation shot record migration angle volumes.

FIG. 29 illustrates the accumulation of angle of propagation information for angle volumes.

FIG. 30 illustrates the computation of propagation direction vectors for angle volumes.

FIG. 31 illustrates computing a collection of angle image volumes.

FIG. 32 illustrates using seismic amplitude information to compute reflectivity attributes.

FIG. 33 illustrates least-squares inversion of incidence angle gathers to compute A and B volumes.

FIG. 34 illustrates using seismic amplitude information to iteratively compute a γ volume relating P-wave velocity to bulk density.

FIG. 35 illustrates iterative transformation of P-wave velocity to S-wave velocity using the hyperbolic mudrock line.

FIG. 36 illustrates a hyperbolic mudrock line fit to laboratory P-wave velocity versus S-wave velocity data for limestone.

### DETAILED DESCRIPTION OF THE PREFERRED EMBODIMENTS

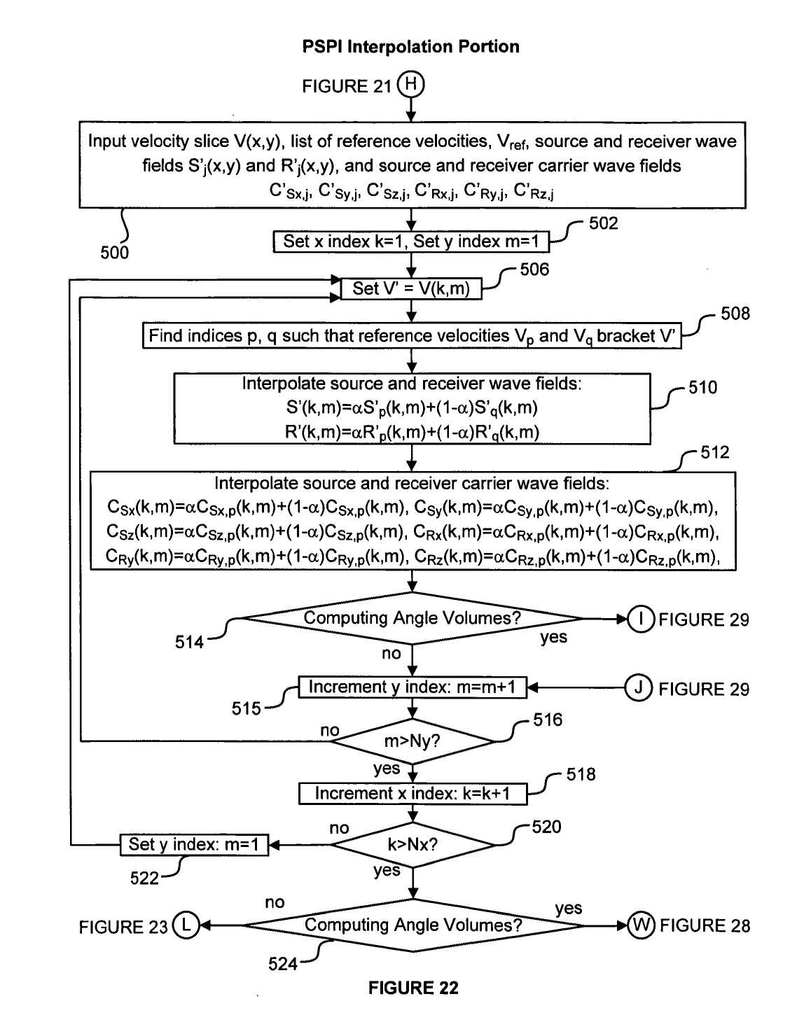

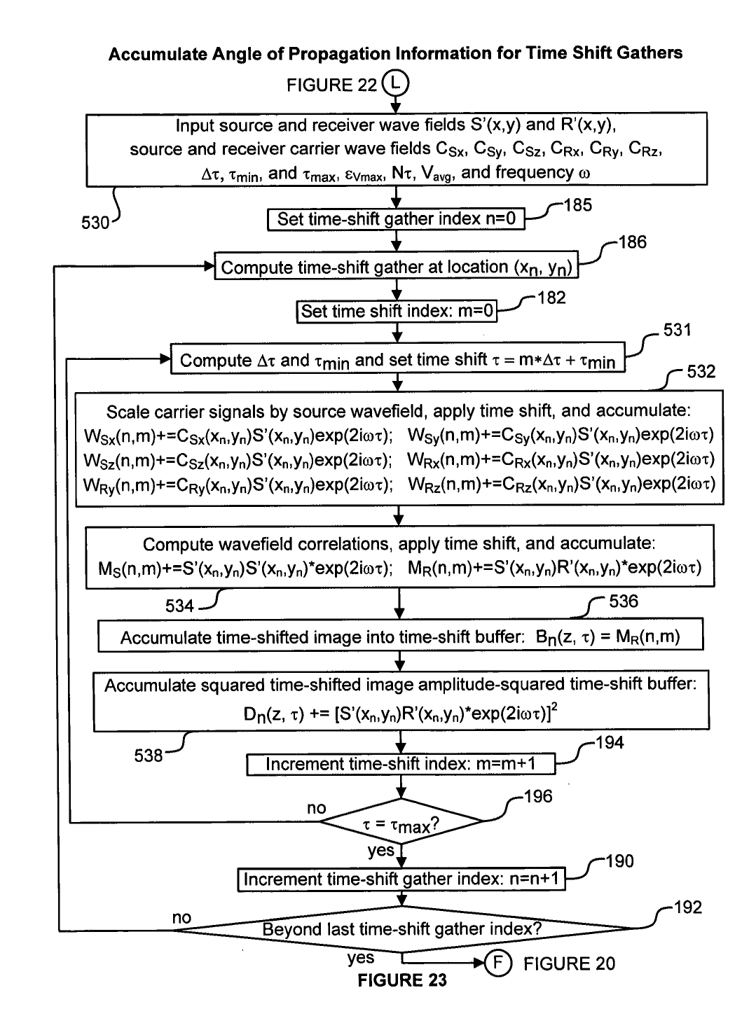

The following description includes the best mode of carrying out the invention. The detailed description illustrates the principles of the invention and should not be taken in a limiting sense. The scope of the invention is determined by reference to the claims. Each part (or step) is assigned its own part (or step) number throughout the specification and drawings. Because some flow charts don't fit in a single drawing sheet encircled capital letters (e.g., “L”) show how the flow charts connect (e.g., L connects the flowcharts of FIGS. 22 and 23). The punctuation mark ' and apostrophe ' mean prime wherever they appear in the drawings and specification.

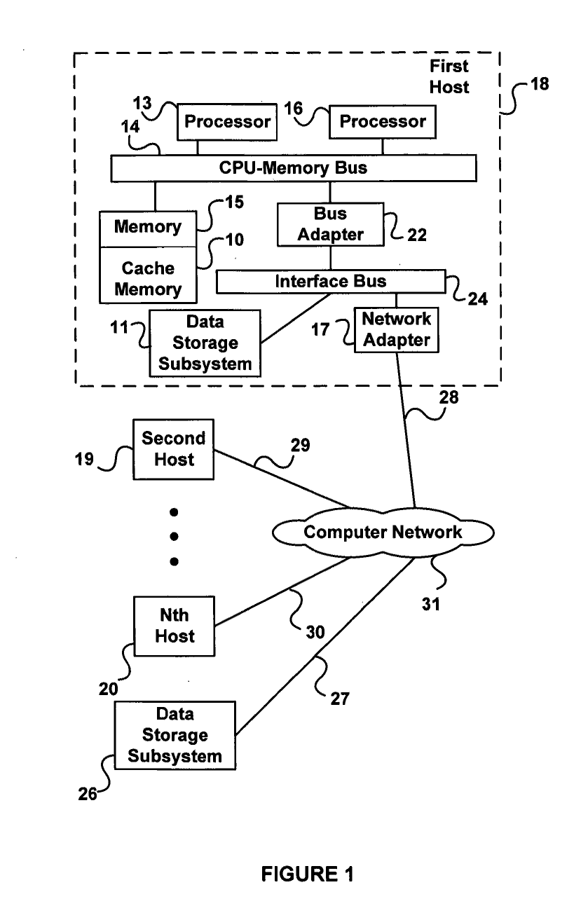

FIG. 1 illustrates a cluster of hosts that can execute the methods in software as described below. Each host is a computer that can communicate with data storage subsystems 11 and 26 (e.g., a disk array and/or solid state memory) and with each other. Hennessy and Patterson, Computer Architecture: A Quantitative Approach (2006), and Patterson and Hennessy, Computer organization and Design: The Hardware/Software Interface (2007) describe computer hardware and software, storage systems, caching, and networks and are incorporated by reference.

As shown in FIG. 1, a first host 18, which is representative of the second host 19 through Nth host 20, includes a motherboard with a CPU-memory bus 14 that communicates with dual processors 13 and 16. The processor used is not essential to the invention and could be any suitable processor such as the Intel Pentium processor. A processor could be any suitable general purpose processor running software, an ASIC dedicated to perform the operations described herein or a field programmable gate array (FPGA). Also, one could implement the invention using a single processor in each host or more than two processors to meet various performance requirements. The arrangement of the processors is not essential to the invention. Data is defined as including user data, instructions, and metadata. Inputting data is defined as the input of parameters and data from user input, computer memory, and/or storage device(s). The processor reads and writes data to memory 15 and/or data storage subsystem 11 and 26. Each host includes a bus adapter 22 between the CPU-memory bus 14 and an interface bus 24. A computer-readable medium (e.g., storage device, CD, DVD, floppy card, USB storage device) can be used to encode the software program instructions described in the methods below.

A seismic survey may contain hundreds of thousands of shot gathers resulting in a data set greater than one terabyte. Our method of computing the propagation velocity (described below) can be implemented on one host having a processor, but preferably uses many hosts each with a plurality of processors to image the shot gathers in parallel. In an embodiment, the method is implemented on at least 20 hosts, each having four processors. In the embodiment, each processor on each slave host communicates with a processor on a master host with data flowing between the master and the slave hosts throughout the computation. Data used by our method is usually stored locally on the slave hosts. After the work on each slave host completes, its portion of the output is summed into a single file on the master host. The SeisPak® software owned by Chevron Corporation, San Ramon, Calif. and licensed to the applicants is a suitable software environment for implementing the method described below. SeisPak® uses the open source Parallel Virtual Machine (PVM) software package distributed by Oak Ridge National Laboratory, Oak Ridge, Tenn. to implement the parallel computations described above.

Each host runs an operating system such as Linux, UNIX, a Windows OS, or another suitable operating system. Tanenbaum, Modern Operating Systems (2008) describes operating systems in detail and is hereby incorporated by reference. Bovet and Cesati, Understanding the Linux Kernel (2005), and Bach, Design of the Unix Operating System (1986) describe operating systems in detail and are incorporated by reference herein.

FIG. 1 shows that the first host 18 includes a CPU-memory bus 14 that communicates with the processors 13 and 16 and a memory 15 which is connected to memory cache 10. The first host 18 communicates through the network adapter 17 over a link 28 with a computer network 31 with other hosts. Similarly, the second host 19 communicates over link 29 with the computer network 31, and the Nth host 20 communicates over link 30 with the computer network 31. In sum, the hosts 18, 19 and 20 communicate with each other and with the computer network 31. The link 27, the link 29, the link 30, and the computer network 31 can be implemented using a suitable known bus, SAN, LAN, or WAN technology such as Fibre Channel, SCSI, InfiniBand, or Ethernet, and the technology implemented is not essential to the invention. See Kembel, The FibreChannel Consultant, A Comprehensive Introduction (1998), Kembel, The FibreChannel Consultant, Arbitrated Loop (1996-1997) The FibreChannel Consultant, Fibre Channel Switched Fabric (2001), Clark, Designing Storage Area Networks (2003), Clark, IP SANs: A Guide to iSCSI, iFCP, and FCIP Protocols for Storage Area Networks (2002) and Clark, Designing Storage Area Networks (1999), which are incorporated by reference herein.

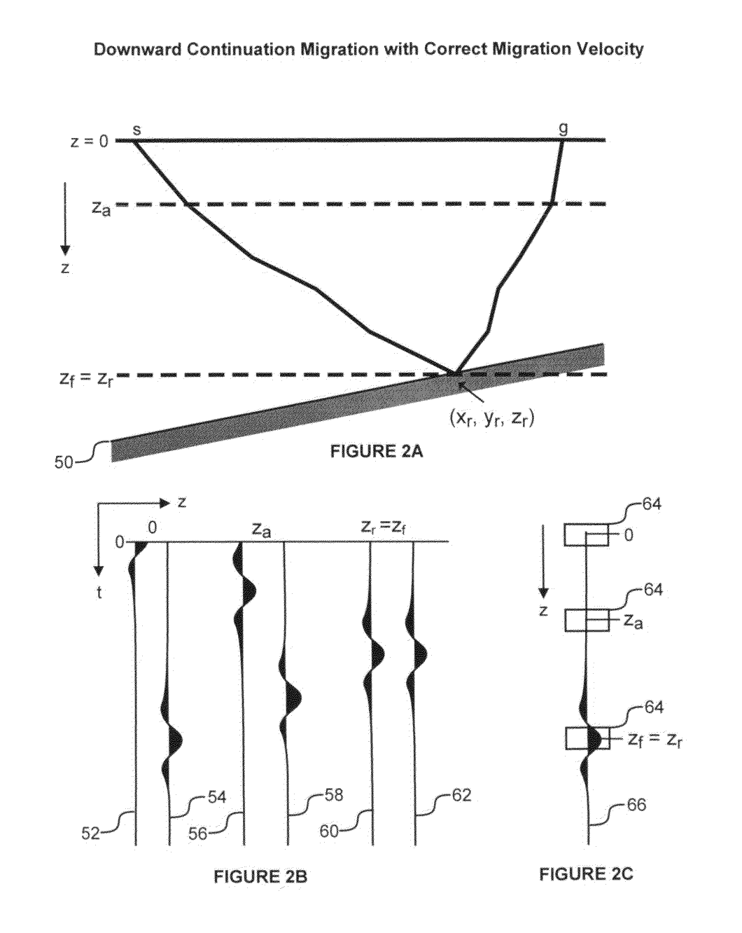

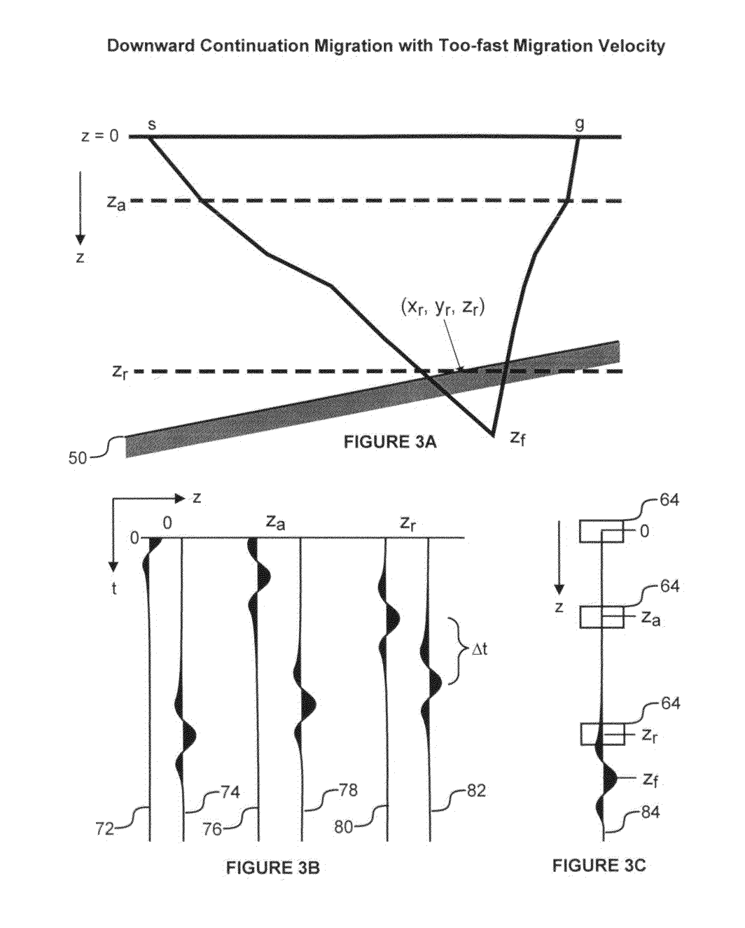

FIGS. 2A-2C and FIGS. 3A-3C illustrate methods of applying downward continuation for prestack depth migration with the zero time lag correlation imaging condition. FIGS. 2A-2C illustrate the method when the migration velocity equals the true propagation velocity.

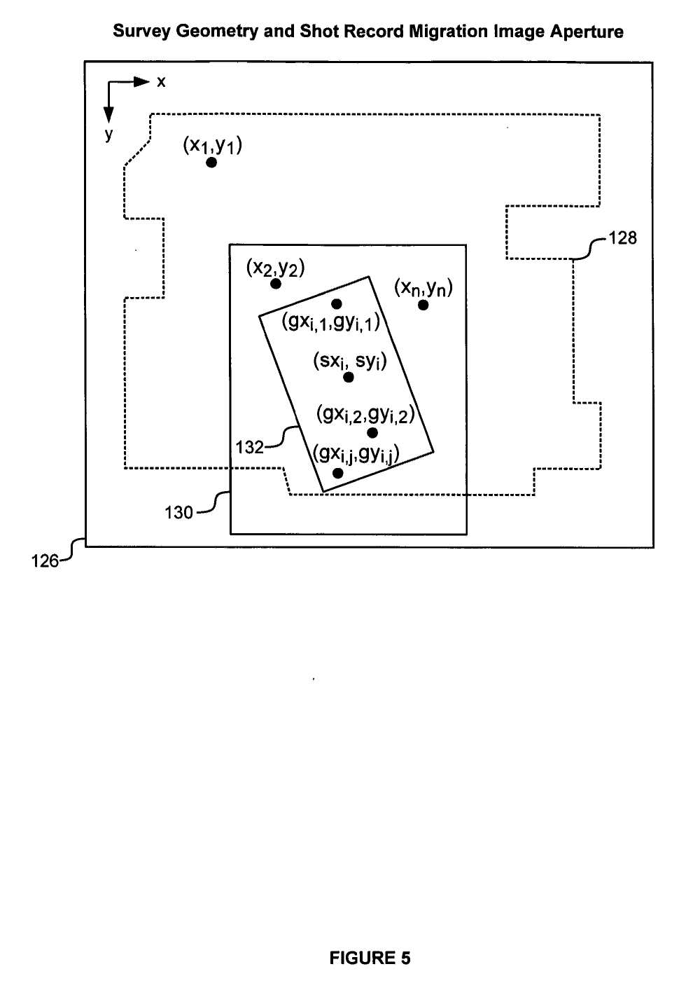

In FIG. 2A, dipping geologic interface 50 produces a seismic reflection which is recorded as a seismic trace (FIG. 2B) at the depth z=0, which can be on or below earth's surface. The voltage of the receiver plots the seismic energy as a function of time t. A simulated source trace 52 is also shown in FIG. 2B. The energy peak of the simulated source trace 52 will lie at t=0 when z=0. The source generating a seismic wave and the receiver which generates the voltage indicative of the wave's reflected energy records its travel time at two-dimensional surface coordinate vectors s=[sx, sy] and g=[gx, gy] as shown in FIG. 5. The simulated source trace 52 is assumed to lie at the position s. The vector connecting the source position s and the receiver position g, referred to as the “offset” vector, can be oriented at an arbitrary azimuth with respect to the (x, y) axis as shown in FIG. 5.

As shown in FIG. 2B, the simulated source trace 52 and the recorded trace 54 are downward continued in depth to some depth z=zₐ>0, producing traces 56 and 58. The energy peak of the downward continued simulated source trace 56 is moved to a later time. The energy peak of the downward continued recorded trace 58 is moved to an earlier time. At the focusing depth z_{f} the energy peak of the downward continued simulated source trace 60 and the energy peak of the downward continued recorded trace 62 are coincident in time. Because the migration velocity corresponds to the true propagation velocity, the focusing depth, z_{f}, is the same as the true reflector depth, zᵣ.

FIG. 2C illustrates applying the zero time lag imaging condition 64 to create a depth image trace 66. To form an image at depth z=0, the value corresponding to the dot product of the traces 52 and 54 is placed on the depth image trace at depth z=0. The image at z=zₐ is formed by applying the imaging condition 64 to the traces 56 and 58. The image at z=zᵣ is formed by applying the imaging condition 64 to the traces 60 and 62. Because the migration velocity equals the true propagation velocity, the energy peak of the image trace reaches a maximum at the true reflector depth z=zᵣ.

FIGS. 3A-3C illustrate the same method depicted in FIGS. 2A-2C, but in the situation where the migration velocity is faster than the true propagation velocity.

As shown in FIG. 3A, the migration velocity is too fast, which causes the focusing depth z_{f} to be greater than the true reflector depth zᵣ.

FIG. 3B illustrates the same method depicted in FIG. 2B. The downward continuation of a simulated source trace 72 produces a trace 76 at zₐ and a trace 80 at zᵣ. The downward continuation of a recorded trace 74 produces a trace 78 at zₐ and a trace 82 at zᵣ. Because the migration velocity is too fast, the energy peaks of the trace 80 and trace 82 are not time-coincident but separated by time Δt.

FIG. 3C illustrates the same method depicted in FIG. 2C. The zero time lag correlation imaging condition 64 is applied at each depth. Because the migration velocity is too fast, the energy peak of the depth image trace 84 is deeper than the true reflection depth zᵣ.

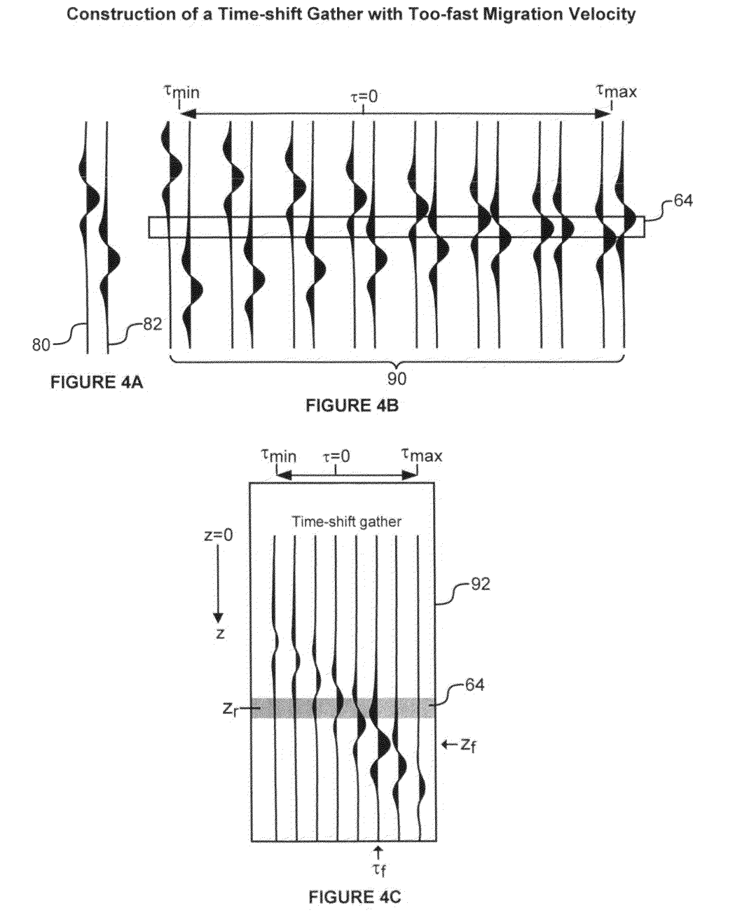

FIGS. 4A-4C illustrate applying the time-shift imaging condition to the downward continued traces 80 and 82 (FIG. 4A) when the migration velocity is too slow.

As shown in FIG. 4B, an ensemble of shifted traces 90 is generated by applying opposing time shifts τ ranging from τₘᵢₙ to τₘₐₓ to the trace pair 80 and 82 shown in FIG. 4A. The zero time lag correlation imaging condition 64 is applied to each of the shifted trace pairs. In this case, at τ>0 the energy peaks of the traces in the trace pairs are time coincident.

FIG. 4C shows a time-shift gather 92. The shaded row of the time-shift gather at z=zᵣ is filled by applying the time-shift imaging condition 64 to each trace pair in the ensemble of shifted traces 90 shown in FIG. 4B. The time-shift gather is filled for other depth levels generating a slanting seismic event in the (z, τ) plane for each reflector. For a reflector, the energy of the slanting seismic event will be largest at the focusing depth z_{f}. Corresponding to the focusing depth z_{f} is a focusing time shift τ_{f}. Because the migration velocity is incorrect, the focusing time shift τ_{f} is not zero.

The magnitude of the focusing time shift τ_{f} can be used in an embodiment to approximate the velocity error which caused the focusing time shift to deviate from zero. The computed velocity error is then used to update the migration velocity to better approximate the propagation velocity.

FIG. 5 illustrates the geometry of a seismic survey and a shot record migration aperture. The seismic survey includes a collection of shot gathers. Each shot gather consists of a source (or shot). The ith shot is located at position vector [sxᵢ, syᵢ]. A collection of receivers records seismic reflections from each source. Three such receivers corresponding to the ith shot are shown at [gx_{i,1}, gy_{i,1}], [gx_{i,2}, gy_{i,2}], and [gx_{i,j}, gy_{i,j}], where the index j represents the jth receiver belonging to the ith shot. A polygon 132 contains all the receivers corresponding to the ith shot. Although shown as a rectangle, the polygon is generally irregular. A polygon 128 contains all the sources and receivers. The polygon is typically irregular in shape due to constraints such as oilfield equipment and irregularities in land ownership. The shot record migration produces an independent seismic image for each shot gather.

To reduce computational time, a shot image aperture 130 can be defined for each shot gather. The shot image aperture 130 is usually a rectangle for simple implementation. Whatever its geometric shape, the shot image aperture 130 should contain the source and all receivers in the shot gather, and enough “padding” on the edges to image seismic energy reflecting from dipping reflectors. The master image extent 126 contains all shot image apertures and is generally rectangular for simple implementation.

The location of a time-shift gather in general is denoted by (xₙ, yₙ). Three such locations are shown at (x₁, y₁), (x₂, y₂), and (xₙ, yₙ). Two of the three time-shift gather locations are contained in the shot image aperture 130 of the ith shot. Energy from the ith shot image will only contribute to time-shift gather locations contained in the shot image aperture 130. The spacing density and regularity of the time-shift gathers is flexible but can be specified on a regular grid for simplicity.

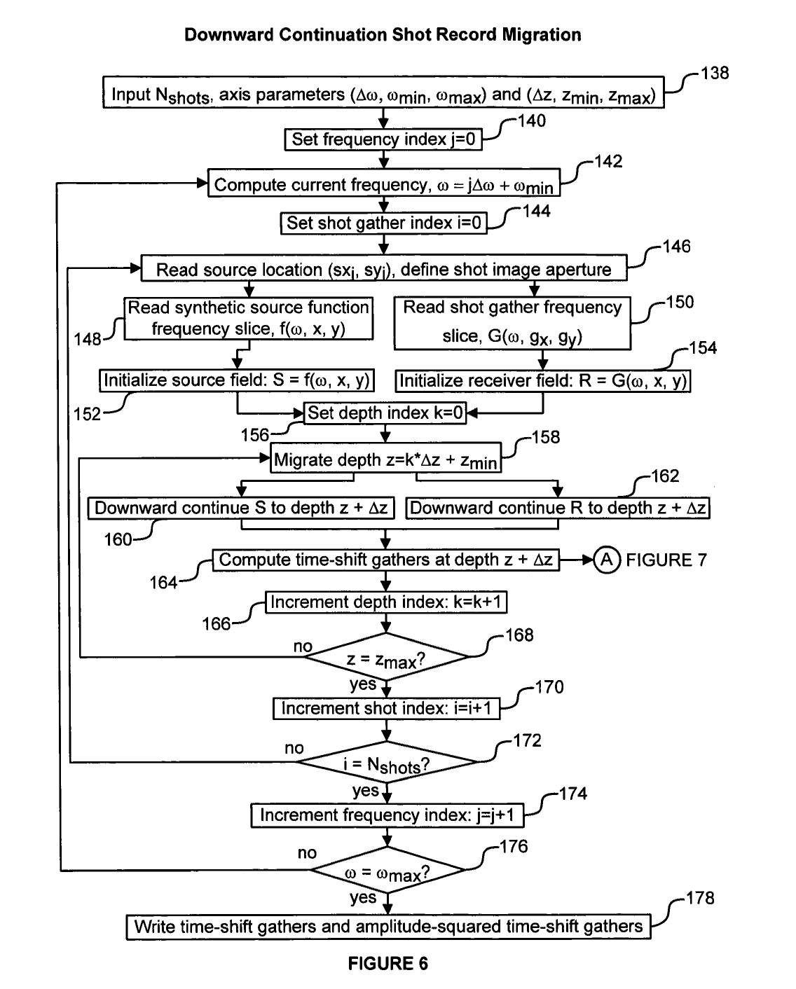

FIG. 6 illustrates a method of shot record migration to generate time-shift gathers as implemented in software executable by the host. A discrete Fourier transform is applied to the time axis of every trace in the collection of input shot gathers. The shot record migration method includes three nested loops: over all frequencies, over all shot gathers, and over all depths. It is known that summation of the frequency components of a Fourier-transformed signal is equivalent to extraction of the original signal at zero time. The zero lag correlation imaging condition is applied in this manner for efficient computation. Each shot gather is imaged independently with a pre-defined aperture then inserted and summed into the master image as shown in FIG. 5. For each frequency and each shot, the image is formed by downward continuation from the minimum depth to the maximum depth.

As shown in FIG. 6, at step 138 the user inputs the parameters for the frequency axis, the output image's depth axis, and the number of shot gathers Nₛₕₒₜₛ in the host. It is simplest to parameterize the axes by the minimum value, the spacing between samples, the maximum value, and an integer index. The minimum frequency is ωₘᵢₙ, the spacing between adjacent frequencies is Δω, and the maximum frequency is ωₘₐₓ. Similarly, the minimum depth is zₘᵢₙ, the spacing between adjacent depths is Δz, and the maximum depth is zₘₐₓ. Implementations using irregular sampling in depth may yield a significant performance advantage, because seismic velocities generally increase with depth and high frequencies in the data are attenuated allowing less frequent sampling as the seismic waves propagate into the earth.

At step 140, the method initializes the frequency loop index j to 0. At step 142 the method computes the current frequency by the linear relation ω=j*Δω+ωₘᵢₙ. At step 144, the method initializes the shot gather index i to 0. At step 146, the method reads the location of the ith source, (sxᵢ, syᵢ) from the trace header of any trace in the current shot gather. Those skilled in the art are familiar with the concept of trace headers. The SEG-Y format is one example of a data format which uses trace headers. At step 146, the method also defines the spatial extent of the shot image aperture 130 relative to (sxᵢ, syᵢ). At step 148, the method reads a Fourier-transformed synthetic source function for the current frequency. Because the source function depends on three variables, extraction of one frequency value is a “frequency slice” from the three-dimensional source function cube. Although this synthetic source function may have finite spatial extent, it can be implemented as a point source at (sxᵢ, syᵢ), and is defined either as a “spike” at time=0 or as a more complicated function in time, which reproduces the behavior of the actual source function of the shot. At step 152, the method initializes the source wave field S, which is a two-dimensional array corresponding to the shot image aperture, by interpolating the synthetic source function into the appropriate location on S. At step 150, the method reads a frequency slice from the current Fourier-transformed shot gather. At step 154, the method initializes the receiver wave field R as it did with the source wave field at step 152 by interpolating the shot gather frequency slice read at step 150 into the appropriate location. The receiver wave field R is also a two-dimensional array with the same size as source wave field S. The initialization of receiver wave field R and source wave field S is assumed to happen at depth z=0, where the sources and receivers are assumed to be located. Generalization of the algorithm to a non-flat acquisition datum is possible, as described in Higginbotham, Directional depth migration, Geophysics, v. 50, p. 1784 (1985), which is incorporated by reference herein.

At step 156, the method executes a loop over depth that begins by initializing the depth index k to 0. At step 158, the method computes the kth depth by the linear relation z=k*Δz+zₘᵢₙ. At steps 160 and 162, the method downward continues the source wave field S and the receiver wave field R to the next depth. For wave-equation migration, the method can execute the downward continuation by a factorization of the acoustic wave equation into a one-way wave equation, which propagates waves only down (or up) in depth as described in Claerbout, Toward a unified theory of reflector mapping, Geophysics v. 36, p. 467 (1971), which is incorporated by reference. This allows recursive propagation of energy from the surface (z=0) into the sub-surface (z>0).

Biondi, 3D Seismic Imaging (2006), which is incorporated by reference, gives an overview of the implementations of the one-way wave equation. In an embodiment, the Phase Shift Plus Interpolation method described in Gazdag and Sguazzero, Migration of seismic data by phase-shift plus interpolation, Geophysics, v. 49, p. 124 (1984), which is incorporated by reference, is used to implement the one-way wave equation.

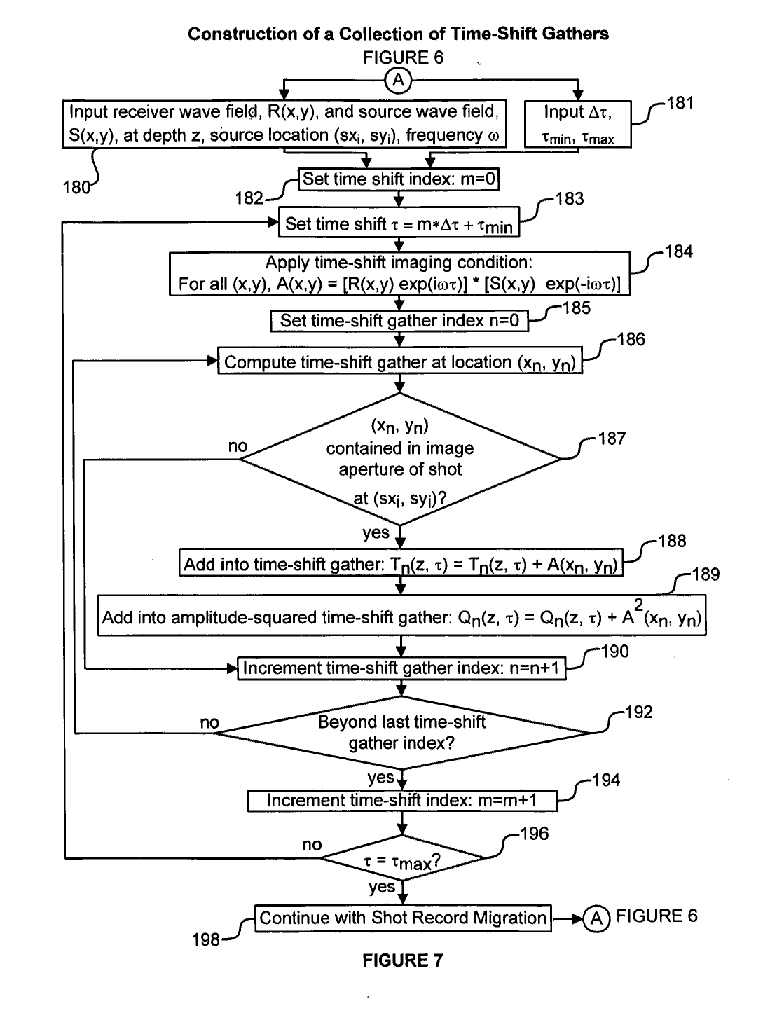

The method of FIG. 6 will populate the appropriate row of all time-shift gathers (See FIG. 4) at each depth by applying the time-shift imaging condition (See FIG. 7) to the source wave field S and the receiver wave field R at step 164. After application of the time-shift imaging condition, the method increments the depth index at step 166. If the maximum depth zₘₐₓ was exceeded at step 168, the method proceeds to the next shot gather. If not, the method returns to process the next depth at step 158. The method increments the shot gather index at step 170. If the final shot has been migrated, then at step 172, the method continues to the next frequency. Otherwise, the method returns to process the next shot gather at step 146. The method increments the frequency index at step 174. If the maximum frequency, ωₘₐₓ has been migrated, then at step 176, the method exits to write a file containing the time-shift gathers and the amplitude-squared time shift gathers at step 178. If not, the method returns to process the next frequency at step 142.

FIG. 7 illustrates computation of a collection of time-shift gathers for a single frequency, ω, a single shot gather located at (sxᵢ, syᵢ), and a single depth, z. The method time shifts the source wave field S and receiver wave field R from the shot record migration and correlates them for an ensemble of time shifts. For each time shift, the method extracts the time shifted trace at each time shift location within the current shot image aperture. The method enters at step 164 from the method of FIG. 6. At step 180, the method inputs the source wave field S and the receiver wave field R. As in FIG. 4, the method applies the time-shift imaging condition for a plurality of time shifts. At step 181, the method inputs the axis parameters for the time shift variable τ. It is simplest to parameterize each time shift in terms of the minimum time shift τₘᵢₙ the spacing between adjacent time shifts Δτ, and the maximum time shift τₘₐₓ. In an alternative embodiment, the method can use irregularly-spaced time shifts. At step 182, the method initializes the time-shift index m to 0. At step 183, the method computes the current time shift t by the linear relation τ=m*Δτ+τₘᵢₙ. At step 184, the method applies the time shift in the frequency domain via multiplication with the complex exponential exp(−iωτ) to the down-going source wave field S and similarly applies time shift exp(iωτ) to the up-going receiver wave field R. The method then multiplies the time shifted receiver wave field with the complex conjugate of the time shifted source wave field point-wise at each (x, y) location. The method stores the result in a temporary array A. At step 185, the method initializes the time-shift gather location index n to 0. At step 186, the method reads the current time-shift gather location (xₙ, yₙ). The user inputs a list of time-shift gather locations and shot image aperture dimensions at run-time. At step 187, if (xₙ, yₙ) lies inside the current shot image aperture (See FIG. 5), the method adds the local value of the temporary array A at (xₙ, yₙ) in the appropriate row of the time-shift gather at step 188, and adds the square of the local value of the temporary array A at (xₙ, yₙ) in the appropriate row of the amplitude-squared time-shift gather at step 189. At step 190, the method increments the time-shift gather index. If (xₙ, yₙ) does not lie inside the current shot image aperture, the method proceeds to step 190 without executing steps 188 and 189. If, at step 192, the method determines that the time-shift gather index exceeds the last time-shift gather index, the method proceeds to the next time shift value. Otherwise, the method returns to step 186 to process the next time-shift gather. At step 194, the method increments the time-shift index. If the method determines that the current time shift τ exceeds the maximum time-shift index τₘₐₓ at step 196 the method continues to step 198 at which point it returns at step 166 to the shot record migration in FIG. 6. If not, the method returns to step 183 to process the next time-shift value.

From FIG. 4, it can be seen that on a time-shift gather, the image is best focused at some τ_{f}, which may or may not be equal to zero. In an embodiment, the invention relates τ_{f} to a change in velocity. Adding this change in velocity to the migration velocity better approximates the propagation velocity which will produce more accurate images of the earth's geology. To make the focusing information on a time-shift gather more readily understood, the method converts the time-shift gathers and amplitude-squared time-shift gathers to semblance gathers.

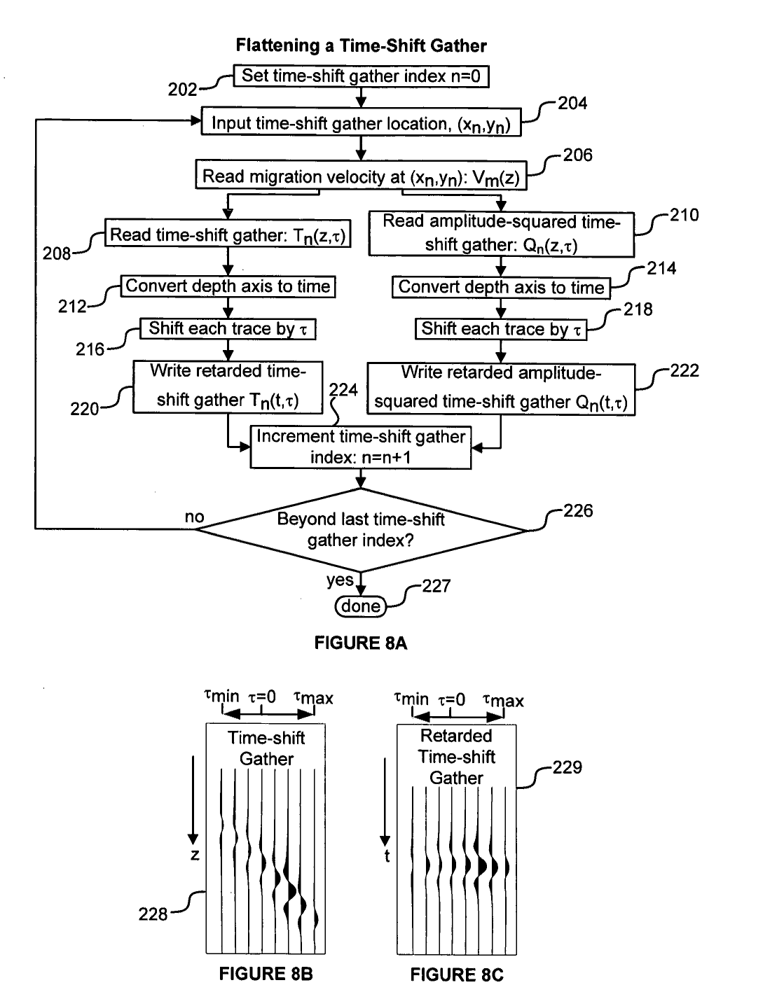

FIGS. 8A-8C illustrate an optional and intermediate step in computing semblance gathers, referred to as “retardation” or flattening. After retardation, the slanting reflection events on a time-shift gather and amplitude-squared time-shift gather are approximately flat as a function of time shift τ.

In FIG. 8A at step 202, the method initializes the time-shift gather index n to 0. At step 204, the method reads the current time-shift gather location (xₙ, yₙ) from the trace header of a time-shift gather file. At step 206, the method reads a single trace, Vₘ(z), from the migration velocity cube at location (xₙ, yₙ). At step 208, the method reads the current time-shift gather. At step 210, the method reads the current amplitude-squared time-shift gather. Using the migration velocity, the method converts the depth axis of the current time-shift gather and amplitude-squared time-shift gather to time at steps 212 and 214, respectively. For each trace in the current time-shift gather, the method applies a vertical shift of magnitude τ at step 216. The method also applies a vertical shift of magnitude τ to the current amplitude-squared time-shift gather at step 218. To a first order, the method flattens each event on the time-shift gather with respect to τ about τ=0. At step 220, the current retarded time-shift gather is written. At step 222, the current retarded amplitude-squared time-shift gather is written. At step 224 the time-shift gather index n is incremented. If, at step 226, the time-shift gather index exceeds the number of time-shift gathers, then the method exits at step 227. If not, the method returns to step 204 to read the next time-shift gather.

FIGS. 8B and 8C illustrate the flattening or retardation step. FIG. 8B shows a time-shift gather 228 computed when the migration velocity was faster than the propagation velocity (same as in FIG. 4). FIG. 8C shows the result of converting the depth, z, axis of time-shift gather 228 to time, t, and flattening of the slanting seismic event about τ=0, to form retarded time-shift gather 229.

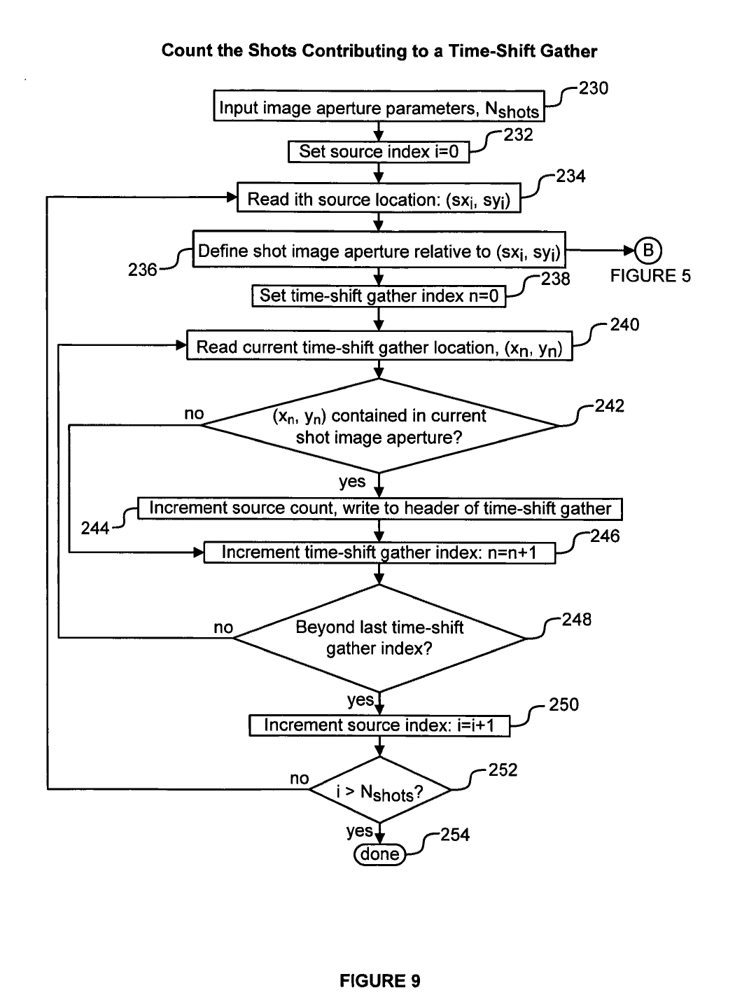

The number of shot record images that contribute to a time-shift gather location can be used to compute the semblance as shown in FIG. 9. As shown in FIG. 5, each shot gather image has a finite aperture which may not contain every time-shift gather location. At step 230, the method inputs the total number of shot gathers, Nₛₕₒₜₛ, and parameters describing the size of the shot image aperture. At step 232, the method initializes the source index i to 0. At step 234, the method reads the ith source location (sxᵢ, syᵢ) from the trace header of any trace in the current shot gather. At step 236, the method defines the shot image aperture. At step 238, the method initializes the time-shift gather index n. At step 240, the method reads the nth time-shift gather location (xₙ, yₙ) from the trace header of any trace in the current time-shift gather. At step 242, the method arrives at a decision block: if (xₙ, yₙ) is inside the shot image aperture corresponding to the source location (sxᵢ, syᵢ), then the method increments the count of sources contributing to the current time-shift gather and writes that count in the trace header of the time-shift gather file at step 244. If (xₙ, yₙ) is not inside the image aperture, then the method skips step 244 and increments the time-shift gather index at step 246. If the time-shift gather index is beyond the maximum time-shift gather index, then at step 248, the method processes the next shot gather at step 250. If not, the method processes the next time-shift gather at step 240. The method next increments the shot gather index at step 250. If, at step 252, the shot gather index is beyond the maximum number of shot gathers Nₛₕₒₜₛ, the method terminates at step 254. If not, the method returns to step 234 to process the next shot gather.

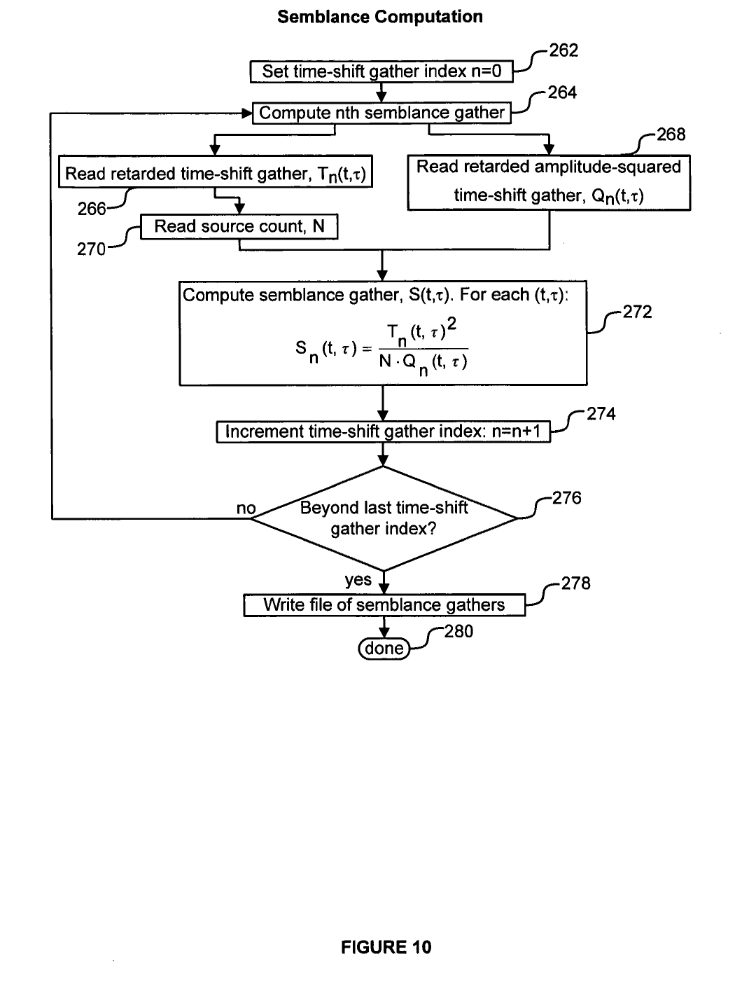

The semblance computation is illustrated in FIG. 10. At step 262, the method initializes the time-shift gather index n to 0. At step 264, the method begins to process the nth semblance gather. At steps 266 and 268, respectively, the method reads the current retarded time shift gather and retarded amplitude-squared time-shift gather and stores the two-dimensional arrays, Tₙ and Qₙ. At step 270, the method reads the number, N, of shot gather images contributing to the current time-shift gather (See FIG. 9) from the trace header. At step 272, the method computes the semblance gather using the current time-shift gather, the amplitude-squared time-shift gather, and the source count. Each sample of the two-dimensional semblance gather, Sₙ(t, τ) is filled according to the following relation:

$${S}_{n} ( t , τ ) = \frac{{{T}_{n} ( t , τ )}^{2}}{N \cdot {Q}_{n} ( t , τ )} , \qquad ( 1 )$$

where Tₙ(t, τ) corresponds to a sample from the current retarded time-shift gather and Qₙ(t, τ) corresponds to a sample from the current retarded amplitude-squared time-shift gather. The computed semblance gather Sₙ is everywhere positive with a maximum at the point of best focusing, (t_{f}, τ_{f}).

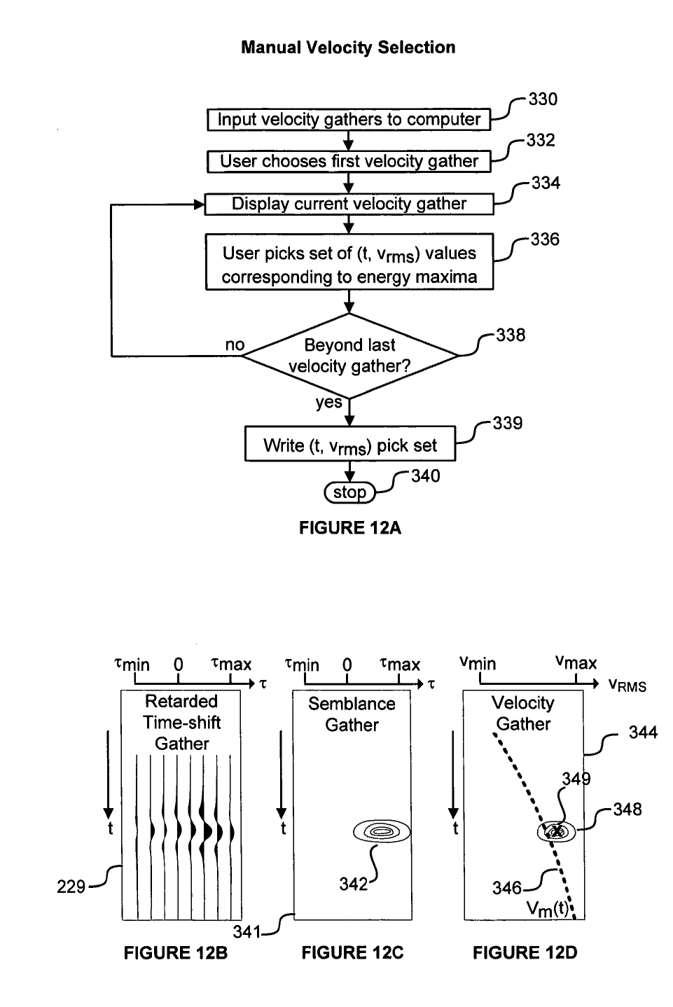

A semblance gather 341 is shown in FIG. 12C. The energy peak 342 has a maximum at the same (t, τ) as the corresponding retarded time-shift gather 229 as shown in FIG. 8C.

At step 274 in FIG. 10, the method increments the time-shift gather index. If, at step 276, the time-shift gather index is greater than the total number of time-shift gathers, the method writes a file of semblance gathers at step 278. If not, the method computes the next semblance gather at step 264. The method exits at step 280.

The semblance computation of equation (1) represents only one embodiment for facilitating the interpretation of energy peaks on the time-shift gathers. In alternative embodiments, other forms of semblance may be computed. For example, MacKay and Abma, Imaging and velocity estimation with depth-focusing analysis, Geophysics, v. 57, p. 1608 (1992), which is incorporated by reference, describe using the envelope function, which may be used in our invention to compute other forms of coherence rather than semblance. The method can utilize the energy peaks directly on time-shift gathers without using any coherence calculation. Additionally, the method can compute the semblance in depth first then convert to time and apply the retardation to the semblance. The order in which this is done is not essential to the invention. It is also possible for the method to perform the optional retardation step after applying a semblance measure.

In an embodiment, the invention transforms a time-shift parameter, t to a change in velocity. The physical basis of this transformation is the relation of the time shift parameter as shown in FIG. 3B. Δt is the amount of time separating the energy peaks on a downward continued data trace and downward continued simulated source trace at depth zᵣ. Δt represents the travel time of a reflection event from source position sᵣ to the focusing depth z_{f} and back to the receiver position gᵣ. When the migration velocity is correct, Δt is zero and the change in velocity will be zero.

Levin, Apparent velocity from dipping interface reflections, Geophysics 36, p. 510 (1971), which is incorporated by reference herein, gives an equation (“Levin's equation”) that expresses the travel time of a seismic event from a dipping reflector in terms of the “zero-offset travel time” t₀, velocity c, dip angle θ, and “half offset” h:

c²t²=c²t₀²+4h² cos² θ. (2)

An embodiment of the invention uses Levin's equation (2) as a starting point in the derivation of equations (14), (17), and (18), which are used to implement the method. That derivation follows below.

The present invention understands that in the course of shot record migration the shot gather and the simulated source trace are both downward continued to some depth Z using the migration velocity. In an embodiment, the method interprets the time t as the travel time through a “replacement overburden” having a velocity with characteristics that allow use of Levin's equation from earth's surface down to depth Z. The method relates depth Z to t₀ exactly for the constant velocity case even for dipping events. When the velocity is represented as a RMS velocity then the relation of Z to t₀ is exact for flat events and approximate for dipping events. Since the half offset h, the zero offset time t₀, and even the exact velocity, are not easily available during shot record downward continuation, the method eliminates these variables from equation (2) in favor of known quantities such as the migration velocity and travel time t.

Define Z as the vertical depth to the reflection point when h=0. Then Levin's equation (2) can be rewritten in terms of Z:

$${c}^{2} {t}^{2} = \frac{4 {Z}^{2}}{{cos}^{2} θ} + 4 {h}^{2} {cos}^{2} θ . \qquad ( 3 )$$

The method holds t, θ, and h constant and perturbs the velocity in equation (3), leading to a perturbed depth. The method defines the perturbed velocity v(t) and the perturbed depth Z′ and rewrite equation (3):

$${v ( t )}^{2} {t}^{2} = \frac{4 {Z}^{′2}}{{cos}^{2} θ} + 4 {h}^{2} {cos}^{2} θ . \qquad ( 4 )$$

The method subtracts equation (3) from (4) to derive a relationship between a perturbation in velocity Δv(t) and a perturbation in depth Δz:

$$\begin{matrix}Δ v ( t ) = \frac{\overline{Z}}{\overline{v}} \frac{4 Δ z}{{t}^{2} {cos}^{2} θ} , & ( 5 ) \\ Δ v ( t ) ≡ v ( t ) - c ; \\ Δ Z ≡ {Z}^{′} - Z ; \\ \frac{\overline{Z}}{\overline{v}} = \frac{Z + Δ Z / 2}{c + Δ v ( t ) / 2} . & ( 6 )\end{matrix}$$

The method evaluates equation (3) at h=0, then relates ΔZ to a perturbation in zero offset travel time, Δt₀:

$$Δ Z = Δ {t}_{0} \frac{c}{2} cos θ . \qquad ( 7 )$$

The method also manipulates equation (2) to relate perturbations in zero offset travel time Δt₀, to perturbations in non-zero offset travel time Δt. The method perturbs t₀ and t and algebraically rearranges equation (2) to obtain:

$$2 t Δ t ( 1 + \frac{Δ t}{2 t} ) = 2 {t}_{0} Δ {t}_{0} ( 1 + \frac{Δ {t}_{0}}{2 {t}_{0}} ) . \qquad ( 8 )$$

Starting with equation (4), the method inserts the relation for average depth-to-velocity ratio from equation (6) and then uses equation (7) to replace the ΔZ terms with Δt₀ terms to obtain:

$$Δ v ( t ) = \frac{{ct}_{0} Δ {t}_{0}}{{t}^{2}} ( 1 + \frac{Δ {t}_{0}}{2 {t}_{0}} ) {( 1 + \frac{Δ v ( t )}{2 c} )}^{- 1} . \qquad ( 9 )$$

The method recognizes a term that looks like the right-hand side of equation (8) in equation (9), and eliminates t₀ from equation (9) to obtain:

$$Δ v ( t ) = \frac{c Δ t}{t} ( 1 + \frac{Δ t}{2 t} ) {( 1 + \frac{Δ v ( t )}{2 c} )}^{- 1} . \qquad ( 10 )$$

The method further algebraically manipulates the last component of equation (10) to obtain:

$${( 1 + \frac{Δ v ( t )}{2 c} )}^{- 1} = ( 1 - \frac{Δ v ( t )}{v ( t )} ) {( 1 - \frac{Δ v ( t )}{2 v ( t )} )}^{- 1} . \qquad ( 11 )$$

The method also uses the fact that:

$$c = v ( t ) ( 1 - \frac{Δ v ( t )}{v ( t )} ) . \qquad ( 12 )$$

The method uses relations (11) and (12), plus algebraic manipulations to modify equation (10) into the following relationship between Δt and change in RMS velocity, Δv(t):

$$\frac{Δ t}{t} = - 1 + \sqrt{1 + \frac{2 \frac{Δ v ( t )}{v ( t )} ( 1 - \frac{Δ v ( t )}{2 v ( t )} )}{{( 1 - \frac{Δ v ( t )}{v ( t )} )}^{2}}} , \qquad ( 13 )$$

Finally, the method associates Δt in equation (13) with the migration time shift parameter τ to obtain a relationship between Δv(t) and τ:

$$\frac{τ}{t} = - 1 + \sqrt{1 + \frac{2 \frac{Δ v ( t )}{v ( t )} ( 1 - \frac{Δ v ( t )}{2 v ( t )} )}{{( 1 - \frac{Δ v ( t )}{v ( t )} )}^{2}}} , \qquad ( 14 )$$

A feature of the invention is the independence of equation (14) from reflector dip and offset. Further, equation (14) is exact in the case of constant velocity and arbitrary reflector dip, and also exact in the case of depth variable velocity and flat reflectors.

The method simplifies equation (14) by defining relative velocity and time shifts α and β:

$$α ≡ \frac{Δ v ( t )}{v ( t )} ; \\ β ≡ \frac{τ}{t} . \qquad ( 15 )$$

The method uses relations (15) to recast equation (14) as a quadratic equation in α and β. After common algebraic rearrangements of equation (15), the method obtains:

$$\frac{{β}^{2}}{2} + β - \frac{α ( 1 - \frac{α}{2} )}{{( 1 - α )}^{2}} = 0. \qquad ( 16 )$$

The method solves quadratic equation (16), expands the square root to three terms, and keeps only terms of order α², to obtain an approximation to equation (14):

$$\frac{τ}{t} = \frac{Δ v ( t )}{v ( t )} ( 1 + \frac{Δ v ( t )}{v ( t )} ) . \qquad ( 17 )$$

Equation (17) is quite accurate. For a relative velocity perturbation of 10% (α=0.1), the correct result is β=0.1111 . . . , while equation (17) yields a result of β=0.11, implying an error of only 0.1%.

Another, less accurate, approximation to equation (14) is applicable when Δv(t)/v(t)<<1:

$$\frac{Δ v ( t )}{v ( t )} \approx \frac{τ}{t} . \qquad ( 18 )$$

The analysis above can be repeated for depth-variable velocity. The method assumes that the reflector depth is controlled by the average velocity and repeats the analysis above, yielding a result similar to equations (14), (17), and (18), except that v(t) is replaced with RMS velocity.

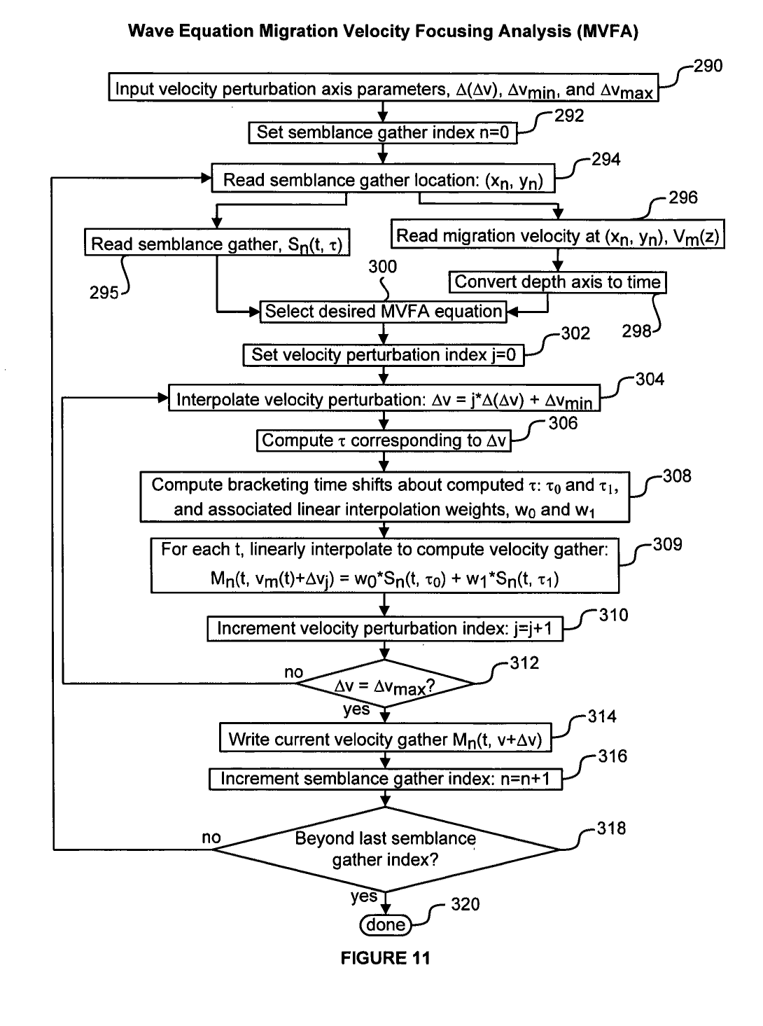

The computer implemented methods of equations (14), (17), and (18) are shown in FIG. 11. At step 290, the method inputs the axis parameters for the Δv axis: the minimum value, Δvₘᵢₙ, the increment between adjacent samples, Δ(Δv), and the maximum value, Δvₘₐₓ. At step 292, the method initializes the semblance gather index n. At step 294, the method reads the nth semblance gather location, (xₙ, yₙ) from the trace header of any trace in the semblance gather. At step 295, the method reads the current semblance gather into a two-dimensional array, Sₙ(t, τ). At step 296, the method reads the trace of the migration velocity at (xₙ, yₙ) into a one dimensional array. At step 298, the method converts the depth axis of the velocity to time. At step 300, the method permits the user to select one of the migration velocity focusing analysis (MVFA) equations, that is equation (14), (17), or (18). The MVFA transformation represents a time-dependent stretch of the τ axis of a semblance gather to Δv.

The method loops over the output domain Δv. At step 302, the method initializes the velocity perturbation index j to 0. At step 304, the method computes the current Δv by the linear equation Δv=j*Δ(Δv)+Δvₘᵢₙ. At step 306, the selected MVFA equation computes the value of τ corresponding to the current value of Δv. At step 308, the method computes the two grid points, τ₀ and τ₁, on the τ-axis bracketing the value of τ. The method computes the linear interpolation weights, w₀ and w₁ according to the relations w₀=(τ₁−τ)/Δτ and w₁=1−w₀, where Δτ is the distance between adjacent τ grid points on Sₙ(t, τ). For each time t the method averages the values of the semblance gather at the two bracketing grid points to produce one sample of the velocity gather Mₙ(t, vₘ(t)+Δv) at step 309. Although the MVFA mapping of equations (14), (17), or (18) is between τ and Δv, in the mapping shown at step 309, τ is mapped to v+Δv. The method may also define the velocity gather only in terms of Δv. At step 310, the method increments the velocity perturbation index. If, at step 312, the current Δv value is equal to Δvₘₐₓ, the method proceeds to step 314. If not, the method returns to process the next velocity perturbation at step 304. At step 314, the method writes the recently computed velocity gather. At step 316, the method increments the semblance gather index. If the semblance gather index is beyond the last semblance gather index at step 318, the method terminates at step 320. If not, method returns to step 294 to compute the next velocity gather.

After the method converts a semblance gather to a velocity gather as described by FIG. 11, the method maps a given energy peak on the semblance gather, (t_{f}, τ_{f}) to an energy peak on the velocity gather (t_{f}, vᵣₘₛ+Δvᵣₘₛ). FIG. 12C shows an energy peak 342 on a semblance gather 341. The method maps that energy peak to a corresponding energy peak 348 on the velocity gather 344 as shown in FIG. 12D. The migration velocity 346, Vₘ(t) is plotted as a thick dotted line. If, as in FIG. 12D, the migration velocity is too slow, the energy peak on the velocity gather 344 indicates that a higher velocity is needed to approximate the propagation velocity. The method defines the output velocity gather in terms of total updated velocity (vᵣₘₛ+Δvᵣₘₛ). The method may also define the velocity gather in terms of velocity change Δvᵣₘₛ alone.

FIGS. 12-14 illustrate a method to update the migration velocity to approximate the true propagation velocity. FIG. 12A illustrates that the host can display the results to human who can visually pick the energy peaks of the velocity gathers. At step 330, the velocity gather file is input to an application which allows a user to view a velocity gather, pick individual points in (t, vᵣₘₛ) space and save the points to a file. Many suitable software applications exist such as the GSEGYView viewer, which is available and can be downloaded from SourceForge at www.sourceforge.net. The user can loop over the desired velocity gathers as described earlier. Starting with the first velocity gather at step 332, the method displays the current velocity gather at step 334. At step 336, the user selects energy maxima on the current velocity gather that correspond to the subsurface reflection events. If the user has reached the last velocity gather at step 338, then at step 339, the user's selection of (t, vᵣₘₛ) is written to a file and the method terminates at step 340.

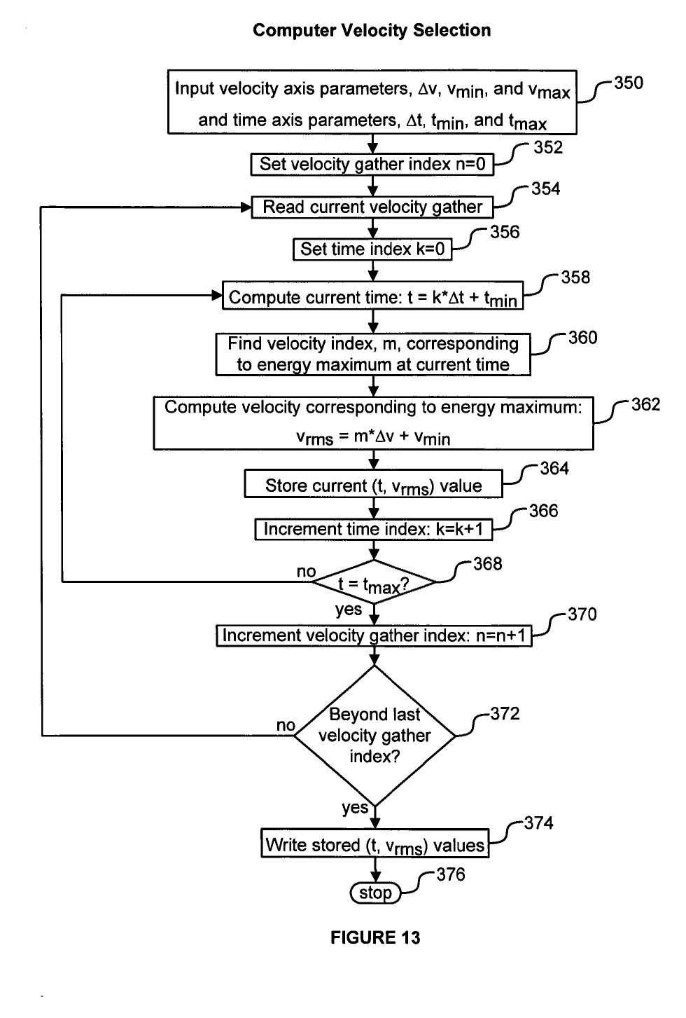

FIGS. 12B, 12C, and 12D illustrate the processing sequence from retardation of time-shift gathers to semblance gathers to picking velocities on velocity gathers. The retarded time-shift gather 229 shown in FIG. 12B is the same as retarded time-shift gather 229 shown in FIG. 8C. The energy peak 342 on the corresponding semblance gather 341 is shown in FIG. 12C. FIG. 12D shows how energy peak 342 on FIG. 12C is mapped to an energy peak 348 on the velocity gather 344. The migration velocity 346, Vₘ(t), is plotted as a thick dotted line. If the migration velocity is too slow, the energy peak 348 on the velocity gather 344 indicates that a velocity speedup is needed to better approximate the true propagation velocity. The bold “x” symbol 349 represents a single (t, vᵣₘₛ) selection that can be made by a human interpreter as described in FIG. 12A or by a computer as described below in FIG. 13. The collection of all (t, vᵣₘₛ) picks on all velocity gathers can be used to update the migration velocity.

FIG. 13 illustrates a computer implemented method that selects the energy peaks on velocity gathers. At step 350, the method inputs the axis parameters for the velocity axis: the minimum value vₘᵢₙ, the increment between adjacent samples Δv, and the maximum value vₘₐₓ. The velocity gather's horizontal axis is parameterized in terms of velocity and not the velocity perturbation. Also at step 350, the method inputs the axis parameters for the time axis, the minimum value tₘᵢₙ, the increment between adjacent samples Δt, and the maximum value tₘₐₓ. At step 352, the method initializes the velocity gather index n to 0. At step 354, the method reads the current velocity gather into a two-dimensional array, the axes of which are time and velocity. At step 356, the method initializes the time index k to 0. At step 358, the method computes the current time t by the linear equation t=k*Δt+tₘᵢₙ. At step 360, the method computes the velocity index m, corresponding to the maximum value of the row of the velocity gather at the current time index. At step 362, the method computes the RMS velocity, vᵣₘₛ, corresponding to the velocity index m by the linear equation vᵣₘₛ=m*Δv+vₘᵢₙ. At step 364, the method stores the current (t, vᵣₘₛ) value corresponding to the current energy peak. At step 366, the method increments the time index. If the time corresponding to the incremented time index exceeds tₘₐₓ at step 368, the method proceeds to step 370. If not, the method returns to step 358 to process the next time value. At step 370, the method increments the velocity gather index. If, at step 372, the velocity gather index exceeds the maximum velocity gather index, the method proceeds to step 374. If not, the method returns to step 354 to process the next velocity gather. At step 374, the method writes the stored collection of (t, vᵣₘₛ) values. At step 376, the method exits.

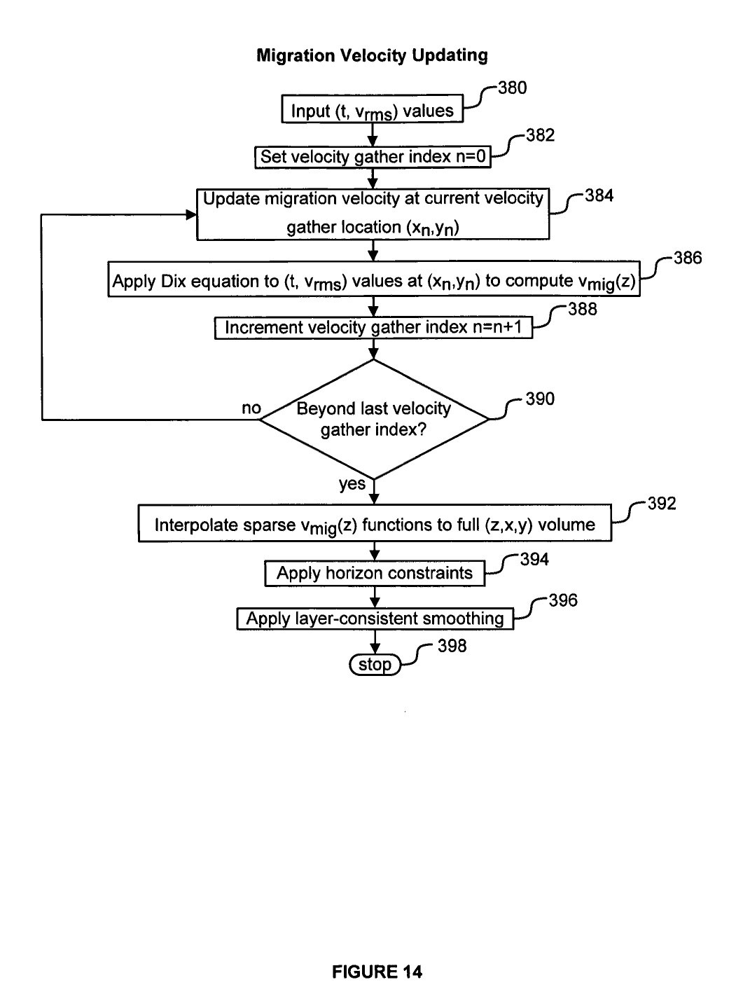

FIG. 14 illustrates how the energy peaks selected by the methods of FIG. 12 or FIG. 13 can be used to update the migration velocity. At step 380, the method inputs the energy peaks from either FIG. 12 or FIG. 13. At step 382, the method initializes the velocity gather index n. At step 384, the method updates the migration velocity at the current velocity gather location. At step 386, the method uses the (t, vᵣₘₛ) selected at the current velocity gather location to derive an interval velocity, v_{mig}(t), as a function of depth by solving the Dix equation with feasibility constraints (i.e., greater than a realistic minimum velocity and less than a realistic maximum velocity) on the value of the velocity. The Dix equation is described in C. H. Dix, Seismic velocities from surface measurements, Geophysics, v. 20, p. 68 (1955), which is incorporated by reference herein. At step 388, the method increments the velocity gather index. If the method determines the last velocity gather index has been exceeded at step 390, the method proceeds to step 392. If not, the method returns to process the next velocity gather at step 384. After the velocity gather locations have been processed, the method interpolates the collection of sparsely sampled interval velocity functions, v_{mig}(t), at step 392 to form a fully sampled volume of updated migration velocities. At step 394, the method applies constraints to enforce mathematical properties (i.e., continuity of the velocity and/or the first derivative) across the interpreted geologic interfaces. At step 396, the method applies polynomial smoothing to smooth the velocity within each geologic layer defined by the user. At step 398, the method exits. It should be noted that steps 386, 392, 394, and 396 may be accomplished using the SeisPak software system, described earlier.

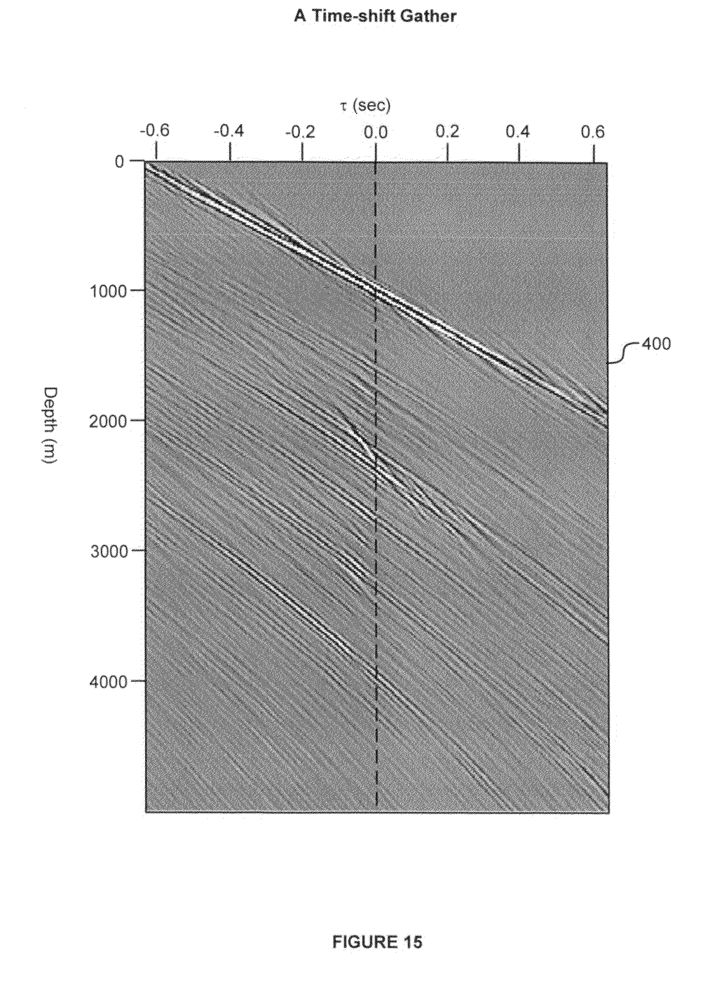

As noted above, velocity analysis using the invention begins with time-shift gathers, computed with a wave equation shot record depth migration algorithm. FIG. 15 illustrates an actual time-shift gather 400 taken from a synthetic dataset migrated with an incorrect velocity. The velocity was correct above a depth of 2,500 m. For the deeper reflectors, the energy peaks are shifted away from τ=0 by as much as −0.15 second.

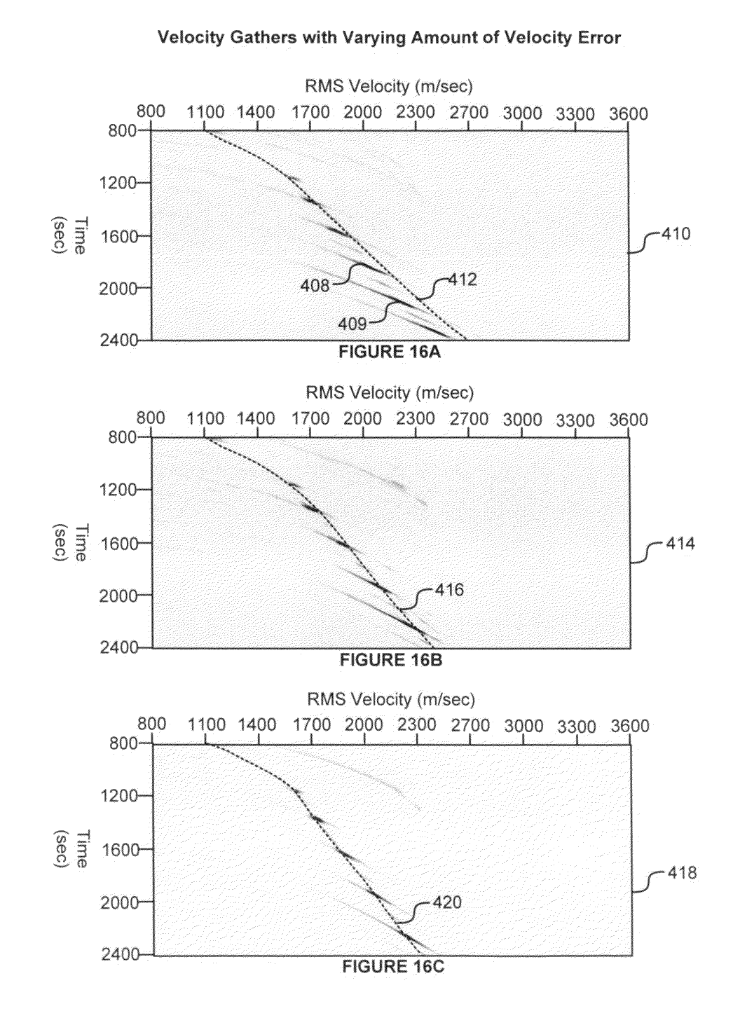

FIGS. 16-18 illustrate application of the invention to a complex 2D synthetic dataset designed to mimic geologic structures such as those found in the Belridge Field, Calif., USA. The synthetic example includes 200 m of topographic relief, a weathering layer of variable thickness, significant lateral velocity variation, and dips to 75 degrees. Shot gathers were simulated over a 10 km profile, using a pseudo-spectral acoustic wave equation solver, with frequencies up to 45 Hz. Density contrasts produce most of the reflections. After building an initial velocity model, two iterations of the method were applied to test the efficacy of the method.

FIGS. 16A-16C show velocity gathers computed using the synthetic land dataset. The thick dotted lines show the RMS migration velocity as a function of time. In an embodiment, the method updates the migration velocity by picking the velocity peaks and converting to an interval velocity using Dix equation, as shown in FIG. 14. The dark semblance peaks represent the RMS velocity implied by the method. The velocity gather 410 shown in FIG. 16A was computed using the initial migration velocity 412. The semblance peaks do not overlay the migration velocity, implying that the migration velocity should be slowed down or sped up. The velocity gather 414 shown in FIG. 16B was computed using the migration velocity 416 computed after two iterations of the method, and it can be seen that the semblance panels overlay the migration velocity more accurately than those shown in FIG. 16A, implying that the migration velocity is closer to the true propagation velocity. The velocity gather 418 shown in FIG. 16C was computed using the true propagation velocity 420. Comparing FIG. 16B to FIG. 16C, it is apparent that by applying two iterations of the method, the propagation velocity has been accurately computed.

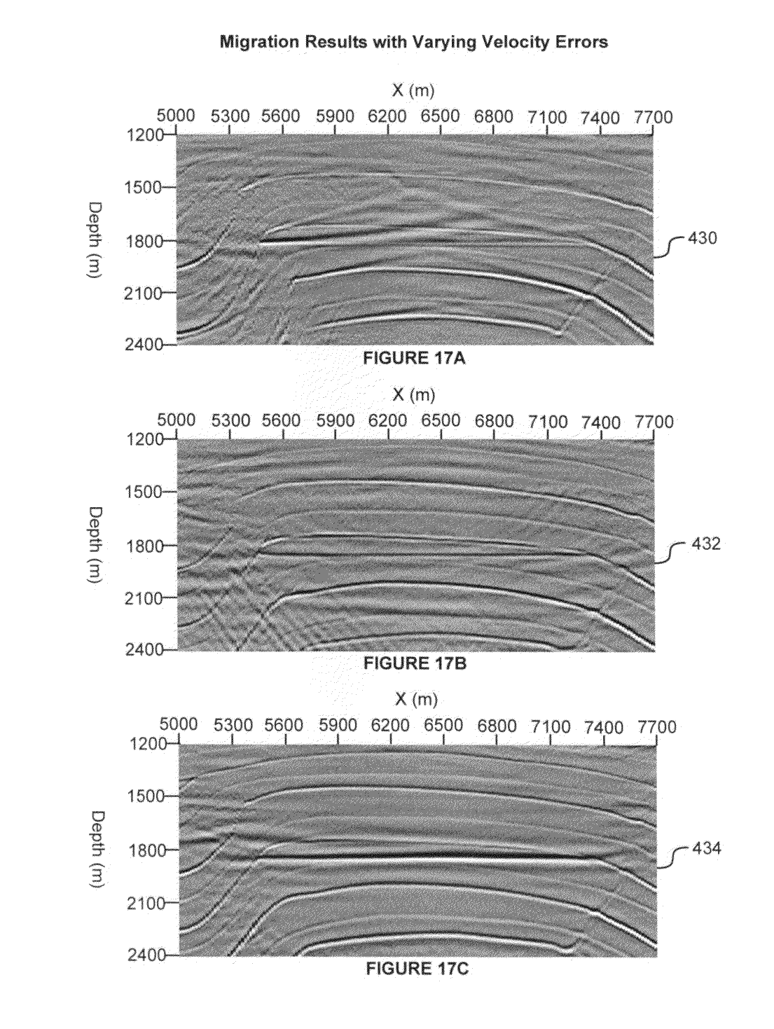

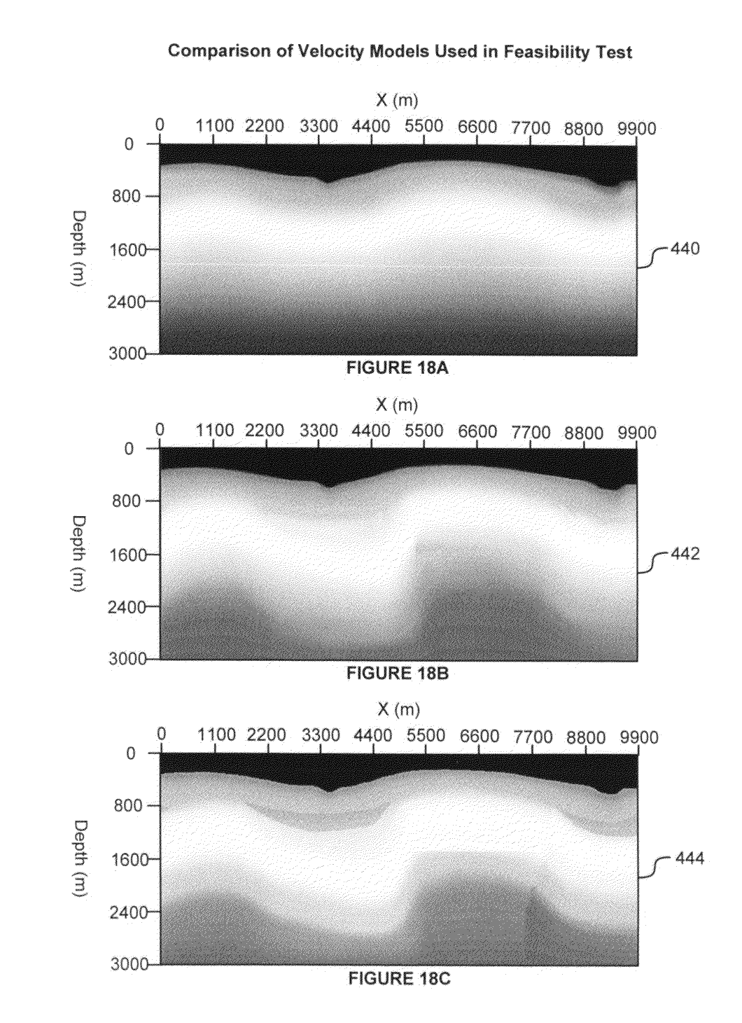

FIGS. 17A-17C show subsets of the shot record migration images corresponding to the initial migration velocity, the migration velocity after two iterations of the method, and the true propagation velocity. As shown in FIG. 17A, the image 430 obtained by migrating with the initial migration velocity has poor focusing of the steep dips on the left side of the anticline. As shown in FIG. 17B, after two iterations of the method, both the fault on the right side of the image 432 and the steep dips on the left side of the image are well-imaged, as are the steep dips. As shown in FIG. 17C, the image 434 obtained by migrating with the true propagation velocity matches the image 432 obtained by migrating with the velocity computed by the method. Some depth errors remain, mostly due to shallow low velocity pods that were not fully inverted for as shown in FIG. 18. However, the focusing and positioning of most events in image 432 shown on FIG. 17B confirms that the velocity obtained by applying two iterations of the method accurately approximates the true propagation velocity.

FIGS. 18A-18C show the initial migration velocity, the migration velocity after two iterations of the method, and the true propagation velocity. As shown in FIG. 18A, initial migration velocity 440 is simply a single v(z) function “hung” from the base of the weathering layer. As shown in FIG. 18B, after two iterations of the method, migration velocity 442 contains considerably more structure than the initial migration velocity. FIG. 18C shows the true propagation velocity 444. The computed velocity 442 is smoother than the true velocity 444. Also, several low velocity “pods” were not reproduced by the method. This is related to the velocity inversion scheme and parameterization of the model, rather than limitation of the invention. When justified by prior information such as well logs or geologic constraints, discontinuous velocity models can be computed. Still, comparing the migration velocity 442 to the initial velocity 440 and the true velocity 444, it is apparent that two iterations of the method have reconstructed the large velocity structures, which is a key element to achieve accurate event positioning after migration.

Our invention to compute the propagation velocity can be employed for seismic imaging. The invention outputs a volume (i.e., x-y-z values) of propagation velocity that can be input to an imaging method that takes in raw seismic data that has little resemblance to earth's geological layers and transforms this data into an image displayed on the host that contains clearly identifiable geological interfaces below the surface of the earth. The method also improves the fidelity of the reflection amplitude with respect to angle of incidence on the reflector.

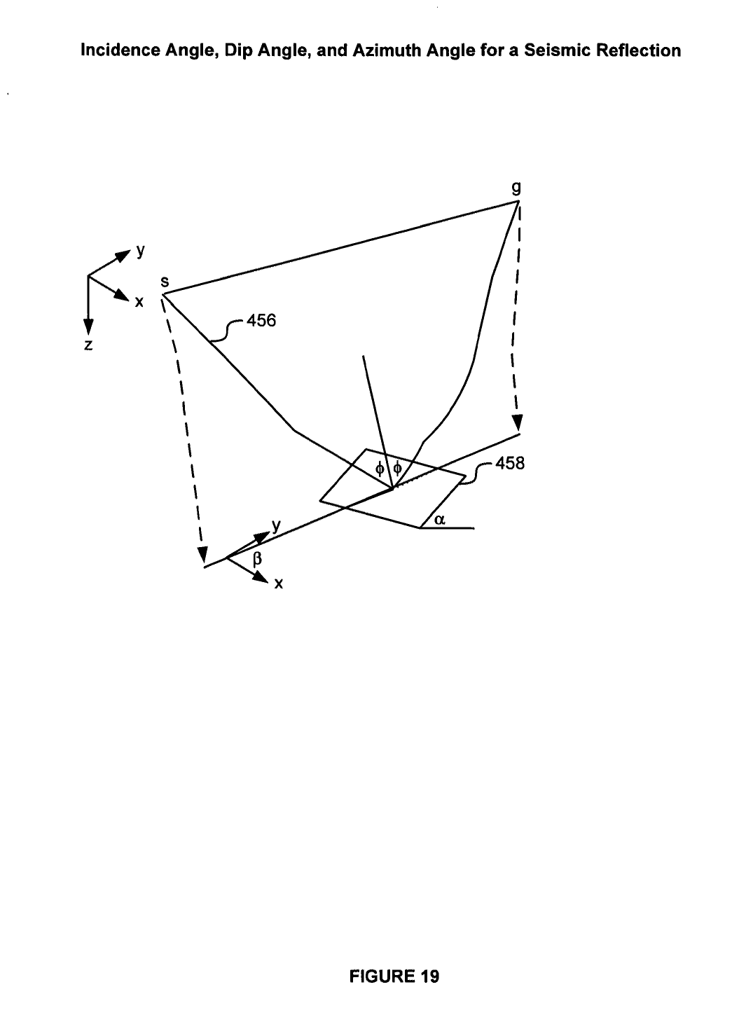

FIG. 19 illustrates three angles which describe a reflected seismic wave in three dimensions. The geometry of the reflected seismic wave is illustrated as a ray 456 from the source s to the target reflector 458 to the receiver g. In reality, wave propagation may not be describable through ray geometry; the schematic is for illustrative purposes only. The reflector makes an angle π/2−α with respect to the z axis; α is called the dip angle. The angle at the reflector made between the downgoing ray and the upgoing ray is 2φ; φ is called the incidence angle. Finally, at the reflector, the azimuth angle is β. At earth's surface the azimuth angle is the angle between the source and receiver location, relative to the x axis. As the analysis point is moved closer and closer to the reflector, the azimuth angle changes.

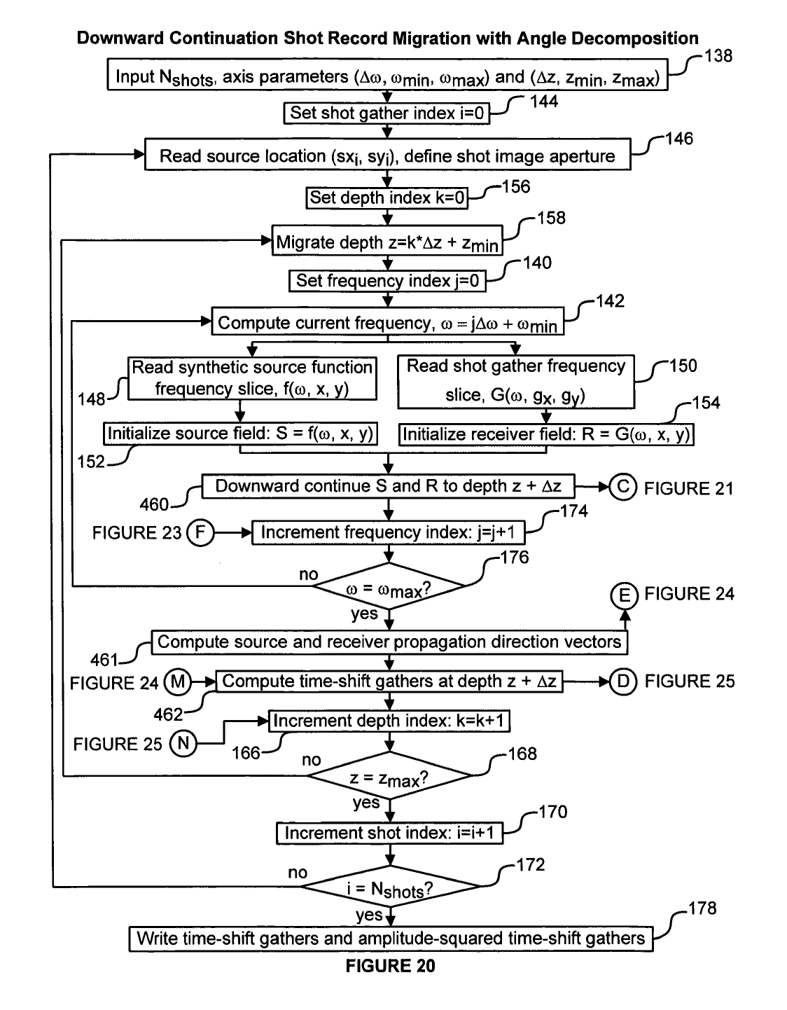

FIG. 20 illustrates downward continuation shot record migration with angle decomposition that uses propagation angles to generate time-shift gathers.

Steps 138-158 were described in FIG. 6 except now the order of loops over source, depth, and frequency changes. The source loop beginning at step 146 and ending at step 172 becomes the outer loop, the depth loop beginning at step 158 and ending at step 168 becomes the middle loop, and the frequency loop beginning at step 142 and ending at step 176 becomes the inner loop.

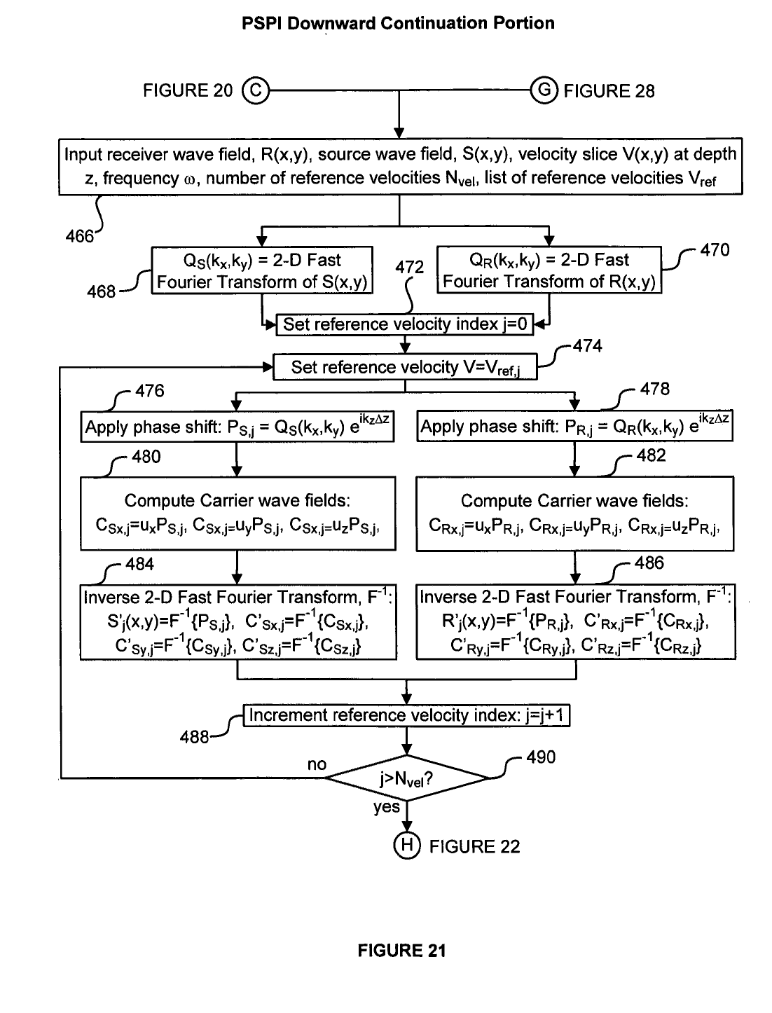

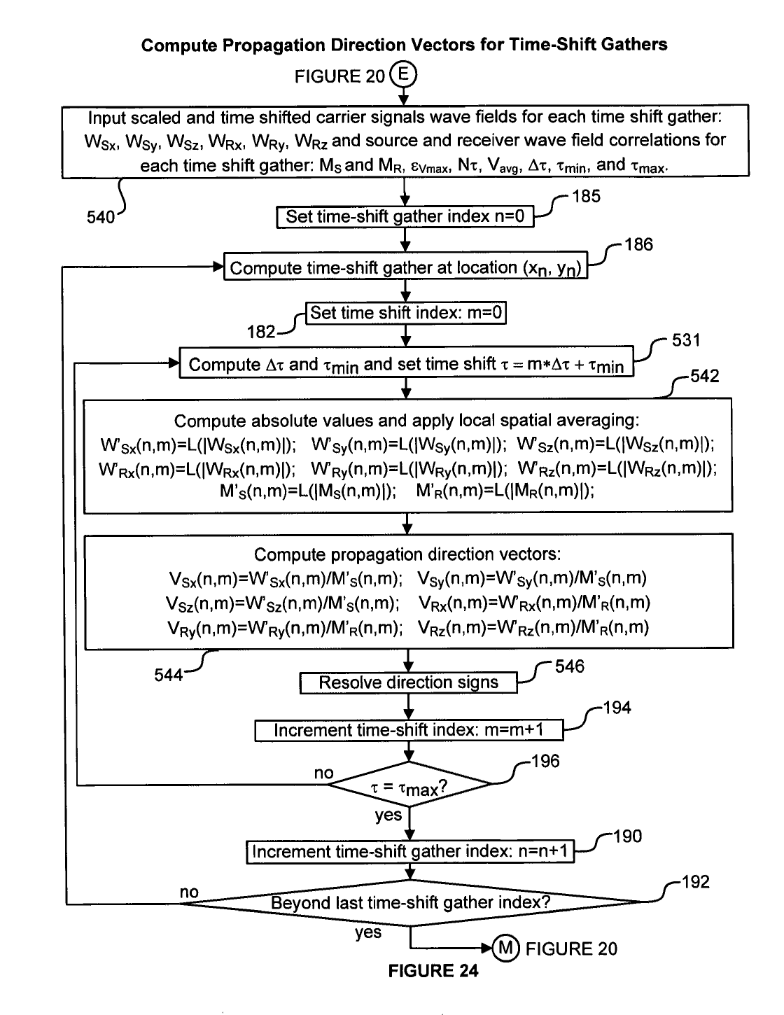

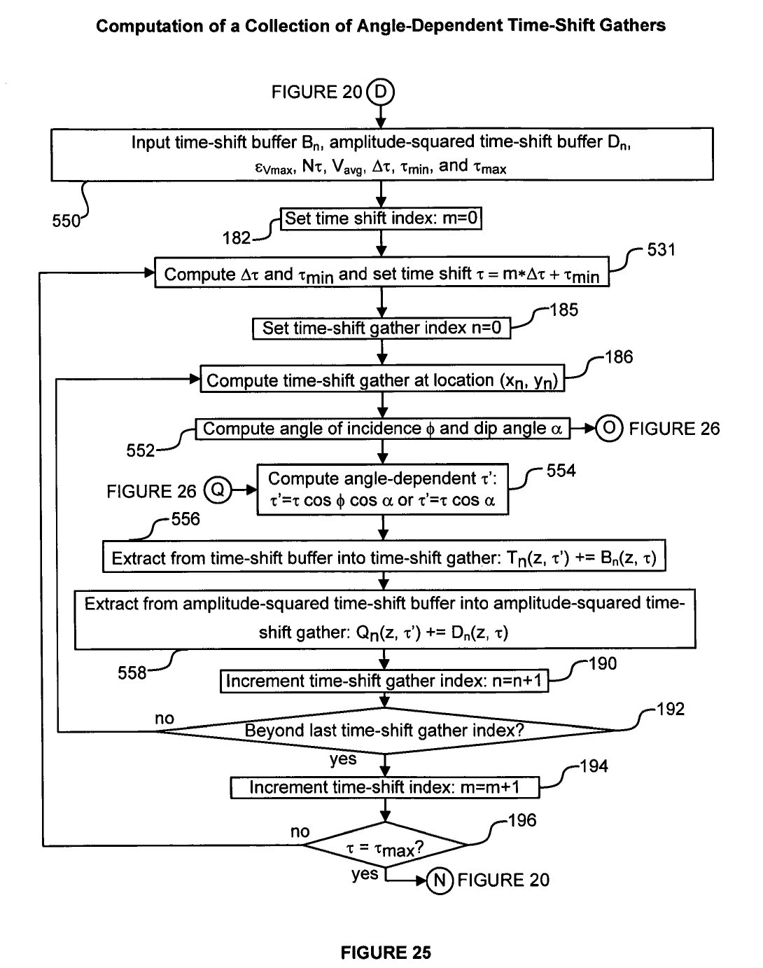

At step 460, the method downward continues the source and receiver wave fields to depth z+Δz and accumulates propagation direction vector information for the (x, y) locations where time-shift gathers are located as illustrated in FIG. 21. At step 461, the method computes propagation direction vectors as illustrated in FIG. 24. At step 462, the method computes time-shift gathers as illustrated in FIG. 25 using propagation direction vectors to compute incidence and dip angles at the reflector. The method outputs the time-shift gathers and amplitude-squared time-shift gathers at step 178.

FIGS. 21-23 illustrate a method of phase shift plus interpolation (PSPI) to downward continue the source and receiver wave fields. Gazdag and Sguazzero, Migration of seismic data by phase-shift plus interpolation, Geophysics, v. 49, p. 124 (1984), which is incorporated by reference, describe the background and details of PSPI. The method encodes propagation direction information into carrier wave fields in the Fourier domain where the information is accurately measured. The method then transforms the carrier wave fields back to the space domain where the encoded propagation direction information is decoded. The method accumulates the propagation direction information into the host(s) memory and transforms the information into propagation direction vectors as illustrated in FIG. 24.

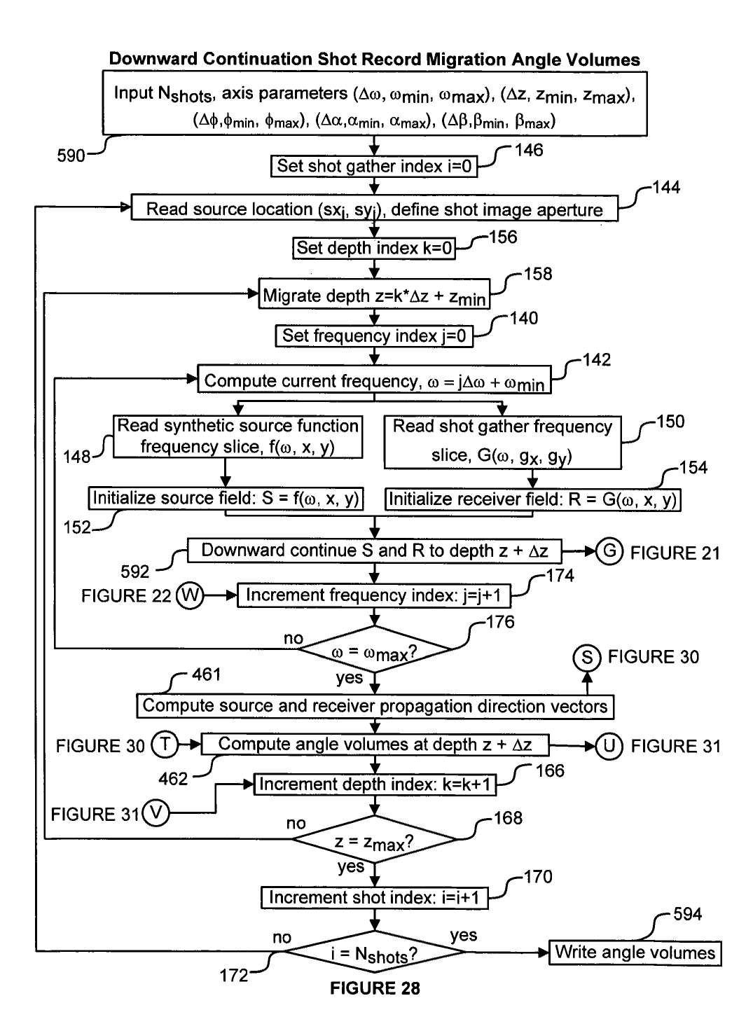

FIG. 21 illustrates using the phase shift portion of PSPI to downward continue the source and receiver wave fields. The method starts from either the method of FIG. 20 or the method of FIG. 28. At step 466, the method inputs the receiver wave field R(x,y), the source wave field S(x,y), a velocity slice V(x,y) at depth z, the frequency ω, the number of reference velocities Nᵥₑₗ, and a list of reference velocities V_{ref}. At steps 468 and 470, the method transforms the source and receiver wave fields with a Fast Fourier Transform (FFT) algorithm such as the FFT-W software described in Frigo and Johnson, FFTW: An adaptive software architecture for the FFT, Proc. 1998 IEEE Intl. Conf. Acoustics Speech and Signal Processing, vol. 3, pp. 1381-1384, which is incorporated by reference. The FFT-W software may be downloaded from www.fftw.org.

At step 472, the method sets a reference velocity index j=0. At step 474, the method selects the jth reference velocity from the list V_{ref}. At step 476, the method phase shifts a Fourier-Transformed source wave field Q_{S} using the vertical wave number k_{z}, which is a function of the horizontal wave numbers kₓ and k_{y}, the frequency ω, and the reference velocity:

$${k}_{z} = \sqrt{\frac{{ω}^{2}}{{V}^{2}} - {k}_{x}^{2} - {k}_{y}^{2}} .$$

At step 478, the method phase shifts the Fourier-Transformed receiver wave field Q_{R} in the same manner. At steps 480 and 482, the method forms six carrier wave fields by multiplying the Fourier-Transformed source and receiver wave fields computed at steps 476 and 478 by the following quantities:

$${u}_{x} = \frac{V}{ω} {k}_{x} , {u}_{y} = \frac{V}{ω} {k}_{y} , {u}_{z} = \frac{V}{ω} {k}_{z} . \qquad ( 19 )$$

At steps 484 and 486, the method inverse FFT's all the Fourier-Transformed wave fields. At step 488, the method increments the reference velocity index j. If the reference velocity index j exceeds Nᵥₑₗ at step 490, the method performs the method of FIG. 22. If not, the method returns to step 474.

FIG. 22 illustrates a method to perform the interpolation portion of PSPI on the source and receiver wave fields and on the carrier wave fields illustrated in FIG. 21. At step 500, the method inputs a velocity slice V(x,y), a list of reference velocities V_{ref}, a collection of source and receiver wave fields for each reference velocity, and a collection of carrier wave fields corresponding to the source and receiver wave fields for each reference velocity obtained in the method of FIG. 21.

At step 502, the method sets the x index k=1 and sets the y index m=1. At step 506, the method sets variable V′ with the value of the velocity slice V(x,y) at index k and index m. At step 508, the method finds reference velocity indices p and q such that reference velocity V_{P} is less than or equal to V′ and the reference velocity V_{q} is greater than or equal to V′.

At step 510, the method interpolates between the downward continued source and receiver wave fields corresponding to reference velocities p and q, producing interpolated source and receiver wave fields S′ and R′ at depth z+Δz for (x,y) indices k and m. The method defines the interpolation weight α as follows:

$$α = \frac{\frac{1}{{( {V}^{′} )}^{2}} - \frac{1}{{V}_{q}^{2}}}{\frac{1}{{V}_{p}^{2}} - \frac{1}{{V}_{q}^{2}}} . \qquad ( 20 )$$

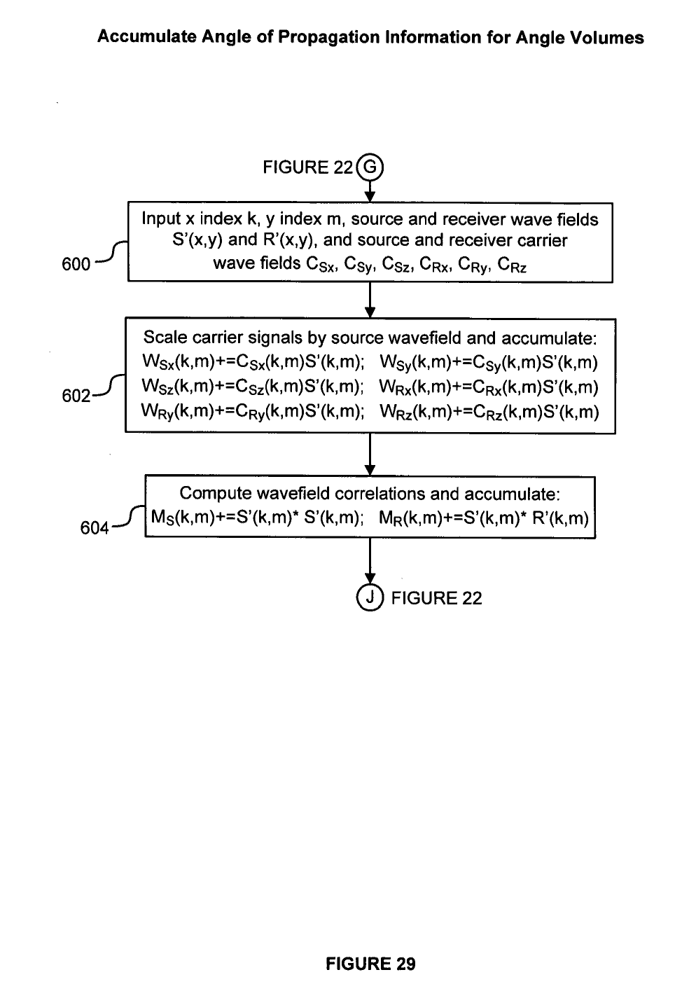

The method's value for a causes the interpolated wave field to satisfy the known scalar wave equation at the initial depth z. At step 512, the source and receiver carrier wave fields corresponding to reference velocities p and q are interpolated for (x,y) indices k and m using the value of α, producing interpolated source and receiver carrier wave fields C_{Sx}, C_{Sy}, C_{Sz}, C_{Rx}, C_{Ry}, and C_{Rz} at depth z+Δz. At step 514, the method determines if it is computing angle volumes. If so, the method proceeds to the method illustrated in FIG. 29. If not, the method proceeds to step 515. In either case, the method increments the y index m at step 515. At step 516, if index m exceeds the number of y grid points N_{y}, the method proceeds to step 518. If not, the method repeats steps 506 to 515 for the next (x,y) location. At step 518, the method increments the index k. At step 520, if index k exceeds the number of x grid points Nₓ, the method proceeds to step 524. If not, the method proceeds to step 522, resetting index m to 1, then repeats steps 506 to 518 for the next (x,y) location. At step 524, the method determines if it is computing angle volumes. If yes, the method proceeds to the method illustrated in FIG. 28. If not, the method proceeds to the method illustrated in FIG. 23.

FIG. 23 illustrates the accumulation of angle of propagation information for time-shift gathers. At step 530, the method inputs source and receiver wave fields S′(x,y) and R′(s,y), the source and receiver carrier wave fields C_{Sx}, C_{Sy}, C_{Sz}, C_{Rx}, C_{Ry}, and C_{Rz}, time shift axis parameters Δτ, τₘᵢₙ, and τₘₐₓ, the maximum allowable velocity error ε_{Vmax}, number of time shifts Nτ, average velocity V_{avg}, and frequency ω. At step 185, the method initializes the time-shift gather location index n to 0. At step 186, the method reads the current time-shift gather location (xₙ, yₙ). The user inputs a list of time-shift gather locations and shot image aperture dimensions at run-time. At step 182, the method initializes the time-shift index m to 0.

At step 531, the method computes the current time shift τ by the linear relation τ=m*Δτ+τₘᵢₙ where Δτ is either a constant value supplied by the user or a depth-variable function of depth z and average velocity V_{avg} at the (x,y) locations of the time-shift gathers. If the user chooses a depth-variable t, the user must also supply a maximum measurable RMS velocity error ε_{Vmax} as a fraction of RMS migration velocity, and the number of time shifts Nτ. The method substitutes ε_{Vmax} into the right side of equation (14) and replaces t with z/V_{avg} in equation (14). The method solves equation (14) for τ and defines this as τₘᵢₙ. The method then defines Δτ=2τₘᵢₙ/Nτ. At step 532, the method multiplies each element of the carrier wave fields by the corresponding element in the source wave field and by an exponential time shift and accumulates the result in arrays in the host(s) memory according to the following relationships:

W_{Sx}(n,m)+=C_{Sx}(xₙ,yₙ)S′(xₙ,yₙ)exp(2iωτ)

W_{Sy}(n,m)+=C_{Sy}(xₙ,yₙ)S′(xₙ,yₙ)exp(2iωτ)

W_{Sz}(n,m)+=C_{Sz}(xₙ,yₙ)S′(xₙ,yₙ)exp(2iωτ)

W_{Rx}(n,m)+=C_{Rx}(xₙ,yₙ)S′(xₙ,yₙ)exp(2iωτ)

W_{Ry}(n,m)+=C_{Ry}(xₙ,yₙ)S′(xₙ,yₙ)exp(2iωτ)

W_{Rz}(n,m)+=C_{Rz}(xₙ,yₙ)S′(xₙ,yₙ)exp(2iωτ)

The operator +=means add and assign the expression on the right of the equal sign to the expression on the left.

At step 534, the method computes wavefield correlations by multiplying each element of the source and the receiver wave fields with the complex conjugate of the source wave field, and then applies a time shift as follows and accumulates the result M_{S} and M_{R} in the host(s) memory as follows:

M_{S}(n,m)+=S′(xₙ,yₙ)S′(xₙ,yₙ)*exp(2iωτ)

M_{R}(n,m)+=S′(xₙ,yₙ)R′(xₙ,yₙ)*exp(2iωτ)

At step 536, the method accumulates the time-shifted image M_{R} into time-shift buffer Bₙ(z, τ):

Bₙ(z,τ)=M_{R}(n,m)

At step 538, the method accumulates the squared time-shifted image (right expression below) into the amplitude-squared time-shift buffer (left expression):

Dₙ(z,τ)+=[S′(xₙ,yₙ)R′(xₙ,yₙ)*exp(2iωτ)]²

At step 194, the method increments the time-shift index. If the method determines that the current time shift τ exceeds the maximum time-shift τₘₐₓ at step 196 the method continues to step 190. At step 190, the method increments the time-shift gather index. At step 192, if the method determines that the time-shift gather index exceeds the last time-shift gather index, the method proceeds to the method illustrated in FIG. 20. If not, the method proceeds to step 186 to compute the next time shift value.

FIG. 24 illustrates a method to compute propagation direction vectors for time-shift gathers. At step 540, the method inputs scaled and time shifted carrier signal wave fields for each time shift gather: W_{Sx}, W_{Sy}, W_{Sz}, W_{Rx}, W_{Ry}, W_{Rz} and source and receiver wave field correlations for each time shift gather: M_{S} and M_{R}, the maximum allowable velocity error ε_{Vmax}, number of time shifts Nτ, average velocity V_{avg}, and time shift axis parameters Δτ, τₘᵢₙ, and τₘₐₓ.

At step 185, the method initializes the time-shift gather location index n to 0. At step 186, the method reads the current time-shift gather location (xₙ, yₙ). The user inputs a list of time-shift gather locations and shot image aperture dimensions at run-time. At step 182, the method initializes the time-shift index m to 0. At step 531, the method computes the current time shift τ by the linear relation τ=m*Δτ+τₘᵢₙ as described by the method illustrated by FIG. 23.

At step 542, the method computes the absolute values of the eight fields (W_{Sx}, W_{Sy}, W_{Sz}, W_{Rx}, W_{Ry}, W_{Rz}, M_{S}, and M_{R}) and then applies a local spatial average operator L to each of the fields:

W′_{Sx}(n,m)=L(|W_{Sx}(n,m)|)

W′_{Sy}(n,m)=L(|W_{Sy}(n,m)|)

W′_{Sz}(n,m)=L(|W_{Sz}(n,m)|)

W′_{Rx}(n,m)=L(|W_{Rx}(n,m)|)

W_{Ry}(n,m)=L(|W_{Ry}(n,m)|)

W′_{Rz}(n,m)=L(|W_{Rz}(n,m)|)

M′_{S}(n,m)=L(|M_{S}(n,m)|)

M′_{R}(n,m)=L(|M_{R}(n,m)|)

At step 544, the method computes propagation direction vectors using the fields computed at step 542 as follows:

V_{Sx}(n,m)=W′_{Sx}(n,m)/M′_{S}(n,m)

V_{Sy}(n,m)=W′_{Sy}(n,m)/M′_{S}(n,m)

V_{Sz}(n,m)=W′_{Sz}(n,m)/M′_{S}(n,m)

V_{Rx}(n,m)=W′_{Rx}(n,m)/M′_{R}(n,m)

V_{Ry}(n,m)=W′_{Ry}(n,m)/M′_{R}(n,m)

V_{Rz}(n,m)=W′_{Rz}(n,m)/M′_{R}(n,m)

At step 546, the method resolves the sign of the direction vectors. This is necessary because direction information is lost in the absolute value computation at step 542. At step 194, the method increments time-shift index: m=m+1. At step 194, the method increments the time-shift index. If the method determines that the current time shift τ exceeds the maximum time-shift index τₘₐₓ at step 196 the method continues to step 190. At step 190, the method increments the time-shift gather index. At step 192, if the method determines that the time-shift gather index exceeds the last time-shift gather index, the method proceeds to the method illustrated in FIG. 20. If not, the method proceeds to step 186 to compute the next time shift value.

FIG. 25 illustrates a method to compute a collection of angle-dependent time-shift gathers. FIG. 25 is similar to FIG. 7, except incidence angle and dip angle information improves accuracy of the time-shift gather used to update the migration velocity. At step 550, the method inputs time-shift buffer Bₙ and the amplitude-squared time-shift buffer Dₙ obtained from the method of FIG. 24, the axis parameters τₘₐₓ, τₘᵢₙ, and Δτ defining the time shift axis from a user, the maximum allowable velocity error ε_{Vmax}, number of time shifts Nτ, and average velocity V_{avg}.

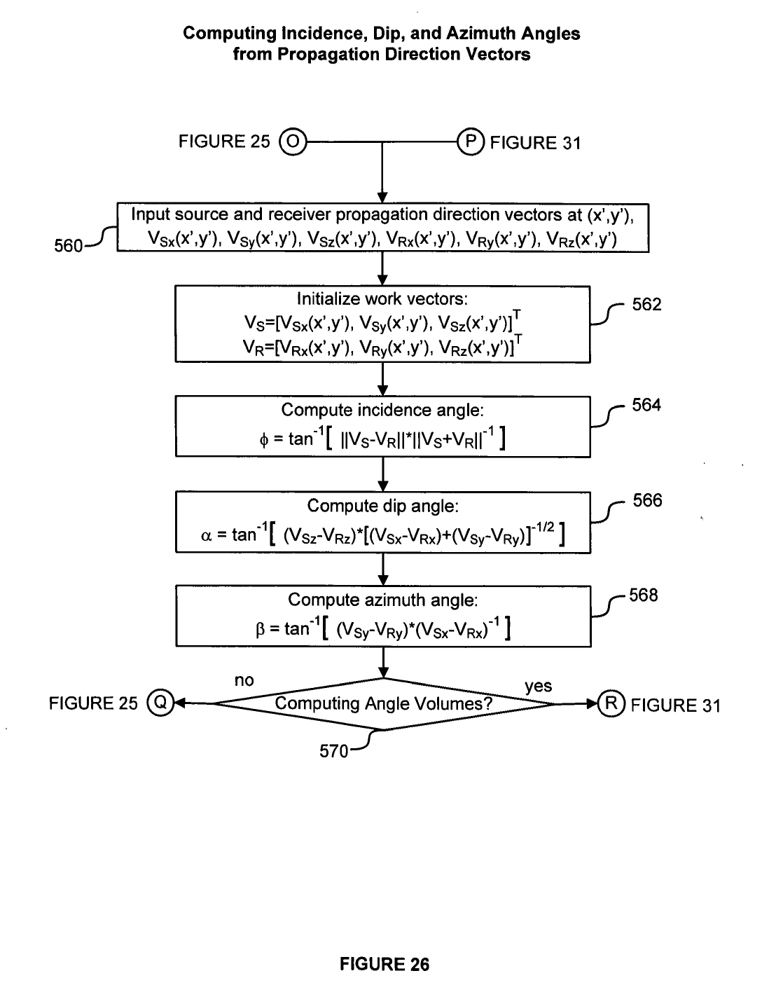

The method continues at step 182, previously described in connection with FIG. 7. The method then proceeds to step 531, previously described in connection with FIG. 23. The method continues at steps 185-186, previously described in connection with FIG. 7. At step 552, the method computes incidence angle φ and dip angle α according to the method illustrated in FIG. 26. At step 554, the method uses the incidence angle φ and dip angle α to compute an angle-dependent time shift variable τ′. The user chooses at step 554 whether to apply a dip angle and incidence angle correction (cos φ cos α) or a dip angle-only correction (cos α).

In an embodiment, the method defines an angle-dependent time shift, τ′=τ cos α. The method then replaces τ with τ′ in the left hand side of equations (14), (17), or (18). Furthermore, by using τ′, the method replaces travel time t with vertical travel time tᵥ in equations (14), (17), or (18), which is convenient for implementation.

In another embodiment, equations (14), (17), and (18) contain terms of the form τ/t, where τ is the time shift variable and t is the travel time from source to reflector to receiver. In the implementation of equations (14), (17), and (18), the travel time t is approximated with a vertical travel time tᵥ or the time obtained by performing a 1D depth-to-time conversion of a reflector. For implementation, vertical travel time tᵥ is more convenient to use than travel time t. The method uses the following equation to relate travel time t, normal incidence travel time t₀, and incidence angle φ:

$$cos ϕ = \frac{{t}_{0}}{t} . \qquad ( 21 )$$

The method uses trigonometric relations to relate normal incidence travel time t₀ to vertical travel time tᵥ, using the dip angle α:

$${t}_{0} = \frac{{t}_{v}}{cos α} . \qquad ( 22 )$$

The method combines equations (21) and (22) to relate travel time t to vertical travel time tᵥ:

$$t = \frac{{t}_{v}}{cos α cos φ} . \qquad ( 23 )$$

The method inserts equation (23) into equations (14), (17), and (18) to obtain improved equations relating time shift τ to velocity error Δv. The method generates a angle-dependent time shift, τ′, which is defined as:

τ=τ cos α cos φ. (24)

Therefore, by replacing τ with τ′ at step 554, the method handles dependence on dip angle and incidence angle without modifying the right hand side of equations (14), (17), or (18). Furthermore, by using τ′, the method defines equations (14), (17), or (18) in terms of vertical travel time tᵥ, which is convenient for implementation. The method rewrites equation (14):

$$\frac{{τ}^{′}}{{t}_{v}} = - 1 + \sqrt{1 + \frac{2 \frac{Δ v ( t )}{v ( t )} ( 1 - \frac{Δ v ( t )}{2 v ( t )} )}{{( 1 - \frac{Δ v ( t )}{v ( t )} )}^{2}}} , \qquad ( 25 )$$

rewrites equation (17):

$$\frac{{τ}^{′}}{{t}_{v}} = \frac{Δ v ( t )}{v ( t )} ( 1 + \frac{Δ v ( t )}{v ( t )} ) , \qquad ( 26 )$$

and rewrites equation (18):

$$\frac{Δ v ( t )}{v ( t )} \approx \frac{{τ}^{′}}{{t}_{v}} . \qquad ( 27 )$$

At step 556, the method adds the time-shift buffer Bₙ(z,τ) into the time-shift gather Tₙ(z,τ′). At step 558, the method adds the amplitude-squared time-shift buffer Dₙ(z,τ) into the amplitude-squared time-shift gather Qₙ(z,τ′). Steps 190, 192, 194, and 196 were previously described in FIG. 7. After step 196, the method returns to the method illustrated in FIG. 20.

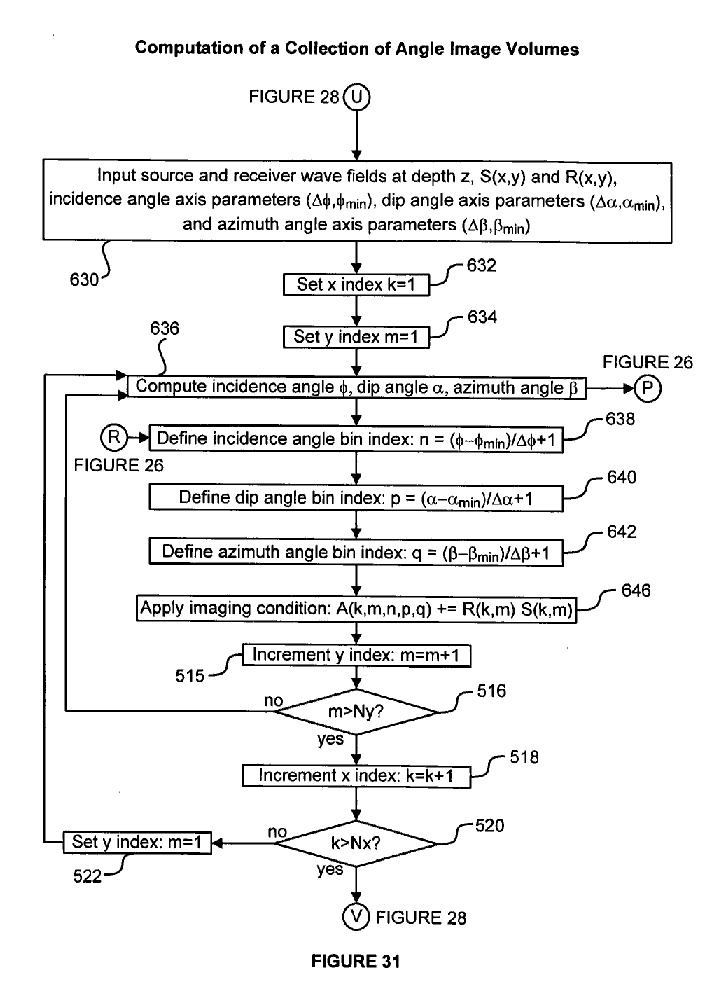

FIG. 26 illustrates a method to use propagation direction vectors to compute incidence angle, dip angle, and azimuth angle. The method starts from either the method of FIG. 25 or the method of FIG. 31. At step 560, the method inputs source and receiver propagation direction vectors at a given position (x′,y′): V_{Sx}(x′,y′), V_{Sy}(x′,y′), V_{Sz}(x′,y′), V_{Rx}(x′, y′), V_{Ry}(x′,y′), V_{Rz}(x′,y′).

At step 562, work vectors V_{S} and V_{R} are initialized:

v_{S}=[V_{Sx}(x′,y′),V_{Sy}(x′,y′),V_{Sz}(x′,y′)]^{T}

V_{R}=[V_{Rx}(x′,y′),V_{Ry}(x′,y′),V_{Rz}(x′,y′)]^{T}

At step 564, the work vectors V_{S} and V_{R} are used to compute the incidence angle φ according to the relation:

$$ϕ = {tan}^{- 1} [ \frac{‖ {V}_{S} - {V}_{R} ‖}{‖ {V}_{S} + {V}_{R} ‖} ] . \qquad ( 28 )$$

At step 566, the method uses individual components of the propagation direction vectors to compute the dip angle α according to the relation:

$$α = {tan}^{- 1} [ \frac{{V}_{Sz} - {V}_{Rz}}{\sqrt{{( {V}_{Sx} - {V}_{Rx} )}^{2} + {( {V}_{Sy} - {V}_{Ry} )}^{2}}} ] . \qquad ( 29 )$$

At step 568, the method uses individual components of the propagation direction vectors to compute the azimuth angle β according to the relation:

$$β = {tan}^{- 1} [ \frac{{V}_{Sy} - {V}_{Ry}}{( {V}_{Sx} - {V}_{Rx} )} ] . \qquad ( 30 )$$

At step 570, the method determines if it is computing angle volumes. If yes, the method proceeds to the method illustrated in FIG. 31. If not, the method proceeds to the method illustrated in FIG. 25.

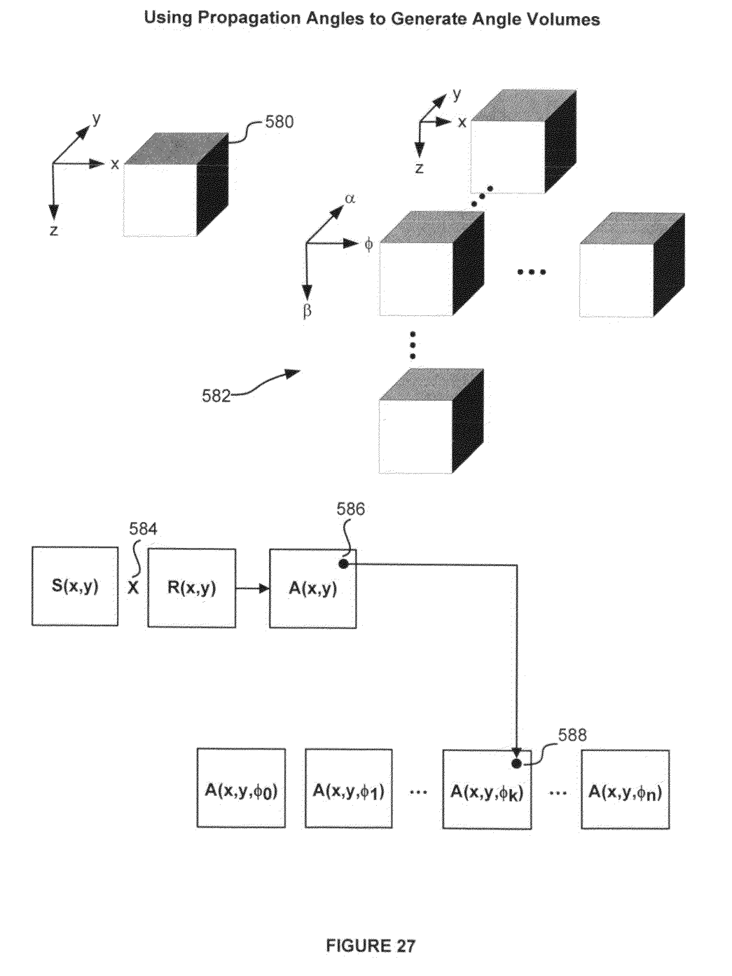

FIG. 27 illustrates using propagation angles to generate angle volumes. Three-dimensional image 580 is a function of (x,y,z). Each of the plurality of angle volumes 582 is also a function of (x,y,z). As shown, three propagation vectors (i.e., incidence angle φ, dip angle α, and azimuth angle β) result in three dimensions of angle volumes.

To compute a three-dimensional image as a function of the propagation angles we need to map points in an image volume into points in the angle volumes, which is described in detail in FIGS. 28-31.

FIG. 27 illustrates the mapping for the incidence angle φ only. A correlation imaging condition 584 is applied to an interpolated source wavefield S(x,y) and an interpolated receiver wavefield R(x,y). FIG. 31 illustrates how the condition is applied. This produces an image slice A(x,y).

The method defines a plurality of angle volume slices A(x,y,φₖ) where index k refers to an angle range defined by the user. For instance, k=0 could represent the angle range φ=0-10°. An incidence angle φ is computed at (x,y) point 586, and defines the index k of the corresponding angle volume. As shown, the method adds the image amplitude at point 586 in image slice A(x,y) to the point 588 of the plurality of angle volume slices A(x,y,φₖ).

FIG. 28 illustrates a method to compute angle volumes from downward continuation shot record migration. The method uses the angle information to generate fully-populated images decomposed by incidence angle, dip angle, and/or azimuth angle. At step 590, the method inputs the number of shots Nₛₕₒₜₛ, and axis parameters (grid spacing, minimum coordinate, maximum coordinate) for frequency (Δω, ωₘᵢₙ, ωₘₐₓ), depth (Δz, zₘᵢₙ, zₘₐₓ), incidence angle (Δφ, φₘᵢₙ, φₘₐₓ), dip angle (Δα, αₘᵢₙ, αₘₐₓ), and azimuth angle (Δβ, βₘᵢₙ, βₘₐₓ). For instance, if a user desires incidence angle volumes every 10 degrees from 0 to 60 degrees, Δφ would be set to 10, φₘᵢₙ to 0, and φₘₐₓ to 60, and the method outputs six angle volumes.

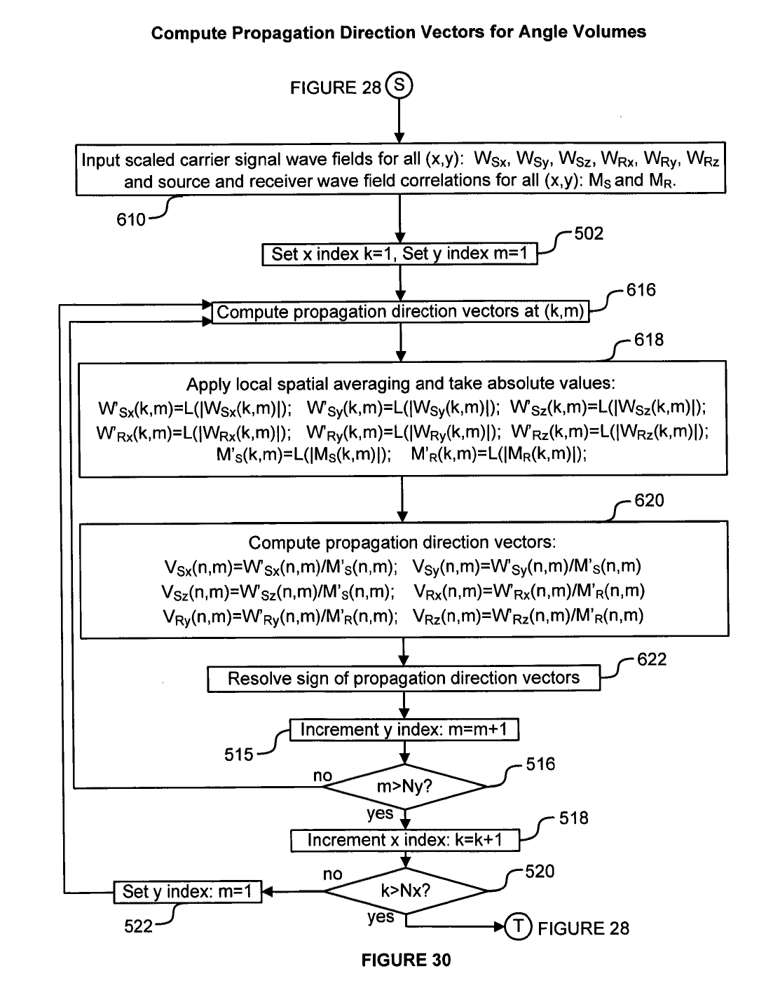

The method performs steps 140-158 and steps 166-176, previously illustrated by the method described in FIG. 20. At step 592, the method downward continues the source wave field S and receiver wave field R to depth z+Δz and accumulates propagation direction vector information as illustrated in FIG. 21. At step 461, the method computes propagation direction vectors as illustrated in FIG. 30. At step 462, the method computes angle volumes as illustrated in FIG. 31 using propagation direction vectors to compute incidence angle φ, dip angle α, and azimuth angle β at the reflector. At step 594, the method writes a file containing the angle volumes.

FIG. 29 illustrates the accumulation of angle of propagation information for angle volumes. At step 600, the method inputs an x index k, a y index m, source and receiver wave fields S′(x,y) and R′(s,y), and the source and receiver carrier wave fields C_{Sx}, C_{Sy}, C_{Sz}, C_{Rx}, C_{Ry}, and C_{Rzx}.

At step 602, the method multiplies each element of the carrier wave fields by the corresponding element in the source wave field and accumulates the result in arrays in the host(s) memory according to the following relationships:

W_{Sx}(k,m)+=C_{Sx}(k,m)S′(k,m)

W_{Sy}(k,m)+=C_{Sy}(k,m)S′(k,m)

W_{Sz}(k,m)+=C_{Sz}(k,m)S′(k,m)

W_{Rx}(k,m)+=C_{Rx}(k,m)S′(k,m)

W_{Ry}(k,m)+=C_{Ry}(k,m)S′(k,m)

W_{Rz}(k,m)+=C_{Rz}(k,m)S′(k,m)

At step 604, the method computes wavefield correlations by multiplying each element of the source wave field S′(k,m) and the receiver wave field R′(k,m) with the complex conjugate of the source wave field S′(k,m)* and accumulates the result M_{S} and M_{R} in the host(s) memory as follows:

M_{S}(k,m)+=S′(k,m)*S′(k,m)

M_{R}(k,m)+=S′(k,m)*R′(k,m)

Finally, after step 604, the method proceeds to the method illustrated by FIG. 22.

FIG. 30 illustrates the computation of propagation direction vectors for angle volumes. At step 610, the method inputs scaled carrier signal wave fields for all (x,y): W_{Sx}, W_{Sy}, W_{Sz}, W_{Rx}, W_{Ry}, W_{Rz}, and source and receiver wave field correlations for all (x,y): M_{S} and M_{R}.

At step 502, the method initializes the x index k=1 and the y index m=1. At step 616, the method computes propagation direction vectors at indices (k,m). At step 618, the method computes the absolute values of the eight fields (W_{Sx}, W_{Sy}, W_{Sz}, W_{Rx}, W_{Ry}, W_{Rz}, M_{S}, and M_{R}). In an embodiment that stabilizes the result, the method can smooth the eight fields by applying a local spatial average operator L such as a known Gaussian spatial averaging filter to each of the fields:

W′_{Sx}(n,m)=L(|W_{Sx}(n,m)|)

W′_{Sy}(n,m)=L(|W_{Sy}(n,m)|)

W′_{Sz}(n,m)=L(|W_{Sz}(n,m)|)

W′_{Rx}(n,m)=L(|W_{Rx}(n,m)|)

W′_{Ry}(n,m)=L(|W_{Ry}(n,m)|)

W′_{Rz}(n,m)=L(|W_{Rz}(n,m)|)

M′_{S}(n,m)=L(|M_{S}(n,m)|)

M′_{R}(n,m)=L(|M_{R}(n,m)|)

At step 620, the method computes propagation direction vectors using the fields computed at step 618 as follows:

V_{Sx}(n,m)=W′_{Sx}(n,m)/M′_{S}(n,m)

V_{Sy}(n,m)=W′_{Sy}(n,m)/M′_{S}(n,m)

V_{Sz}(n,m)=W′_{Sz}(n,m)/M′_{S}(n,m)

V_{Rx}(n,m)=W′_{Rx}(n,m)/M′_{R}(n,m)

V_{Ry}(n,m)=W′_{Ry}(n,m)/M′_{R}(n,m)

V_{Rz}(n,m)=W′_{Rz}(n,m)/M′_{R}(n,m)

At step 622, the method resolves the sign of the propagation direction vectors. This is necessary, because direction information is lost in the absolute value computation at step 542. The method assumes that the sign of V_{Rz} and V_{Sz} are positive, and computes the signs of V_{Rz}, V_{Ry}, V_{Sx}, and V_{Sy} by using the relative phase of the x and y components with respect to the z component. In an embodiment that stabilizes the result, the method can smooth the computed phases by applying a local spatial average operator L such as a known Gaussian spatial averaging filter to each of the fields:

P_{Sx}(n,m)=L(phase(V_{Sx}(n,m)/V_{Sz}(n,m)))

P_{Sy}(n,m)=L(phase(V_{Sy}(n,m)/V_{Sz}(n,m)))

P_{Rx}(n,m)=L(phase(V_{Rx}(n,m)/V_{Rz}(n,m)))

P_{Ry}(n,m)=L(phase(V_{Ry}(n,m)/V_{Rz}(n,m)))

If the phases P_{Sx}(n,m), P_{Sy}(n,m), P_{Rx}(n,m), P_{Ry}(n,m) are greater than π/2, the sign is assumed to be positive. Otherwise, the sign is assumed to be negative. The method then performs steps 515, 516, 518, 520, and 522 as illustrated in FIG. 22.

FIG. 31 illustrates a method to apply an angle-dependent imaging condition to generate angle volumes as illustrated in FIG. 27.

At step 630, the method inputs source and receiver wave fields at depth z, S(x,y) and R(x,y), the incidence angle axis parameters (Δφ,φₘᵢₙ), the dip angle axis parameters (Δα,αₘᵢₙ), and the azimuth angle axis parameters (Δβ,βₘᵢₙ).

At step 632, the method sets the x index k=1. At step 634, the method sets the y index m=1. At step 636, the method computes the incidence angle φ, dip angle α, and azimuth angle β at (x,y) as illustrated in FIG. 26. At step 638, the method defines an index n corresponding to the incidence angle φ computed at step 636. At step 640, the method defines an index p corresponding to the dip angle α computed at step 636. At step 642, the method defines an index q corresponding to the azimuth angle β computed at step 636. At step 646, the method applies the shot record migration imaging condition previously illustrated in FIG. 27, and adds R(k,m) S(k,m) into a five-dimensional image volume A(k,m,n,p,q). In an embodiment, only one type of angle decomposition is done. For instance, if only incidence angle decomposition is being done, then p and q will always be 1, and the image volume will be three-dimensional. In an alternative embodiment, the angle decomposition is done on a plurality of propagation angles (e.g., incidence angle and azimuth angle). The method then performs steps 515, 516, 518, 520, and 522 as illustrated in FIG. 22, before returning to the shot record migration method illustrated in FIG. 28.

Oil and gas prospectors desire to drill a minimum number of wells to extract a maximum amount of oil and gas. Seismic imaging techniques reduce drilling risk by revealing the geometry of geologic structures, so that prospectors can find “traps.” The invention seeks to further reduce risk, by indicating which traps are likely to hold oil and gas and which traps are not. Reflectivity attributes indicate changes in rock properties across a geologic structure boundary. Areas where the reflectivity attributes are “anomalous” may indicate traps holding oil and gas.

It is known that changing the fluid or gas which saturates a porous rock, for instance from water to natural gas, will cause the reflected seismic signature to change. Often the changes are most apparent when the reflected seismic signature from a geologic boundary is viewed as a function of incidence angle as shown in FIG. 19.

U.S. application Ser. No. 12/587,607, Estimation of Propagation Angles of Seismic Waves in Geology with Application to Determination of Propagation Velocity and Angle-Domain Imaging, filed on Oct. 9, 2009 relates to a more accurate method of organizing seismic data with incidence angle and a more accurate method of determining seismic velocity.

In an embodiment, the invention inverts the amplitude of the seismic image as a function of incidence angle for unknown rock properties. In the embodiment, the invention also uses a measured seismic velocity volume to compute reflectivity attributes representing the rock properties. If the measured seismic velocity volume is accurate, and the amplitudes and measured incidence angle on the seismic image is also accurate, then the computed rock properties will be more accurate, and the risk of drilling an unsuccessful oil or gas well reduced.

The Zoeppritz equations relate rock properties in the earth to the amplitude of reflected seismic waves. The details are provided in Zoeppritz, Erdbebenwellen VIII B, On the reflection and penetration of seismic waves through unstable layers: Goettinger Nachr., pp. 66-84 (1919), which is incorporated by reference.

In an embodiment, the invention modifies the Zoeppritz equations to enable the inversion of reflected seismic wave amplitudes on angle gathers for reflectivity attributes which indicate changes in rock properties across geologic boundaries. Wang, Approximations to the Zoeppritz equations and their use in AVO analysis, Geophysics, v 64, p. 1920 (1999), which is incorporated by reference herein, provides an overview of many common approximations to the Zoeppritz equations.

An approximation of the Zoeppritz equations is found in Aki and Richards, Quantitative Seismology (1979), which is incorporated by reference herein. Aki and Richards express the amplitude of a compressional wave or P-wave reflection as a function of incidence angle φ. The expression is written in terms of linear perturbations in P-wave velocity V_{P}, shear wave or S-wave velocity V_{S}, and bulk density ρ across the boundary. The method rearranges the Aki and Richards' expression to obtain:

$$R ( ϕ ) = A ( 1 + \frac{{sin}^{2} ϕ {tan}^{2} ϕ}{1 + γ} ) + B {sin}^{2} ϕ \qquad ( 31 )$$

R(φ) is the reflection strength as a function of incidence angle, assuming that velocity is isotropic, i.e., that V_{P} and V_{S} do not vary as a function of incidence angle.

Equation (31) is a linear function of the parameters A and B, which are defined below in equation (33).

The quantity γ in equation (31) depends on P-wave velocity V_{P} and bulk density ρ, as follows:

$$\begin{matrix}γ = ( \frac{{V}_{P , 1} + {V}_{P , 0}}{{V}_{P , 1} - {V}_{P , 0}} ) ( \frac{{ρ}_{1} - {ρ}_{0}}{{ρ}_{1} + {ρ}_{0}} ) \\ = \frac{{\overline{V}}_{P}}{Δ {V}_{P}} \frac{Δ ρ}{\overline{ρ}}\end{matrix} \qquad ( 32 )$$

The form of γ shown in equation (32) is equivalent to equation (5) in Castagna et al., Framework for AVO gradient and intercept interpretation, Geophysics, v. 63, p. 948 (1998), which is incorporated by reference herein.

Equation (32) uses the subscript “0” and “1” in equation (32) refer to P-wave velocity V_{P} and bulk density ρ above and below the geologic boundary, respectively.

The A and B parameters in equation (31) are functions of V_{P}, V_{S}, and γ as follows:

$$A = \frac{Δ {V}_{P}}{{\overline{V}}_{P}} ( \frac{1 + γ}{2} ) \\ B = \frac{1}{2} \frac{Δ {V}_{P}}{{\overline{V}}_{P}} ( 1 - 4 γ \frac{{V}_{S}^{2}}{{V}_{P}^{2}} ) - 4 \frac{{V}_{S}^{2}}{{V}_{P}^{2}} \frac{Δ {V}_{S}}{{\overline{V}}_{S}} \qquad ( 33 )$$

Some other approximations to the Zoeppritz equations assume that the function multiplied by A is a constant and utilize a third linear parameter, C, which describes R(φ) at large incidence angles. The method uses γ to remove the dependence on C by setting C=A/(1+γ) and incorporating the angle dependence of this third term in the function that A multiplies. Thus equation (31) is accurate for high angles of incidence when an approximate γ is known, yet A and B still correspond to the usual quantities called intercept and gradient (slope).

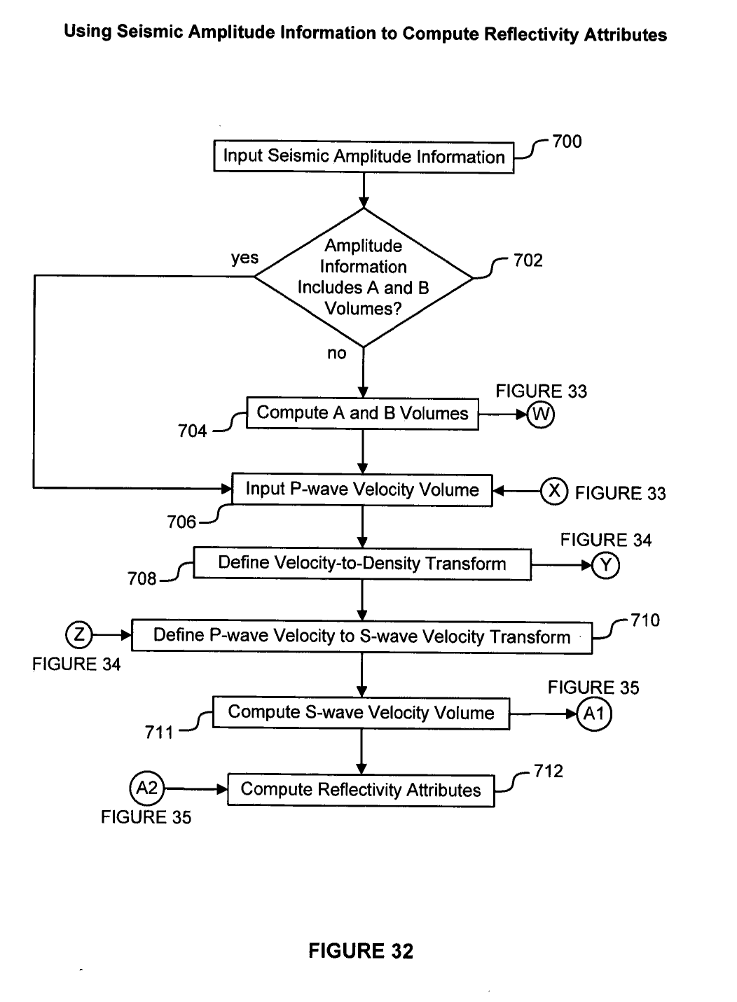

FIG. 32 illustrates a method for using seismic amplitude information to determine reflectivity attributes.

At step 700, the method inputs seismic amplitude information (e.g., reflection seismic data as described in our background). If, at step 702, the seismic amplitude information includes volumes of A and B parameters, then the method proceeds to step 706. Otherwise, the method assumes that the seismic amplitude information includes a set of incidence angle gathers and proceeds to step 704.

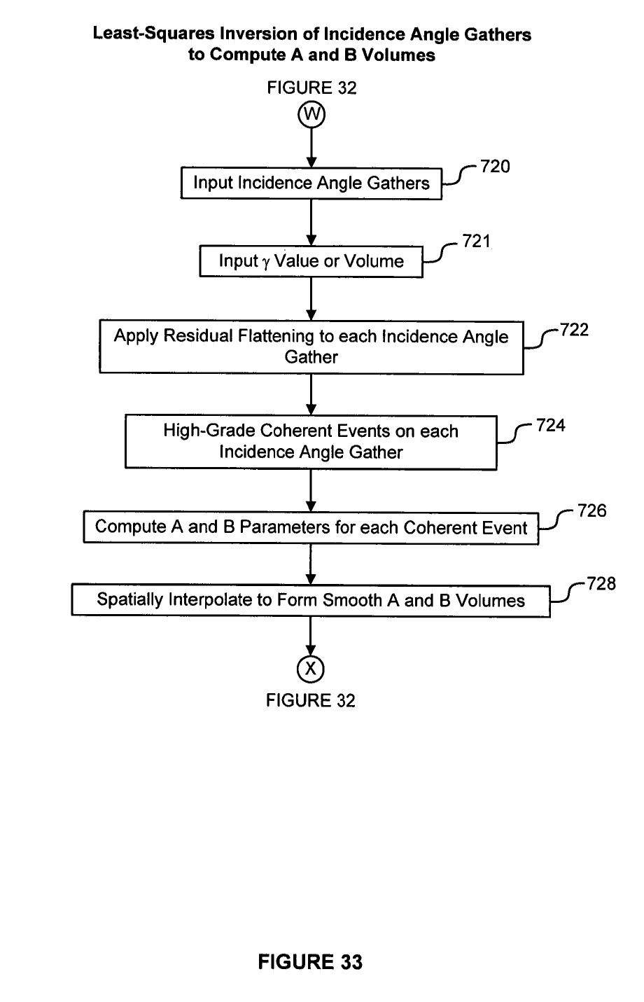

At step 704, the method uses the set of incidence angle gathers to compute volumes of A and B parameters defined in equation (33). A three-dimensional volume with x, y, and z locations is abbreviated volume (e.g., A and B volumes). In an embodiment, the method proceeds to the method illustrated in FIG. 33 to compute A and B volumes using a least-squares inversion. In another embodiment, the method computes approximate A and B volumes by using a near-angle “common-angle volume” for A, and a far-angle common-angle volume for (A+B)/2. The method then solves for B, assuming A is known. FIG. 27 illustrates a common-angle volume.

At step 706, the method inputs a volume of P-wave velocity V_{P}. The V_{P} volume could be obtained by interpolating sonic logs, from checkshot or VSP data, from stacking velocities, time migration velocities, or a depth migration interval velocity volume. The more accurate the V_{P} volume, the more accurate the computed reflectivity attributes will be.

At step 708, the method defines a relationship to transform P-wave velocity V_{P} to an approximate bulk density ρ. Often, a volume of ρ is not available, except possibly at sparse well locations (e.g., locations miles apart), whereas a volume of P-wave velocity V_{P} is usually available from seismic velocity analysis. The method utilizes the relationship at step 712 to compute reflectivity attributes.

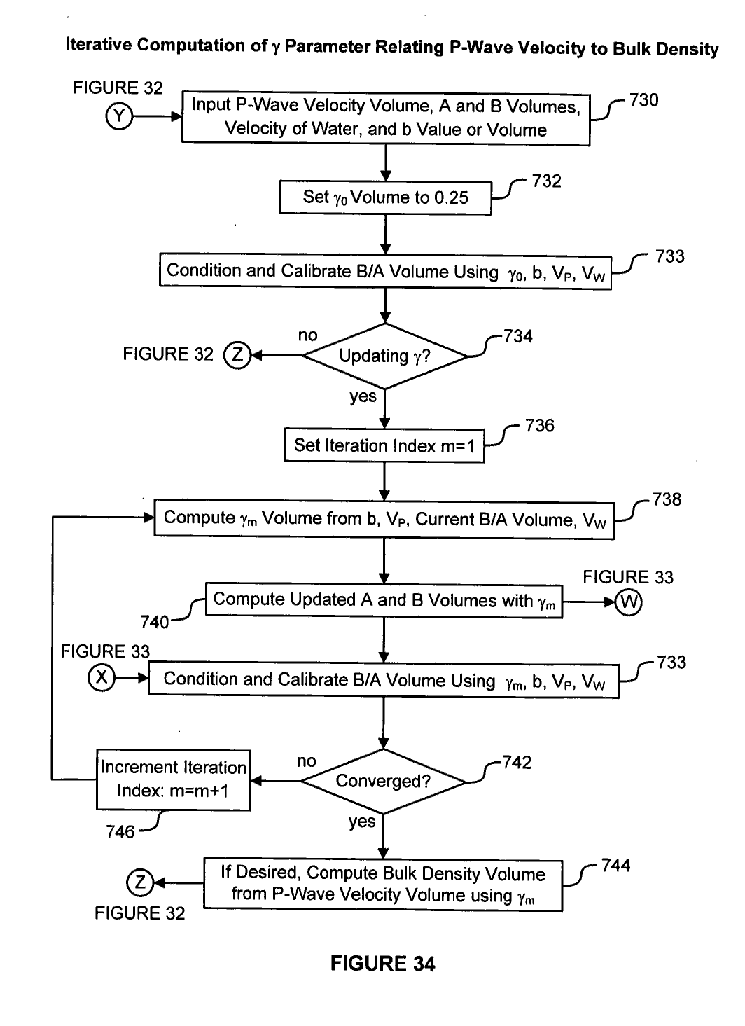

In an embodiment, the present invention uses γ=0.25 in equation (32) and thus defines a simple transformation connecting ΔV_{P}/V_{P} to Δρ/ρ. Gardner et al., Formation velocity and density—the diagnostic basics for stratigraphic traps, Geophysics, v. 39, p. 1784 (1974), which is incorporated by reference herein, describes the details. In another embodiment, the method proceeds to the method illustrated by FIG. 34 to compute a spatially varying y volume.

A theoretical justification for the method's use of γ is found in Bortfeld, Reflection and transmission coefficients of plane waves, Geophysical Prospecting, v. IX, p. 493 (1961), which is incorporated by reference herein. Bortfeld derived a nonlinear formula for R(φ) using an expression for γ (Bortfeld's equation (17)), which reduces to the expression for γ in equation (32) in the limit of small changes (e.g., less than 20%) in the physical parameters across the geologic boundary.

If a volume of S-wave velocity V_{S} is not readily available, at step 710, the present invention defines a relationship to transform the volume of P-wave velocity V_{P} obtained from seismic velocity analysis to an approximate V. The method utilizes the relationship at step 712 to compute reflectivity attributes.

In an embodiment, the invention uses the relationships described in Castagna et al., Relationships between compressional-wave and shear-wave velocities in clastic silicate rocks, Geophysics, v. 50, p. 571 (1985), which is incorporated by reference herein. Castagna et al. define a “mudrock line” which is a linear relationship between P-wave velocity V_{P} and S-wave velocity V_{S}. We recognize, however, that the linear mudrock line is typically computed using well data and may not be accurate between well locations. The linear mudrock line may not enforce the constraint that the computed V_{S} should equal zero when V_{P} equals the P-wave velocity in water. Also, the linear mudrock line requires two parameters (i.e., a slope and an intercept).

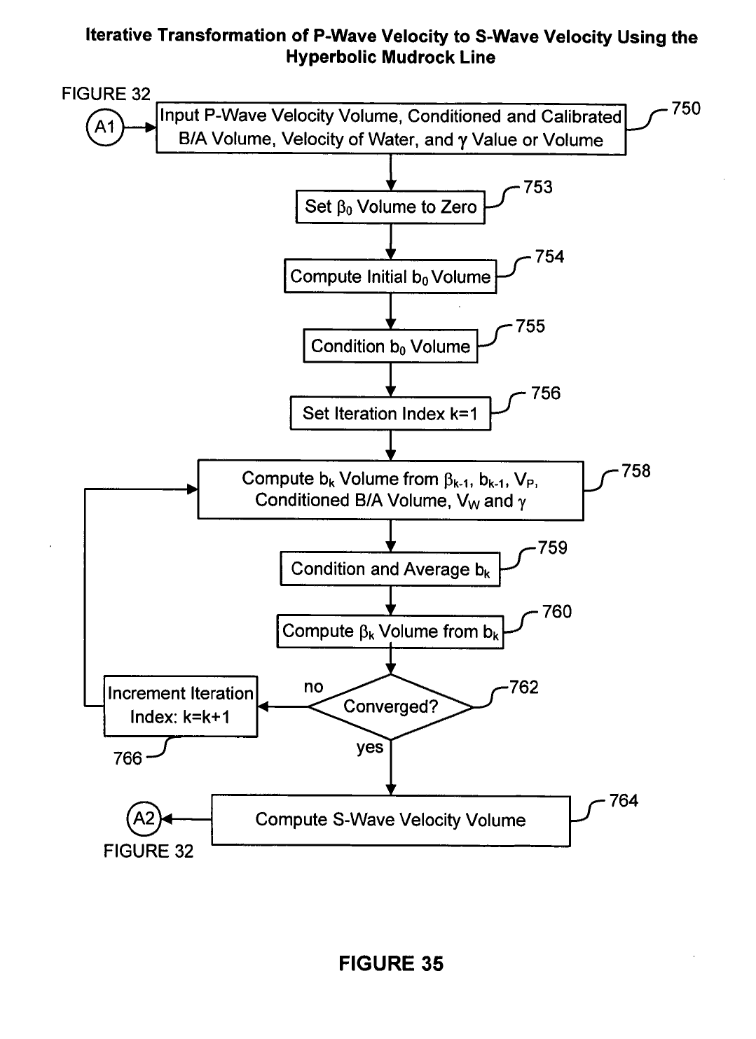

In an embodiment shown in FIG. 35, the method defines a “single-parameter mudrock line” that relates S-wave velocity V_{S} to P-wave velocity V_{P}, which is constrained to have the computed V_{S} equal zero when V_{P} equals water velocity. Thus, the single-parameter mudrock line needs only one parameter to relate V_{S} to V_{P}.

It is desirable to use seismic amplitude information to compute mudrock line parameters, rather than well data, because a seismic survey may cover an area of interest in many locations, i.e., densely. By contrast, there may only be a few wells over the same area of interest. By estimating mudrock line parameters at many locations, rather than just a few well locations, the mudrock relationship will be more accurate. However, it may not be feasible to use seismic amplitude information to compute two mudrock parameters. An embodiment, described in FIG. 35, uses a hyperbolic form (see e.g., equation (38)) for the single-parameter mudrock line, and also uses seismic amplitude information to compute the mudrock parameter.

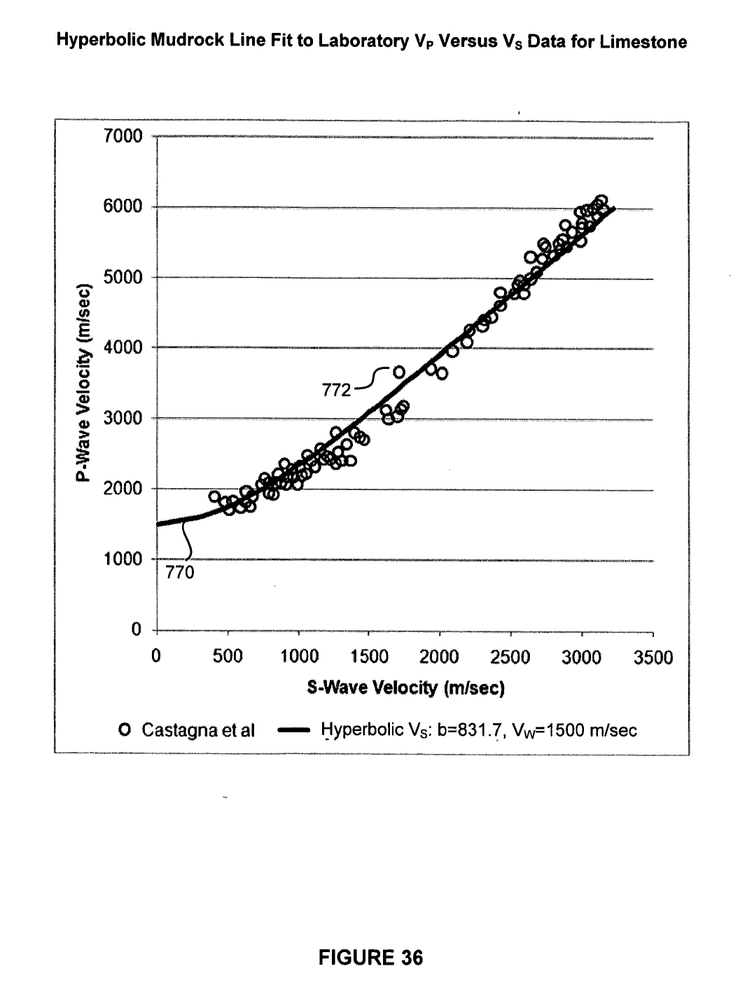

Castagna et al. named the relationship between S-wave velocity V_{S} and P-wave velocity V_{P} a mudrock line because data from wells that penetrated sand and shale layers (i.e., mudrock) were used to develop the relationship. The hyperbolic mudrock line fits limestone as shown in FIG. 36 and dolomite, but the linear mudrock line may fit sand and shale layers better. In FIG. 35, a method to estimate a spatially varying hyperbolic mudrock line parameter volume is described. By allowing slow variations of the hyperbolic mudrock line parameter, the hyperbolic mudrock line will provide an accurate fit for many rock types.

At step 711, the method uses the relationship between S-wave velocity and P-wave velocity to compute a volume of S-wave velocity V_{S}. In an embodiment, the method proceeds to the method illustrated in FIG. 35, which uses the A and B volumes which were either input at step 700 or computed at step 704, in order to compute V_{S} using the hyperbolic mudrock line.

At step 712, the method computes reflectivity attributes from the seismic amplitude information. A reflectivity attribute could be computed for many earth properties such as bulk density ρ, P-wave velocity V_{P}, S-wave velocity V_{S}, bulk modulus K, shear modulus μ, and so on. Earth properties may exhibit anomalous behavior when a rock is saturated with hydrocarbons. When natural gas replaces water or oil in a porous rock, the bulk modulus can drop significantly (e.g., 25%). The magnitude of the bulk modulus reflectivity is relatively high when the rock above or below an interface is saturated with natural gas compared to when the rock is saturated with oil or water.

For a given earth property, call it X, the reflectivity attribute is defined as follows:

$$\frac{Δ X}{\overline{X}} \qquad ( 34 )$$

The reflectivity attribute measures the difference of the earth property above and below a reflecting interface. The difference is normalized by the average of the earth property above and below the interface. This average is also called the background. Often, the quantities used in reflectivity attribute calculation, such as a P-wave velocity volume for seismic migration, are spatially smooth. Because the volumes are spatially smooth they are suitable for use as background fields, and the overbar notation will not be shown in the equations below.

An earth property that can be expressed as a function of P-wave velocity V_{P}, S-wave velocity V_{S}, and bulk density ρ can be transformed into a reflectivity attribute. For example, the invention can compute the reflectivity attribute for shear modulus μ, as described below.

In an embodiment, the Δ operator defined in equation (32) is assumed to be a total derivative. The total derivative is first applied to the relation for shear modulus μ, and then normalized by the background value of μ to obtain an expression for the shear modulus reflectivity attribute Δμ/μ:

$$μ = ρ {V}_{S}^{2} \\ \begin{matrix}Δ μ = Δ ρ \frac{\partial ( ρ {V}_{S}^{2} )}{\partial ρ} + Δ {V}_{S} \frac{\partial ( ρ {V}_{S}^{2} )}{{V}_{S}} \\ = Δ ρ {V}_{S}^{2} + 2 Δ {V}_{S} ρ {V}_{S}\end{matrix} \\ \frac{Δ μ}{μ} = \frac{Δ ρ}{ρ} + 2 \frac{Δ {V}_{S}}{{V}_{S}} \qquad ( 35 )$$

The method computes the shear modulus reflectivity attribute Δμ/μ expressed in equation (35) in terms of known inputs as follows. The method first solves equation (33) to compute the P-wave velocity reflectivity attribute ΔV_{P}/V_{P} by dividing each element of the A parameter volume by 0.5*(1+γ). A constant value is used for γ if a volume of γ values is not available. The method expresses Δμ/μ in terms of a bulk density reflectivity attribute Δρ/ρ and an S-wave velocity reflectivity attribute ΔV_{S}/V_{S}. The method computes Δρ/ρ from ΔV_{P}/V_{P} using equation (32). The method then computes ΔV_{S}/V_{S} from ΔV_{P}/V_{P} in three steps. First, the method performs amplitude inversion of the incidence angle gathers at step 704 to derive the A and B volumes. Second, the method uses seismic amplitude information, specifically the A and B volumes, to define a V_{P}-to-V_{S} transformation which computes a background S-wave velocity V_{S} at step 710. Third, the method solves the expression defining the B parameter in equation (33) for ΔV_{S}/V_{S}.

FIG. 33 illustrates a method of least-squares inversion to determine volumes of A and B parameters. At step 720, the method inputs a set of incidence angle gathers. An incidence angle gather is a two-dimensional array of seismic data. One dimension of the incidence angle gather is either recording time or recording time converted to depth. The second dimension is incidence angle. The entire seismic data set consists of one or more incidence angle gathers, where each incidence angle gather corresponds to a particular x, y location on earth's surface. The incidence angle gathers could be obtained by a variety of well known techniques. For example, they could be obtained by converting common midpoint (CMP) gathers from source-receiver offset to incidence angle after normal moveout correction via Levin's equation (3), by converting time migrated or depth migrated offset gathers converted to incidence angle, or by using depth migrated angle gathers from an angle-domain Kirchhoff migration. In an embodiment, the angle gathers could also be obtained by inputting depth migrated incidence angle gathers from a shot record wave equation prestack depth migration with reflection angle decomposition.

At step 721, the method inputs either a constant-valued γ or a spatially varying γ volume. The relations for A and B parameters defined in equation (33) depend on γ. Therefore, the choice of γ affects the inversion of angle gathers for A and B. FIG. 34 illustrates an iterative method to compute a spatially varying γ. After each iteration, the new value of γ is input to the least-squares inversion for A and B shown in FIG. 33.

At step 722, if the angle gathers are insufficiently flat with respect to incidence angle, the method may apply a residual flattening algorithm to align the seismic events on each incidence angle gather with respect to incidence angle. A residual flattening algorithm may be implemented by a conventional cross-correlation, parabolic radon transform, or other technique. The method may mute the incidence angle gathers or may apply a stretch compensation to mitigate any effects from far-angle stretch.

At step 724, the method high-grades and conditions events on each incidence angle gather to ensure that the A and B inversion is only performed on reliable seismic events. An embodiment of the high-grading and conditioning process is as follows:
1. Produce a “stacked trace” by averaging each angle gather over some range of incidence angles to form a single trace. The user specifies the width of the averaging window (usually over half or more of the incidence angles in a gather). Seismic reflections may undergo a phase shift with angle. The window is chosen to avoid averaging through this phase shift.
2. For each sample of the stacked trace, extract a tapered window (vector) of samples in depth centered on the sample. The square root of the dot product of the vector with itself defines a quality measure, Q. Divide each sample of the vector by Q to create a normalized stack vector.
3. For each incidence angle trace, form a similar vector around the sample being analyzed but do not normalize—call this the angle trace vector. Take the dot product of the normalized stack vector with each corresponding angle trace vector in the incidence angle gather. The output value is treated as the reflection strength R(φ) at a given incidence angle φ for that particular depth sample and used as the input for the A and B inversion at step 726.

At step 726, the method computes A and B parameters for each event on each incidence angle gather in the data set. As described above, an incidence angle gather is a two-dimensional object. The number of samples in the angle direction is N. For instance, an incidence angle gather might contain N=16, representing incidence angles from 0 to 45 degrees, sampled at 3 degrees. The user defines a quality threshold Qₘᵢₙ. The method ignores events on angle gathers for which the quality measure Q, defined in step 724, is lower than Qₘᵢₙ. The number of accepted data samples M is less than or equal to N. For a given event on a given incidence angle gather, let R(φᵢ) be the reflection strength of the event at the i^{th} angle, after the conditioning process at step 724.

Equation (31) relates R(φᵢ) linearly to the A and B parameters at the location of the event. The method expresses the relationship between each of the R(φᵢ) and the A and B parameters in matrix form:

$$d = [ \begin{matrix}R ( {ϕ}_{0} ) \\ ⋮ \\ R ( {ϕ}_{M} )\end{matrix} ] = [ \begin{matrix}1 + \frac{{sin}^{2} {ϕ}_{0} {tan}^{2} {ϕ}_{0}}{1 + γ} & {sin}^{2} {ϕ}_{0} \\ ⋮ & ⋮ \\ 1 + \frac{{sin}^{2} {ϕ}_{M} {tan}^{2} {ϕ}_{M}}{1 + γ} & {sin}^{2} {ϕ}_{M}\end{matrix} ] [ \begin{matrix}A \\ B\end{matrix} ] = LM \qquad ( 36 )$$

If M is greater than 2, then the least-squares estimation for A and B in equation (36) is over-determined, and the vector m of A and B that solves equation (36) in a least-squares sense is as follows:

m=(L^{T}L)⁻¹L^{T}d (37)

The method then solves the 2-by-2 matrix inverse and matrix multiplications required of equation (37). The method determines the sign of A and B parameters with respect to the sign of the windowed stacked trace by multiplying the computed A and B parameters by the corresponding element of the windowed stacked trace.

At step 728, the method forms volumes of A and B parameters by solving equation (37) for each of the x, y, z locations which had an accepted seismic event, and applying a spatial interpolation. Such an interpolation might be accomplished by inverse distance weighted smoothing, linear interpolation, higher order interpolation, or spline fitting. In an embodiment, the method uses over-determined local polynomial interpolation in x and y, with the order of the polynomials supplied by the user. The method then returns to the reflectivity attribute computation method of FIG. 32.

FIG. 34 illustrates using seismic amplitude information, contained in the A and B parameters, to iteratively compute a γ volume relating P-wave velocity V_{P} to bulk density ρ. γ is defined in equation (32). Using a spatially varying γ to compute reflectivity attributes may improve the accuracy of the attributes compared to attributes computed with a constant-valued γ. This in turn may better indicate the presence or lack of hydrocarbons in the subsurface.

At step 730, the method inputs a P-wave velocity volume V_{P}, volumes of A and B parameters, a single value for the velocity of water, V_{W}, and either a single value or volume of b parameters for the hyperbolic mudrock line relating V_{P} to S-wave velocity V_{S}. The hyperbolic mudrock line is written as follows:

$${V}_{S}^{2} = {b}^{2} ( \frac{{V}_{P}^{2}}{{V}_{W}^{2}} - 1 ) \qquad ( 38 )$$

The hyperbolic mudrock line is described in detail below.

The process to estimate the spatially varying γ volume is iterative. In an embodiment, the method sets the γ volume for the first iteration, γ₀, to a constant value of 0.25 at step 732.

The method uses the ratio B/A to update γ. At step 734, the method conditions and calibrates the B/A volume, because it may contain noise and other biases. The conditioning process includes:
1. Setting the B/A volume to zero when B/A>1/(1+γ₀) to avoid implying that V_{S}<0.
2. Performing a modified median filter operation on the B/A volume. In an embodiment, the user defines a window that includes samples around a median sample and the method fits the retained samples with a quadratic function which is evaluated at the output depth.

If the method is computing A and B for a particular depth sample, say 5000 feet, for a particular angle gather, then suppose the depth sample interval is 25 feet and the wavelet is roughly 200 feet wide. A user can choose a window length of 9 samples of 25 feet each so that the window spans the wavelet. Now the method windows the stacked trace around the sample at 5000 feet. This is an averaged stacked trace, i.e., the stacked trace divided by the number of non-zero contributing samples at every depth sample. Referring to windowing, the method collects the four samples above and another four samples below and the central sample for 9 points in the vector after setting the window taper length to zero. The method takes the dot product of this vector with itself, takes the square root to find Q, and normalizes this vector by dividing by Q. Call this vector V₀. Now define <Vᵢ, Vⱼ> as the dot product of Vᵢ with Vⱼ. The method has <V₀, V₀>=1.0 because of the normalization. Returning to the angle gather, the method windows each trace of the angle gather similarly to generate a vector for each angle trace but doesn't normalize these because that would destroy their variation with angle. These vectors are numbered: V₁, V₂, V₃, . . . V₁₅ if there are, for example, 15 traces spaced 3 degrees apart. Now the method generates 15 numbers by computing <V₀, Vᵢ> for i=1 to 15. The method “projects” out of each of these vectors that part that looks like V₀. The amount that looks like V₀ is the number obtained. So now the 15 numbers correspond to the amount of each angle trace that looks like their normalized average. Thus, the method eliminates anything orthogonal to the stack vector V₀ which is hopefully noise and gets the “amplitude” of the part that looks like the stack vector V₀. The method uses these 15 numbers to estimate A and B to within a sign. The method multiplies the A and B values by the magnitude and sign of the central element of V₀. The result is the output A and B values.

The method does this for every depth sample to build the A and B volumes. The method combines the A and B volumes according to the reflection coefficient formula and the angles represented by the original angle traces (15 in the example) to reproduce a version of the averaged stack trace consistent with A and B. The method computes the difference between the original stacked averaged trace and this constructed averaged stack trace and outputs the difference as a quality check.

The modified median filter may operate as follows. The method has a trace of B/A values. Again for a given depth, say 5000 feet, the method chooses a window about this depth, say 1000 feet corresponding to 41 samples. The method collects these 41 samples with sample 21 being at depth 5000 feet. The method sorts these values. If the method were doing a standard median filter it would go the 21^{st} sample after the sort and output that at depth 5000 feet. Instead, the method can do a quadratic fit to the 13 central samples (approximately the central third). After the sort the method goes to the central element and collects that sample and the six samples larger than it and smaller than it after the sort. The method also has kept track of the sorting order so the method can get the depth values, Zᵢ, associated with each of these samples for i=−6 to +6 about the median at i=0, So the method has the information it needs to do a quadratic fit to these thirteen samples as a function of depth. The method does this and evaluates it at the 5000 feet depth and this is the value that it outputs for B/A at the depth of 5000 feet. FIG. 35 illustrates how the method estimates a slowly varying quantity b for the hyperbolic mudrock line using B/A. But B and A are associated with rapidly varying physical quantities. These quantities may get quite large and quite small due to this rapid variation. The sorting sends the larger values to one end of the vector and the small values to the other end of the vector. The method assumes the central values don't contain these anomalously large and small values and instead represents the slowly varying character of B/A.

The method also calibrates the B volume at step 733 so that it is consistent with laboratory measurements. The method obtains a predicted value of B/A, denoted r, as follows:

$$r = \frac{1 - \frac{{b}^{2}}{{V}_{W}^{2}} ( 8 + 4 ( 1 - \frac{{V}_{W}^{2}}{{V}_{P}^{2}} ) {γ}_{0} )}{1 + {γ}_{0}} \qquad ( 39 )$$

Published laboratory and field measurements from a wide variety of rock types indicate that b varies approximately plus or minus 8% around 900 meters per second. The b in equation (39) is chosen to match the rock type(s) in the area under study and can be either a single value or a spatially varying volume containing local variations illustrated in FIG. 35, which can lead to a more accurate calibration. The method computes a value for r at every point in a three-dimensional volume and compares r to the actual B/A values. The method finds a single calibration parameter which best scales the actual B/A values to fit the predicted r from equation (39), then applies that value to B to calibrate the actual B/A volume.

If, at step 734, the method is updating the γ volume from the starting value of γ=0.25, the method proceeds to step 736. If not, then the method returns to FIG. 32 at step 734.

At step 736, an iteration index, m, is initialized to 1. At step 738, the method computes a γ volume for the current iteration index m, γₘ, according to the following formula:

$${γ}_{m} = - \frac{1 - \frac{B}{A} - \frac{8 {b}^{2}}{{V}_{W}^{2}}}{\frac{B}{A} + \frac{4 {b}^{2}}{{V}_{W}^{2}} ( 1 - \frac{{V}_{W}^{2}}{{V}_{P}^{2}} )} \qquad ( 40 )$$

The B/A used in equation (40) is the current conditioned and calibrated B/A volume. The b used in equation (40) can be either a constant value or a spatially varying volume.

At step 740, the method applies the least-squares inversion of incidence angle gathers described by FIG. 33 and uses the updated γₘ volume to recompute A and B volumes. The recomputed A and B volumes are used to form a B/A volume for the next iteration, which is conditioned and calibrated at step 733.

At step 742, the user decides whether the method to determine the spatially varying γₘ volume has converged. In an embodiment, the user analyzes each γₘ volume graphically and decides that the method has converged if the change in γₘ from iteration to iteration is sufficiently small when m is large enough (e.g., m>2).

If the user decides that the method has not converged, then at step 746, the iteration index m is incremented by 1 and the method returns to step 738 for the next iteration.

If the user decides that the method has converged, then at step 744, if desired, the method may use the final γₘ volume to transform the input P-wave velocity V_{P} volume to the output bulk density ρ volume according to equation (32). The method assumes a value for density at earth's surface, ρ₀. Assume the spacing in depth between samples of the P-wave velocity volume V_{P} is Δz. The method then solves equation (32) for Δρ at depth Δz and computes ρ at Δz as ρ₀+Δρ. The method then steps down into the earth recursively, solving for Δρ at depth 2*Δz, 3*Δz and so forth.

At step 744, the method also outputs the γₘ volume and the conditioned and calibrated A and B volumes then returns to the reflectivity attribute computation method of FIG. 32.

FIG. 35 illustrates iterative transformation of P-wave velocity V_{P} to S-wave velocity V_{S} using a single-parameter mudrock line, specifically a hyperbolic mudrock line, as defined in equation (38). The method uses seismic amplitude information, contained in the A and B parameters, to compute the hyperbolic mudrock line parameter b which enables the transformation of P-wave velocity V_{P} to S-wave velocity V_{S}. This in turn enables the computation of reflectivity attributes which may indicate the presence or lack of hydrocarbons in the subsurface.

Seismic data are often not acquired in a uniform manner. Therefore, the A and B parameters in equation (33) are scaled by an unknown value which varies spatially. This will hamper the direct use of A and B to determine mudrock line parameters. However, the method divides B by A to obtain the ratio B/A to remove the effect of the unknown value. The ratio B/A is therefore a suitable seismic amplitude input to use for mudrock line determination where B and A individually may not be suitable.

The hyperbolic mudrock line needs only one parameter to relate S-wave velocity V_{S} to P-wave velocity V_{P}, rather than the two parameters used with the linear mudrock line. The hyperbolic mudrock line expresses V_{S} as a function of V_{P} and the mudrock line parameter. Both V_{S} and the mudrock line parameter are unknown. To estimate the mudrock line parameter, the method uses B/A to eliminate V_{S} from the expression. If B/A is the only suitable seismic amplitude input, as stated above, then it may only be feasible to compute one mudrock line parameter, not two mudrock line parameters. The single-parameter mudrock line is therefore a desirable choice if the user wants to use seismic information to obtain the V_{P}-to-V_{S} relationship.

At step 750, the method inputs the following: a P-wave velocity volume V_{P}, as described at step 706, a conditioned and calibrated B/A volume (computed at step 733), a single value for the velocity of sound in water, V_{W} (e.g., from 1,420 to 1,520 m/s depending on salinity, temperature, etc.), and either a single value for γ (e.g., γ=0.25) or a spatially varying volume of y, as computed by the method of FIG. 34.

An embodiment of the single-parameter mudrock line is the hyperbolic mudrock line, written as follows:

$${V}_{S}^{2} = {b}_{k}^{2} ( \frac{{V}_{P}^{2}}{{V}_{W}^{2}} - 1 ) \qquad ( 41 )$$

Equation (41) is the same as equation (38) except that the hyperbolic mudrock parameter b is instead denoted bₖ. The process of estimating bₖ is iterative; k refers to the iteration index. It is clear from equation (41) that when the P-wave velocity V_{P} equals water velocity V_{W}, the computed S-wave velocity V_{S} is zero.

The method expresses bₖ in terms of V_{P}, V_{W}, and γ as well as the previous iteration's hyperbolic mudrock line parameter bₖ₋₁:

$${b}_{k}^{2} = \frac{{V}_{W}^{2} ( 1 - ( 1 + γ ) \frac{B}{A} )}{8 + 4 ( 1 - \frac{{V}_{W}^{2}}{{V}_{P}^{2}} ) ( γ + 2 {β}_{k - 1} )} , \\ where \\ {β}_{k - 1} = \frac{{\overline{V}}_{P}}{Δ {V}_{P}} \frac{Δ {b}_{k - 1}}{{b}_{k - 1}} \qquad ( 42 )$$

The method assumes, at step 753, that β₀=0, such that at step 754, the initial value for the hyperbolic mudrock line parameter b₀ is defined as follows:

$${b}_{0}^{2} = \frac{{V}_{W}^{2} ( 1 - ( 1 + γ ) \frac{B}{A} )}{8 + 4 γ ( 1 - \frac{{V}_{W}^{2}}{{V}_{P}^{2}} )} , \qquad ( 43 )$$

The bₖ parameters are computed at every x, y, z location, forming a volume. At step 755, the method conditions the volume of b₀ produced at step 754 so that it produces a sensible S-wave velocity V_{S} and so that the iterative process described by FIG. 35 converges. The method performs a least-squares fit over the entire b₀ volume to a polynomial in x, y, and z. The user supplies the order of the polynomial in each direction. When the specified order of the fit is too high (e.g., 3) then the iterative computation for bₖ may not converge. In contrast, a linear variation in all directions always converges.

At step 756, the method sets the iteration index k to 1. At step 758, the method computes the hyperbolic mudrock line parameter volume bₖ for iteration k, according to equation (42). At step 759, the bₖ volume is conditioned by the process described at step 755, and also by averaging with the bₖ₋₁ volume. The averaging process increases the likelihood that the iterative process will converge. At step 760, the method uses the conditioned bₖ volume to compute a βₖ volume for the next iteration.

At step 762, the user decides whether the method to determine the hyperbolic mudrock line parameter volume bₖ has converged. In an embodiment, the user analyzes each bₖ volume graphically and decides that the method has converged if the change in bₖ from iteration to iteration is sufficiently small when k is large (e.g., k>5).

If the user decides that the method has not converged, then at step 766, the iteration index k is incremented by 1 and the method returns to step 758 for the next iteration.

If the user decides that the method has converged, then at step 764, the method uses the final conditioned bₖ volume to transform the input P-wave velocity V_{P} volume to compute S-wave velocity V_{S} volume according to equation (41). The method then returns to the reflectivity attribute computation method of FIG. 32.

The transformation from P-wave velocity V_{P} to S-wave velocity V_{S} with the hyperbolic mudrock line is intended to compute a background V_{S}, not an exact V_{S}. Thus, the method computes a spatially smooth bₖ volume.

Based on the data published by Castagna et al., Rock Physics—The Link Between Rock Properties and AVO Response, in Offset-Dependent Reflectivity—Theory and practice of AVO analysis, Society of Exploration Geophysics, (1993), which is incorporated by reference, the hyperbolic mudrock line is accurate for fitting limestone and dolomite. FIG. 36 illustrates a hyperbolic mudrock line fit to laboratory P-wave velocity versus S-wave velocity data for limestone. The laboratory data points, shown at step 772, are accurately predicted by the hyperbolic mudrock line equation (38) with b=831.7 meters per second and V_{W}=1,500 meters per second. A linear mudrock line could not be accurate over the entire range of velocity.

For sand and shale layers the mudrock line is better parameterized with a straight line. For this reason, the method allows the hyperbolic mudrock line parameter b to vary within a three-dimensional volume, and obtains a good local fit for sand and shale layers.

What is claimed:

1. The method in a host of determining a reflectivity attribute indicating the presence of hydrocarbons in earth, comprising:
inputting data representing reflected seismic waves;
inputting a volume of P-wave velocity;
transforming the volume of P-wave velocity into a volume of bulk density;
transforming the volume of P-wave velocity into a volume of S-wave velocity using amplitude information from the reflected seismic waves; and
using the volume of S-wave velocity and the volume of P-wave velocity to compute the reflectivity attribute.

2. The method of claim 1, wherein the amplitude information includes an A parameter and a B parameter corresponding to a linear expression for P-wave reflection strength.

3. The method of claim 2, wherein the linear expression is as follows:
$$R ( ϕ ) = A ( 1 + \frac{{sin}^{2} {ϕtan}^{2} ϕ}{1 + γ} ) + B {sin}^{2} ϕ$$

4. The method of claim 3, further comprising computing a formula for the A parameter in terms of the P-wave velocity reflectivity and the y parameter as follows:
$$A = \frac{Δ {V}_{P}}{{\overline{V}}_{P}} ( \frac{1 + γ}{2} )$$

5. The method of claim 3, further comprising computing a formula for the B parameter in terms of the P-wave velocity reflectivity, the S-wave velocity reflectivity, the volume of P-wave velocity, the volume of S-wave velocity, and the γ parameter as follows:
$$B = \frac{1}{2} \frac{Δ {V}_{P}}{{\overline{V}}_{P}} ( 1 - 4 γ \frac{ {V}_{S}^{2}}{{V}_{P}^{2}} ) - 4 \frac{{V}_{S}^{2}}{{V}_{P}^{2}} \frac{Δ {V}_{S}}{{\overline{V}}_{S}}$$

6. The method of claim 4, further comprising computing the P-wave velocity reflectivity where γ is a constant value γ′, from the formula for the A parameter as follows:
$$\frac{Δ {V}_{P}}{{\overline{V}}_{P}} = \frac{A}{( \frac{1 + {γ}^{′}}{2} )}$$

7. The method of claim 6, further comprising computing the bulk density reflectivity from the formula for γ shown in equation (32) as follows:
$$\frac{Δ ρ}{\overline{ρ}} = {γ}^{′} \frac{Δ {V}_{P}}{{\overline{V}}_{P}}$$

8. The method of claim 7, further comprising computing the S-wave velocity reflectivity from the formula for the B parameter as follows:
$$\frac{Δ {V}_{S}}{{\overline{V}}_{S}} = \frac{\frac{1}{2} \frac{Δ {V}_{P}}{{\overline{V}}_{P}} ( 1 - 4 {γ}^{′} \frac{{V}_{S}^{2}}{{V}_{P}^{2}} ) - B}{4 \frac{ {V}_{S}^{2}}{{V}_{P}^{2}}}$$

9. The method of claim 2, further comprising using the A and B parameters to compute a spatially varying γ volume, γ_{V}.

10. The method of claim 9, further comprising computing the A and B parameters using γ_{V}.

11. The method of claim 9, wherein the spatially varying volume γ_{V} is computed using the ratio of the A and B parameters, B/A.

12. The method of claim 9, wherein the spatially varying volume γ_{V} is computed using an iterative procedure.

13. The method of claim 11, further comprising using the spatially varying volume γ_{V} to iteratively recompute the A and B parameters.

14. The method of claim 10, further comprising computing the P-wave velocity reflectivity where γ is a spatially varying volume γ_{V}, from the formula for the A parameter as follows:
$$\frac{Δ {V}_{P}}{{\overline{V}}_{P}} = \frac{A}{( \frac{1 + {γ}_{V}}{2} )}$$

15. The method of claim 10, further comprising computing the bulk density reflectivity from the formula for γ shown in equation (32) as follows:
$$\frac{Δρ}{\overline{ρ}} = {γ}_{V} \frac{Δ {V}_{P}}{{\overline{V}}_{P}}$$

16. The method of claim 10, further comprising computing the S-wave velocity reflectivity from the formula for the B parameter as follows:
$$\frac{Δ {V}_{S}}{{\overline{V}}_{S}} = \frac{\frac{1}{2} \frac{Δ {V}_{P}}{{\overline{V}}_{P}} ( 1 - 4 {γ}_{V} \frac{{V}_{S}^{2}}{{V}_{P}^{2}} ) - B}{4 \frac{{V}_{S}^{2}}{{V}_{P}^{2}}}$$

17. The method of claim 1, wherein the volume of S-wave velocity is computed with a single-parameter mudrock line equation.

18. The method of claim 17, wherein the single-parameter mudrock line parameter is computed using the ratio of the A and B parameters, B/A.

19. The method of claim 1, wherein the volume of S-wave velocity equals zero when the P-wave velocity equals the P-wave velocity of water.

20. The method of claim 17, wherein the single-parameter mudrock line equation for S-wave velocity is hyperbolic, and takes the form:
$${V}_{S}^{2} = {b}_{k}^{2} ( \frac{{V}_{P}^{2}}{{V}_{W}^{2}} - 1 )$$

21. The method of claim 20, wherein the hyperbolic mudrock line parameter is computed using the ratio of the A and B parameters, B/A.

22. The method of claim 20, wherein the hyperbolic mudrock line parameter is computed with an iterative procedure.

23. The method of claim 2, wherein the A and B parameters are computed using depth migrated angle gathers.

24. The method of claim 23, wherein the depth migrated angle gathers are computed using a shot record one-way wave equation depth migration.

25. The method of claim 2, wherein the A and B parameters are computed by a least-squares inversion of angle gathers.

26. The method of claim 25, wherein low quality angle gather data is excluded from the least-squares inversion by a quality measure Q computed from the angle gathers.

27. The method of claim 2, wherein the B parameter is calibrated to laboratory data.

28. The method of claim 27, further comprising determining a scalar which multiplies the ratio of the A and B parameters, B/A, such that B/A matches a predicted r=B/A.

29. The method of claim 28, wherein the expression for the predicted r=B/A is as follows:
$$r = \frac{1 - \frac{{b}^{2}}{{V}_{W}^{2}} ( 8 + 4 ( 1 - \frac{{V}_{W}^{2}}{{V}_{P}^{2}} ) γ )}{1 + γ}$$

30. A computer-readable medium storing program instructions for determining a reflectivity attribute indicating the presence of hydrocarbons in earth, that cause a host to perform the following steps, comprising:
inputting data representing reflected seismic waves;
inputting a volume of P-wave velocity;
transforming the volume of P-wave velocity into a volume of bulk density;
transforming the volume of P-wave velocity into a volume of S-wave velocity using amplitude information from the reflected seismic waves; and
using the volume of S-wave velocity and the volume of P-wave velocity to compute the reflectivity attribute.

31. The computer-readable medium of claim 30, wherein the amplitude information includes an A parameter and a B parameter corresponding to a linear expression for P-wave reflection strength.

32. The computer-readable medium of claim 31, wherein the linear expression is as follows:
$$R ( ϕ ) = A ( 1 + \frac{{sin}^{2} {ϕtan}^{2} ϕ}{1 + γ} ) + B {sin}^{2} ϕ$$

33. The computer-readable medium of claim 32, further comprising computing a formula for the A parameter in terms of the P-wave velocity reflectivity and the γ parameter as follows:
$$A = \frac{Δ {V}_{P}}{{\overline{V}}_{P}} ( \frac{1 + γ}{2} )$$

34. The computer-readable medium of claim 33, further comprising computing a formula for the B parameter in terms of the P-wave velocity reflectivity, the S-wave velocity reflectivity, the volume of P-wave velocity, the volume of S-wave velocity, and the γ parameter as follows:
$$B = \frac{1}{2} \frac{Δ {V}_{P}}{{\overline{V}}_{P}} ( 1 - 4 γ \frac{{V}_{S}^{2}}{{V}_{P}^{2}} ) - 4 \frac{{V}_{S}^{2}}{{V}_{P}^{2}} \frac{Δ {V}_{S}}{{\overline{V}}_{S}}$$

35. The computer-readable medium of claim 34, further comprising computing the P-wave velocity reflectivity where γ is a constant value γ′, from the formula for the A parameter as follows:
$$\frac{Δ {V}_{P}}{{\overline{V}}_{P}} = \frac{A}{( \frac{1 + {γ}^{′}}{2} )}$$

36. The computer-readable medium of claim 35, further comprising computing the bulk density reflectivity from the formula for γ shown in equation (32) as follows:
$$\frac{Δρ}{\overline{ρ}} = {γ}^{′} \frac{Δ {V}_{P}}{{\overline{V}}_{P}}$$

37. The computer-readable medium of claim 36, further comprising computing the S-wave velocity reflectivity from the formula for the B parameter as follows:
$$\frac{Δ {V}_{S}}{{\overline{V}}_{S}} = \frac{\frac{1}{2} \frac{Δ {V}_{P}}{{\overline{V}}_{P}} ( 1 - 4 {γ}^{′} \frac{{V}_{S}^{2}}{{V}_{P}^{2}} ) - B}{4 \frac{{V}_{S}^{2}}{{V}_{P}^{2}}}$$

38. The computer-readable medium of claim 31, further comprising using the A and B parameters to compute a spatially varying γ volume, γ_{V}.

39. The computer-readable medium of claim 38, further comprising computing the A and B parameters using γ_{V}.

40. The computer-readable medium of claim 38, wherein the spatially varying volume γ_{V} is computed using the ratio of the A and B parameters, B/A.

41. The computer-readable medium of claim 38, wherein the spatially varying volume γ_{V} is computed using an iterative procedure.

42. The computer-readable medium of claim 40, further comprising using the spatially varying volume γ_{V} to iteratively recompute the A and B parameters.

43. The computer-readable medium of claim 39, further comprising computing the P-wave velocity reflectivity where γ is a spatially varying volume γ_{V}, from the formula for the A parameter as follows:
$$\frac{Δ {V}_{P}}{{\overline{V}}_{P}} = \frac{A}{( \frac{1 + {γ}_{V}}{2} )}$$

44. The computer-readable medium of claim 39, further comprising computing the bulk density reflectivity from the formula for γ shown in equation (32) as follows:
$$\frac{Δρ}{\overline{ρ}} = {γ}_{V} \frac{Δ {V}_{P}}{{\overline{V}}_{P}}$$

45. The computer-readable medium of claim 39, further comprising computing the S-wave velocity reflectivity from the formula for the B parameter as follows:
$$\frac{Δ {V}_{S}}{{\overline{V}}_{S}} = \frac{\frac{1}{2} \frac{Δ {V}_{P}}{{\overline{V}}_{P}} ( 1 - 4 {γ}_{V} \frac{{V}_{S}^{2}}{{V}_{P}^{2}} ) - B}{4 \frac{{V}_{S}^{2}}{{V}_{P}^{2}}}$$

46. The computer-readable medium of claim 30, wherein the volume of S-wave velocity is computed with a single-parameter mudrock line equation.

47. The computer-readable medium of claim 46, wherein the single-parameter mudrock line parameter is computed using the ratio of the A and B parameters, B/A.

48. The computer-readable medium of claim 30, wherein the volume of S-wave velocity equals zero when the P-wave velocity equals the P-wave velocity of water.

49. The computer-readable medium of claim 46, wherein the single-parameter mudrock line equation for S-wave velocity is hyperbolic, and takes the form:
$${V}_{S}^{2} = {b}_{k}^{2} ( \frac{{V}_{P}^{2}}{{V}_{W}^{2}} - 1 )$$

50. The computer-readable medium of claim 49, wherein the hyperbolic mudrock line parameter is computed using the ratio of the A and B parameters, B/A.

51. The computer-readable medium of claim 49, wherein the hyperbolic mudrock line parameter is computed with an iterative procedure.

52. The computer-readable medium of claim 31, wherein the A and B parameters are computed using depth migrated angle gathers.

53. The computer-readable medium of claim 52, wherein the depth migrated angle gathers are computed using a shot record one-way wave equation depth migration.

54. The computer-readable medium of claim 31, wherein the A and B parameters are computed by a least-squares inversion of angle gathers.

55. The computer-readable medium of claim 54, wherein low quality angle gather data is excluded from the least-squares inversion by a quality measure Q computed from the angle gathers.

56. The computer-readable medium of claim 31, wherein the B parameter is calibrated to laboratory data.

57. The computer-readable medium of claim 56, further comprising determining a scalar which multiplies the ratio of the A and B parameters, B/A, such that B/A matches a predicted r=B/A.

58. The computer-readable medium of claim 57, wherein the expression for the predicted r=B/A is as follows:
$$r = \frac{1 - \frac{{b}^{2}}{{V}_{W}^{2}} ( 8 + 4 ( 1 - \frac{{V}_{W}^{2}}{{V}_{P}^{2}} ) γ )}{1 + γ}$$
